(19) United States
(12) Patent Application Publication
(10) Pub. No.: US 2004/0115572 A1
(43) Pub. Date: Jun. 17, 2004

(54) Photothermographic material

(76) Inventors: Yoshihisa Tsukada, Kanagawa (JP); Hajime Nakagawa, Kanagawa (JP)

Correspondence Address: BIRCH STEWART KOLASCH & BIRCH, PO BOX 747, FALLS CHURCH, VA, 22040-0747, US

(21) Appl. No.: 10/724,706

(22) Filed: Dec. 2, 2003

(30) Foreign Application Priority Data
Dec. 3, 2002 (JP) 2002-351466

(51) Int. Cl. G03C 1/498

(52) U.S. Cl. 430/619; 430/531; 430/534; 430/535; 430/536; 430/607

(57) ABSTRACT

A photothermographic material of the present invention has a support and an image-forming layer disposed thereon, and the image-forming layer contains a photosensitive silver halide, a non-photosensitive organic silver salt, a reducing agent and a binder. The binder contains a polymer formed by copolymerization of monomers including 10 to 70% by mass of a monomer represented by the following formula (M):

CH₂═CR⁰¹—CR⁰²═CH₂

wherein R⁰¹ represents a hydrogen atom, an alkyl group having 1 to 6 carbon atoms, a halogen atom, or a cyano group; R⁰² represents an alkyl group having 1 to 6 carbon atoms, a halogen atom, or a cyano group; and where R⁰¹ and R⁰² are never both simultaneously a hydrogen atom. The image-forming layer preferably contains an antifoggant of an organic polyhalogen compound.

### CROSS-REFERENCE TO RELATED APPLICATIONS

This application claims benefit of and priority to Japanese Patent Application No. 2002-351466, filed on Dec. 3, 2002, which is incorporated herein by reference in its entirety for all purposes.

### BACKGROUND OF THE INVENTION

1. Field of the Invention

The present invention relates to a photothermographic material.

2. Description of the Related Art

Recently, in the medical field, a decrease in the amount of treated waste fluids is strongly desired in light of environmental protection and space efficiency factors. This has caused a strong demand for technologies relating to photosensitive thermal developing photographic materials for medical diagnosis and photographic technology. These must be able to effectively expose an image to light with a laser imagesetter or a laser imager and thus form a clear black image having high resolution and sharpness. Such photosensitive thermal developing photographic materials provide customers with a thermal developing treating that does not utilize treated chemical solutions, making it that much easier to not harm the environment.

A similar demand has arisen in the field of general image forming materials. Nonetheless, since fine delineation is especially necessary in medical images, medical applications require high image quality and excellent sharpness and granularity. Moreover, in order to facilitate diagnosis, cold black tone images are preferred in medical applications. Various hard copy systems such as inkjet printers and electrophotographic devices utilizing pigments and dyes are currently used as general image forming systems. Nonetheless, none of these satisfactory functions as an output system for medical images.

In contrast to the above, thermal image forming systems utilizing an organic silver salt is described, for example, in Thermally Processed Silver Systems by B. Shely, Neblette, and in Imaging Processes and Materials, 8^{th} edition, edited by Sturge, V. Walworth, A. Shepp, page 2, 1996. In particular, a photothermographic material generally has a photosensitive layer in which a catalytically-active amount of a photocatalyst (e.g. a silver halide), a reducing agent, a reducible silver salt (e.g. an organic silver salt) and, if necessary, a color tone adjusting agent for controlling silver color tone, are dispersed in a matrix of a binder. Such a photothermographic material is heated to a high temperature (e.g., 80° C. or higher) after image exposure, and forms a black silver image by a redox reaction between a reducing agent and a silver halide or a reducible silver salt (functioning as an oxidizing agent). The redox reaction is promoted by the catalytic action of the latent silver halide image generated by exposure, thereby forming a black silver image on the exposed portion. Further, Fuji Medical dry laser imager L (trade name: FM-DP, manufactured by Fuji Photo Film Co. Ltd.) is currently sold as a thermal image forming system for medical use.

Known methods for producing a thermal image forming system utilizing an organic silver salt include a solvent coating method, and a method wherein a coating solution containing a fine particle polymer as a main binder dispersed in water is coated and dried. For example, see Japanese Patent Application Laid-Open (JP-A) No. 2002-229149 and PCT National Publication (JP-A) No. 11-509332. Since a step of recovering solvent is not necessary in the latter process, the producing facilities are simple, making this method advantageous for large scale production.

Photothermographic materials disclosed in Patent publications such as JP-A No. 2002-229149 utilize a polymer latex having a halogen ion content of 500 ppm or less as a binder. Formation of the photosensitive layer using this aqueous coating solution results in improved image storability including increased color density of the unexposed portion, change of the silver color tone, etc. after image formation. This notwithstanding, there has been a large demand for further improving the image storability of photothermographic materials. It is known that organic polyhalogen compounds are effective as antifoggants, however, the sensitivity of photothermographic materials is reduced when the amount of organic polyhalogen compounds is increased. Accordingly, organic polyhalogen compounds can only be added in a restricted amount and thus do not exhibit sufficiently improved effects. Additionally, in order to adapt photothermographic materials to production, the photothermographic materials must be less brittle so as to enhance production yield. Thus, there is a need in the art for technologies providing photothermographic materials having improved image storability, sensitivity and flexibility.

### SUMMARY OF THE INVENTION

An object of the present invention is to provide a photothermographic material excellent in image storability, sensitivity and flexibility.

A photothermographic material of the invention comprises a support and an image-forming layer disposed on the support, wherein the image-forming layer comprises a photosensitive silver halide, a non-photosensitive organic silver salt, a reducing agent and a binder, and the binder comprises a polymer formed by copolymerization of monomers including 10 to 70% by mass of a monomer represented by the following formula (M):

CH₂═CR⁰¹—CR⁰²═CH₂ Formula (M)

wherein R⁰¹ represents a hydrogen atom, an alkyl group having 1 to 6 carbon atoms, a halogen atom, or a cyano group; R⁰² represents an alkyl group having 1 to 6 carbon atoms, a halogen atom, or a cyano group; and where R⁰¹ and R⁰² are never both simultaneously a hydrogen atom.

According to a preferred embodiment of the invention, the image-forming layer comprises an antifoggant formed from an organic polyhalogen compound.

The organic polyhalogen compound is preferably represented by the following formula (H):

Q-(Y)n-C(Z₁)(Z₂)X Formula (H)

wherein Q represents an alkyl group, an aryl group, or a heterocyclic group; Y represents a divalent linking group; n represents an integer of 0 or 1; Z₁ and Z₂ represent a halogen atom, respectively; and X represents a hydrogen atom or an electron-withdrawing group.

The image-forming layer preferably comprises the antifoggant in an amount of 0.01 to 0.5 g/m².

According to another preferred embodiment of the invention, the polymer has a glass-transition temperature of −30 to 70° C.

According to a further preferred embodiment of the invention, the polymer is a polymer latex synthesized by an emulsion polymerization.

According to a further preferred embodiment of the invention, R⁰¹ is a hydrogen atom and R⁰² is a methyl group in the formula (M).

According to a further preferred embodiment of the invention, the polymer is copolymerized with monomers at 1 to 20% by mass, wherein the monomers have acid groups.

### DETAILED DESCRIPTION OF THE INVENTION

The present invention is described in detail below.

A photothermographic material of the invention has an image-forming layer comprising a photosensitive silver halide, a non-photosensitive organic silver salt, a reducing agent, and a binder, on one surface of a support. The photothermographic material may further have a non-photosensitive layer such as a surface protective layer, or an intermediate layer disposed between the image-forming layer and the surface protective layer, if necessary. The surface protective layer may have a structure of single layer or multi-layer. Further, the photothermographic material may comprise a back layer, a back protective layer, etc. on the other surface of the support.

Binder

In the invention, a polymer, which is generated by copolymerization of monomers including 10 to 70% by mass of a monomer represented by the following formula (M), is used as a binder component for the image-forming layer.

CH₂═CR⁰¹—CR⁰²═CH₂ Formula (M)

In the formula (M), R⁰¹ and R⁰² represent a hydrogen atom, an alkyl group having 1 to 6 carbon atoms, a halogen atom, or a cyano group, respectively; and where R⁰¹ and R⁰² are never both simultaneously a hydrogen atom.

The alkyl group represented by R⁰¹ or R⁰² is preferably an alkyl group having 1 to 4 carbon atoms, more preferably an alkyl group having 1 to 2 carbon atoms. The halogen atom represented by R⁰¹ or R⁰² is preferably a fluorine atom, a chlorine atom, or a bromine atom, more preferably a chlorine atom.

It is particularly preferred that one of R⁰¹ and R⁰² is a hydrogen atom and the other is a methyl group or a chlorine atom.

Specific examples of such monomers represented by the formula (M) include 2-ethyl-1,3-butadiene, 2-n-propyl-1,3-butadiene, 2,3-dimethyl-1,3-butadiene, 2-methyl-1,3-butadiene, 2-chloro-1,3-butadiene, 1-bromo-1,3-butadiene, 2-fluoro-1,3-butadiene, 2,3-dichloro-1,3-butadiene, and 2-cyano-1,3-butadiene.

The binder used in the invention comprises the polymer formed by copolymerization of monomers including the monomer represented by the formula (M), and the mass ratio of the monomer represented by the formula (M) to the total of the monomers copolymerized in the polymer is 10 to 70% by mass, preferably 15 to 65% by mass, more preferably 20 to 60% by mass. When the mass ratio of the monomer represented by the formula (M) is less than 10% by mass, meltable components of the binder are reduced, so that the photothermographic material is poor in the brittleness in process. On the other hand, when the mass ratio of the monomer represented by the formula (M) is more than 70% by mass, meltable components of the binder are increased to enhance the mobility of the binder, so that the image storability of the photothermographic material is reduced.

Other monomers to be copolymerized with the monomer represented by the formula (M) are not particularly limited, and monomers may be used in the invention as long as they can be polymerized by a usual radical polymerization or ionic polymerization method. The following monomers (a) to (j) are preferably used in the invention independently or in combination with each other.

Monomers (a) to (j):

(a) conjugated dienes: 1,3-butadiene, 1,3-pentadiene, 1-phenyl-1,3-butadiene, 1-α-naphthyl-1,3-butadiene, 1-β-naphthyl-1,3-butadiene, 1-bromo-1,3-butadiene, 1-chloro-1,3-butadiene, 1,1,2-trichloro-1,3-butadiene, cyclopentadiene, etc.

(b) Olefins: ethylene, propylene, vinyl chloride, vinylidene chloride, 6-hydroxy-1-hexene, 4-pentenoic acid, methyl 8-nonenate, vinylsulfonic acid, trimethylvinylsilane, trimethoxyvinylsilane, 1,4-divinylcyclohexane, 1,2,5-trivinylcyclohexane, etc.

(c) α, β-Unsaturated carboxylic acids and salts thereof: acrylic acid, methacrylic acid, itaconic acid, maleic acid, sodium acrylate, ammonium methacrylate, potassium itaconate, etc.

(d) α, β-Unsaturated carboxylic acid esters: alkyl acrylates such as methyl acrylate, ethyl acrylate, butyl acrylate, cyclohexyl acrylate, 2-ethylhexyl acrylate, and dodecyl acrylate; substituted alkyl acrylates such as 2-chloroethyl acrylate, benzyl acrylate, and 2-cyanoethyl acrylate; alkyl methacrylates such as methyl methacrylate, butyl methacrylate, 2-ethylhexyl methacrylate, and dodecyl methacrylate; substituted alkyl methacrylate such as 2-hydroxyethyl methacrylate, glycidyl methacrylate, glycerin monomethacrylate, 2-acetoxyethyl methacrylate, tetrahydrofurfuryl methacrylate, 2-methoxyethyl methacrylate, polypropylene glycol monomethacrylate (mole number of added polyoxypropylene=2 to 100), 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethoxysilylpropyl methacrylate, allyl methacrylate, and 2-isocyanatoethyl methacrylate; derivatives of unsaturated dicarboxylic acid such as monobutyl maleate, dimethyl maleate, monomethyl itaconate, and dibutyl itaconate; multifunctional esters such as ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, and 1,2,4-cyclohexane tetramethacrylate; etc.

(e) β-Unsaturated carboxylic amides: acrylamide, methacrylamide, N-methylacrylamide, N,N-dimethylacrylamide, N-methyl-N-hydroxyethylmethacrylamide, N-tert-butylacrylamide, N-tert-octylmethacrylamide, N-cyclohexylacrylamide, N-phenylacrylamide, N-(2-acetoacetoxyethyl)acrylamide, N-acryloylmorpholine, diacetone acrylamide, itaconic diamide, N-methylmaleimide, 2-acrylamide-methylpropane sulfonic acid, methylene bisacrylamide, dimethacryloylpiperazine, etc.

(f) Unsaturated nitriles: acrylonitrile, methacrylonitrile, etc.

(g) Styrene and derivatives thereof: styrene, vinyltoluene, p-tert-butylstyrene, vinylbenzoic acid, methyl vinylbenzoate, α-methylstyrene, p-chloromethylstyrene, vinylnaphthalene, p-hydroxymethylstyrene, sodium p-styrenesulfonate, potassium p-styrenesulfinate, p-aminomethylstyrene, 1,4-divinylbenzene, etc.

(h) Vinyl ethers: methyl vinyl ether, butyl vinyl ether, methoxyethyl vinyl ether, etc.

(i) Vinyl esters: vinyl acetate, vinyl propionate, vinyl benzoate, vinyl salicylate, vinyl chloroacetate, etc.

(j) Other polymerizable monomers: N-vinylimidazole, 4-vinylpyridine, N-vinylpyrrolidone, 2-vinyloxazoline, 2-isopropenyloxazoline, divinylsulfone, etc.

Preferred examples of the polymers obtained by copolymerization of the monomer represented by the formula (M) include copolymers formed from the monomer of the formula (M) and styrene, such as random copolymers and block copolymers; copolymers formed from the monomer of the formula (M), styrene, and butadiene, such as random copolymers, butadiene-isoprene-styrene block copolymers, and styrene-butadiene-isoprene-styrene block copolymers; copolymers formed from the monomer of the formula (M), ethylene, and propylene; copolymers formed from the monomer of the formula (M) and acrylonitrile; copolymers formed from the monomer of the formula (M) and isobutylene; copolymers formed from the monomer of the formula (M) and acrylic acid ester such as ethyl acrylate and butyl acrylate; and copolymers formed from the monomer of the formula (M), acrylic acid ester with the same examples as before, and acrylonitrile. Among them, the most preferred are copolymers formed from the monomer of the formula (M) and styrene.

It is preferable that a monomer having acid group(s) is copolymerized with the above monomers to obtain the polymer used in the invention as the binder. The acid group is preferably a carboxylic acid group, a sulfonic acid group, or a phosphoric acid group. The mass ratio of the monomer having acid group(s) to the total of the monomers (co)polymerized in the polymer is preferably 1 to 20% by mass, more preferably 1 to 10% by mass.

Specific examples of such monomers having acid group(s) include acrylic acid, methacrylic acid, itaconic acid, sodium p-styrenesulfonate, isoprenesulfonic acid, phosphorylethyl methacrylate, etc.

The binder used in the invention may comprise any polymer in addition to the copolymer formed from the monomer represented by the formula (M). The polymer to be used with the above copolymer is preferably transparent or translucent, and colorless. The polymer may be a natural resin, polymer or copolymer; a synthetic resin, polymer, or copolymer; or a medium that can form a film. Examples of such polymers include gelatins, polyvinyl alcohols, hydroxyethyl celluloses, cellulose acetates, cellulose acetate butyrates, polyvinylpyrrolidones, caseins, starches, polyacrylic acids, polymethylmethacrylic acids, polyvinyl chlorides, polymethacrylic acids, styrene-maleic anhydride copolymers, styrene-acrylonitrile copolymers, styrene-butadiene copolymers, polyvinyl acetals such as polyvinyl formal and polyvinyl butyral, polyesters, polyurethanes, phenoxy resins, polyvinylidene chlorides, polyepoxides, polycarbonates, polyvinyl acetates, polyolefins, polyamides, etc. The binder may be formed by a coating method from an aqueous or organic solution, or an emulsion.

The glass-transition temperature (Tg) of the binder used in the invention is preferably −30 to 70° C., more preferably −10 to 50° C., furthermore preferably 0 to 40° C., from the viewpoints of the brittleness and the image storability. Two or more polymers may be blended to use as the binder. In this case, the weighted average Tg, obtained based on the composition ratios, is preferably within the above range. In the case that phase separation is caused or that the binder has a core-shell structure, the weighted average Tg is preferably within the above range.

The glass-transition temperature Tg can be calculated using the following equation.

1/Tg=Σ(Xi/Tgi)

Here the polymer is formed by copolymerization of n monomers of i=1 to n. Xi is the weight fraction of the ith monomer (ΣXi=1), and Tgi is the glass-transition temperature (absolute temperature) of the homopolymer of the ith monomer. Σ(Xi/Tgi) is the sum of Xi/Tgi for i=1 to n. It should be noted that the glass-transition temperature Tgi of the homopolymer of each monomer is such as described in J. Brandrup and E. H. Immergut, Polymer Handbook, 3rd Edition (Wiley-Interscience, 1989).

The polymer used in the invention as the binder can be easily prepared by a solution polymerization method, a suspension polymerization method, an emulsion polymerization method, a dispersion polymerization method, an anionic polymerization method, a cationic polymerization method, etc. The emulsion polymerization method is the most preferred because the polymer can be obtained as a latex by the method. In the emulsion polymerization method, for example, water or a mixed solvent of water and water-mixable organic solvent such as methanol, ethanol and acetone is used as a dispersion medium, and monomers are polymerized in the dispersion medium in the presence of an emulsifying agent and a polymerization initiator while stirring at approximately 30 to 100° C., preferably 60 to 90° C., for 3 to 24 hours, the amount of the monomers being 5 to 150% by mass based on the dispersion medium. Conditions such as the dispersion medium, the monomer concentrations, the amount of the polymerization initiator, the amount of the emulsifying agent, the amount of the dispersing agent, the reaction temperature, the method of adding the monomers, etc. may be appropriately selected depending on the monomers. Further, it is preferable that a dispersing agent is used in the emulsion polymerization method if necessary.

The emulsion polymerization may be carried out according to the following references: Gosei Jushi Emarujon, edited by Taira Okuda and Hiroshi Inagaki, Kobunshi Kanko Kai (1978); Gosei Ratekkusu no Oyo, edited by Takaaki Sugimura, Yasuo Kataoka, Souichi Suzuki and Keishi Kasahara, Kobunshi Kanko Kai (1993); and Soichi Muroi, Gosei Ratekkusu no Kagaku, Kobunshi Kanko Kai (1970). In the emulsion polymerization, batch polymerization methods, monomer (successive or stepwise) addition methods, emulsion addition methods, seed polymerization methods, etc. may be used to prepare the polymer latex of the invention. Among them, the batch polymerization methods, the monomer (successive or stepwise) addition methods and the emulsion addition methods are preferable from the viewpoint of the productivity of the latex.

As the polymerization initiator, inorganic peroxides such as persulfates and hydrogen peroxide; peroxides described in Yuki Kasankabutsu Katarogu of NOF Corporation, etc.; and azo compounds described in Azo Jugo Kaishizai Katarogu of Wako Pure Chemical Industries, Ltd., etc. can be used as long as they can generate radicals. Among them, preferred are water-soluble peroxides such as persulfate, and water-soluble azo compounds described in Azo Jugo Kaishizai Katarogu of Wako Pure Chemical Industries, Ltd., etc. More preferred are ammonium persulfate, sodium persulfate, potassium persulfate, azobis(2-methylpropioneamidine)hydrochloride, azobis(2-methyl-N-(2-hydroxyethyl)propioneamide) and azobis(cyanovaleric acid), and particularly preferred are peroxides such as ammonium persulfate, sodium persulfate and potassium persulfate, from the viewpoints of the image storability, the solubility and the costs.

The mass ratio of the polymerization initiator to the total amount of the monomers is preferably 0.3 to 2.0% by mass, more preferably 0.4 to 1.75% by mass, particularly preferably 0.5 to 1.5% by mass. When the mass ratio is less than 0.3% by mass, the image storability is reduced. When the mass ratio is more than 2.0% by mass, the latex is easily aggregated to be unsuitable for coating.

The emulsifying agent for polymerization may be an anionic surfactant, a nonionic surfactant, a cationic surfactant, or an ampholytic surfactant. The anionic surfactants are preferable from the viewpoints of dispersibility and the image storability, and anionic sulfonic acid surfactants are more preferable because they can provide polymerization stability in a small amount and resist hydrolysis. Furthermore preferred are long-chain-alkyl diphenyl ether disulfonates with typical examples including PELEX SS—H (trade name, manufactured by Kao Corporation), and particularly preferred are low electrolyte type agents such as Pionine A-43-S (trade name, manufactured by Takemoto Oil & Fat Co., Ltd).

The mass ratio of the anionic sulfonic acid surfactant used as the emulsifying agent for polymerization to the total amount of the monomers is preferably 0.1 to 10.0% by mass, more preferably 0.2 to 7.5% by mass, particularly preferably 0.3 to 5.0% by mass. When the mass ratio of the emulsifying agent is less than 0.1% by mass, the emulsifying agent cannot maintain the high stability of the emulsion polymerization. When the mass ratio is more than 10.0% by mass, the image storability is reduced.

A chelating agent is preferably used in the synthesis of the polymer latex of the invention. The chelating agent is a compound that can coordinate (chelate) a multivalent ion, e.g. a metal ion such as an iron ion, an alkaline earth metal ion such as a calcium ion, etc. Examples of such chelating agents include compounds described in JP-B No. 6-8956, U.S. Pat. No. 5,053,322, and JP-A Nos. 4-73645, 4-127145, 4-247073, 4-305572, 6-11805, 5-173312, 5-66527, 5-158195, 6-118580, 6-110168, 6-161054, 6-175299, 6-214352, 7-114161, 7-114154, 7-120894, 7-199433, 7-306504, 9-43792, 8-314090, 10-182571, 10-182570 and 11-190892.

Preferred as the chelating agent are inorganic chelating compounds such as sodium tripolyphosphate, sodium hexametaphosphate and sodium tetrapolyphosphate; aminopolycarboxylic acid-based chelating compounds such as nitrilotriacetic acid and ethylenediaminetetraacetic acid; organic phosphonic acid-based chelating compounds described in Research Disclosure, No. 18170, JP-A Nos. 52-102726, 53-42730, 56-97347, 54-121127, 55-4024, 55-4025, 55-29883, 55-126241, 55-65955, 55-65956, 57-179843 and 54-61125, GP No. 1,045,373, etc.; polyphenol-based chelating agents; polyamine-based chelating compounds; etc. Aminopolycarboxylic acid derivatives are particularly preferable as the chelating agent.

Preferred examples of the aminopolycarboxylic acid derivatives include compounds described in attached tables of EDTA—Konpurekisan no Kagaku—, Nankodo Co., Ltd. (1977), and carboxyl group of the compounds may form an alkaline metal salt such as a sodium salt and a potassium salt, an ammonium salt, etc. Particularly preferred examples of the aminopolycarboxylic acid derivatives include iminodiacetic acid, N-methyliminodiacetic acid, N-(2-aminoethyl)iminodiacetic acid, N-(carbamoylmethyl)iminodiacetic acid, nitrilotriacetic acid, ethylenediamine-N,N′-diacetic acid, ethylenediamine-N,N′-di-α-propionic acid, ethylenediamine-N,N′-di-β-propionic acid, N,N′-ethylene-bis(α-o-hydroxyphenyl)glycine, N,N′-di(2-hydroxybenzyl)ethylenediamine-N,N′-diacetic acid, ethylenediamine-N,N′-diacetic acid-N,N′-diacetohydroxamic acid, N-hydroxyethylethylenediamine-N,N′,N′-triacetic acid, ethylenediamine-N,N,N′,N′-tetraacetic acid, 1,2-propylenediamine-N,N,N′,N′-tetraacetic acid, d,1-2,3-diaminobutane-N,N,N′,N′-tetraacetic acid, meso-2,3-diaminobutane-N,N,N′,N′-tetraacetic acid, 1-phenylethylenediamine-N,N,N′,N′-tetraacetic acid, d,l-1,2-diphenylethylenediamine-N,N,N′,N′-tetraacetic acid, 1,4-diaminobutane-N,N,N′,N′-tetraacetic acid, trans-cyclobutane-1,2-diamine-N,N,N′,N′-tetraacetic acid, trans-cyclopentane-1,2-diamine-N,N,N′,N′-tetraacetic acid, trans-cyclohexane-1,2-diamine-N,N,N′,N′-tetraacetic acid, cis-cyclohexane-1,2-diamine-N,N,N′,N′-tetraacetic acid, cyclohexane-1,3-diamine-N,N,N′,N′-tetraacetic acid, cyclohexane-1,4-diamine-N,N,N′,N′-tetraacetic acid, O -phenylenediamine-N,N,N′,N′-tetraacetic acid, cis-1,4-diaminobutene-N,N,N′,N′-tetraacetic acid, trans-1,4-diaminobutene-N,N,N′,N′-tetraacetic acid, α, α′-diamino-o-xylene-N,N,N′,N′-tetraacetic acid, 2-hydroxy-1,3-propanediamine-N,N,N′,N′-tetraacetic acid, 2,2′-oxy-bis(ethyliminodiacetic acid), 2,2′-ethylenedioxy-bis(ethyliminodiacetic acid), ethylenediamine-N,N′-diacetic acid-N,N′-di-α-propionic acid, ethylenediamine-N,N′-diacetic acid-N,N′-di-β-propionic acid, ethylenediamine-N,N,N′,N′-tetrapropionic acid, diethylenetriamine-N,N,N′,N″,N″-pentaacetic acid, triethylenetetramine-N,N,N′,N″,N′″,N′″-hexaacetic acid, and 1,2,3-triaminopropane-N,N,N′,N″,N′″,N′″-hexaacetic acid, and a part of carboxyl groups of the derivatives may form an alkaline metal salt such as a sodium salt and a potassium salt, an ammonium salt, etc.

The mass ratio of the chelating agent to the total amount of the monomers is preferably 0.01 to 0.4% by mass, more preferably 0.02 to 0.3% by mass, particularly preferably 0.03 to 0.15% by mass. When the mass ratio of the chelating agent is less than 0.01% by mass, the chelating agent cannot sufficiently capture metal ions in the preparation of the polymer latex, so that the latex is easily aggregated to be unsuitable for coating. On the other hand, when the mass ratio is more than 0.4% by mass, the viscosity of the latex is increased, so that the latex becomes poor in coating properties.

A chain transfer agent is preferably used in synthesis of the polymer latex in the invention. Preferred as the chain transfer agent are ones described in Polymer Handbook, 3rd Edition (Wiley-Interscience, 1989). Sulfur compounds are more preferable as the chain transfer agent because they are high in chain transfer ability and effective at a small dose. Hydrophobic, mercaptan-based chain transfer agents such as tert-dodecylmercaptan and n-dodecylmercaptan are particularly preferably used in the invention.

The mass ratio of the chain transfer agent to the total amount of the monomers is preferably 0.2 to 2.0% by mass, more preferably 0.3 to 1.8% by mass, particularly preferably 0.4 to 1.6% by mass. When the mass ratio of the chain transfer agent is less than 0.2% by mass, the brittleness is reduced. When the mass ratio is more than 2.0% by mass, the image storability is deteriorated.

In the emulsion polymerization, additives described in Gosei Gomu Handobukku, etc., such as an electrolyte, a stabilizer, a thickener, a defoaming agent, an antioxidant, a vulcanizing agent, an antifreezing agent, a gelling agent and a vulcanization accelerator, may be used in addition to the above-mentioned compounds.

Specific Examples of Polymer

Example Compounds (P-1) to (P-29) are illustrated below as specific examples of the polymer used in the invention without intention of restricting the scope of the invention. x, y, z, and z′ in the chemical formulae each represent a mass ratio of the polymer composition, the sum of x, y, z, and z′ being 100%. Tg is a glass-transition temperature of a dry film obtained from each polymer.

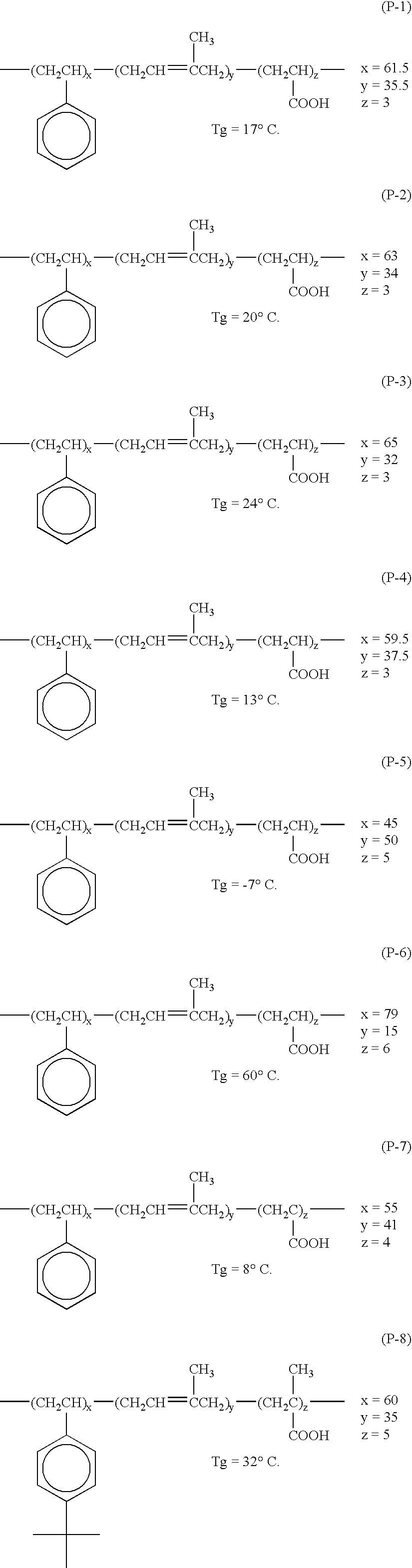

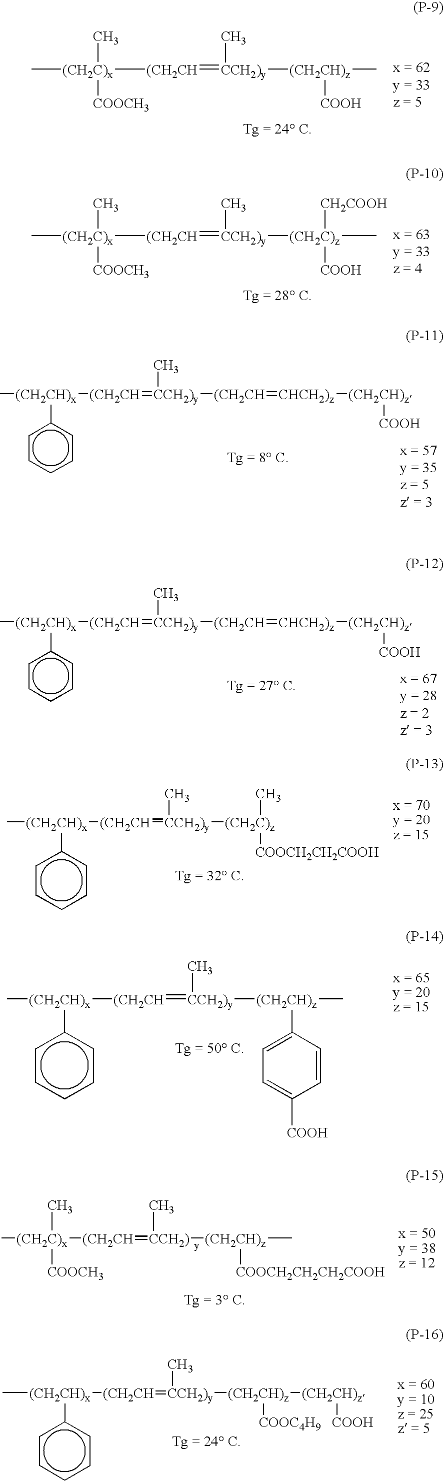

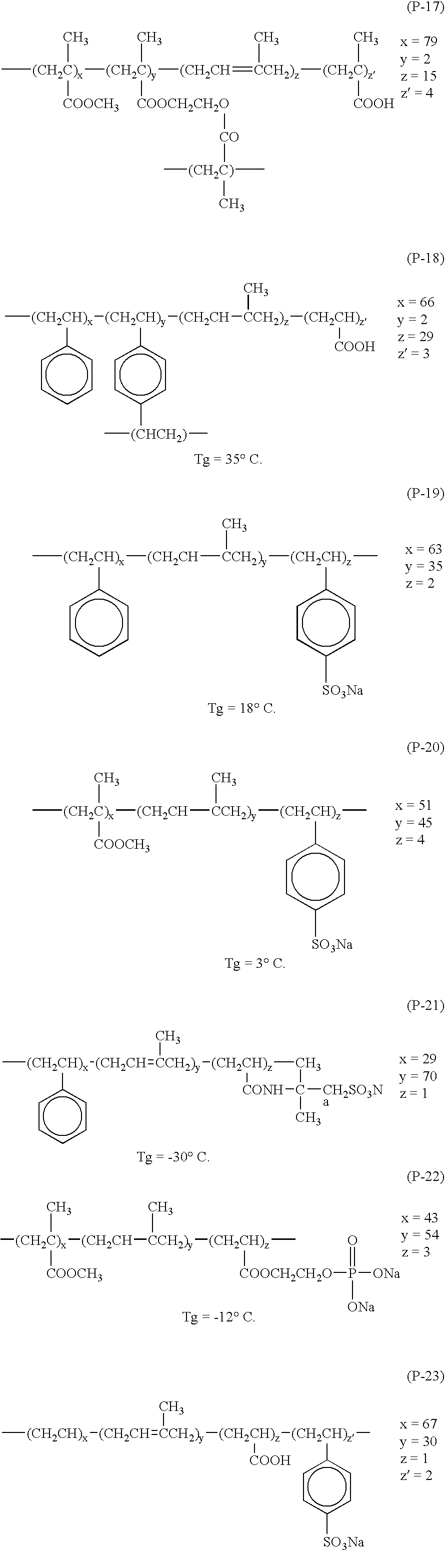

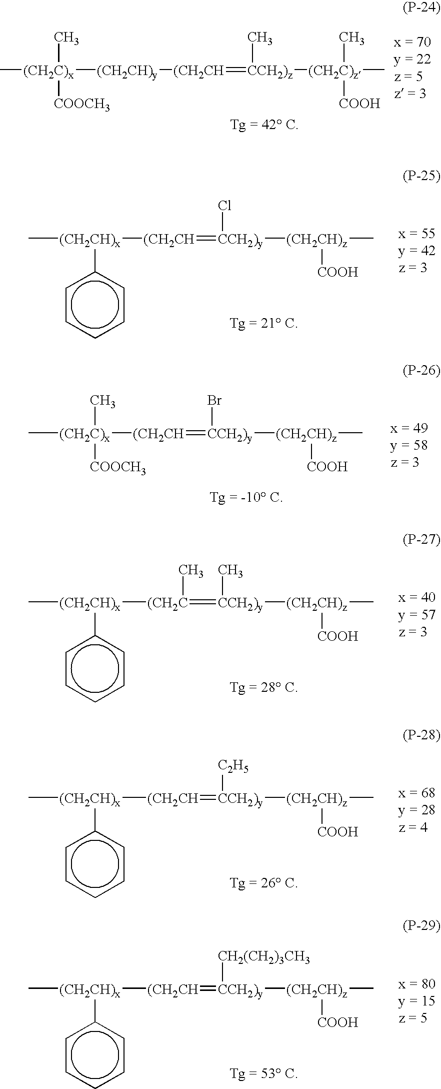

Synthesis Examples of the polymer used in the invention are described below without intention of restriction. Other Example Compounds can be synthesized in the same manner.

### Synthesis Example 1

### Synthesis of Example Compound P-1

1500 g of distilled water was put in a polymerization kettle of a gas monomer reactor TAS-2J (trade name, manufactured by Taiatsu Techno Corporation), and heated at 90° C. for 3 hours to form passive films on a stainless surface of the polymerization kettle and a member of the stirring device made of a stainless steel. To thus treated polymerization kettle were added 584.86 g of distilled water, through which nitrogen gas was passed for 1 hour beforehand, 9.45 g of a surfactant Pionine A-43-S (trade name, manufactured by Takemoto Oil & Fat Co., Ltd.), 20.25 g of 1 mol/l NaOH aqueous solution, 0.216 g of tetrasodium ethylenediaminetetraacetate, 332.1 g of styrene, 191.7 g of isoprene, 16.2 g of acrylic acid, and 4.32 g of tert-dodecylmercaptan. The gas monomer reactor was then closed, the contents were stirred at the stirring rate of 225 rpm, and the inner temperature of the reactor was raised to 60° C. A solution of 2.7 g of ammonium persulfate and 50 ml of water was added thereto and stirred for 7 hours. Further, the inner temperature of the reactor was raised to 90° C. and the resulting mixture was stirred for 3 hours. After the reaction, the inner temperature was lowered to room temperature, and the resultant was filtered by a filter cloth (mesh: 225) to obtain 1145 g of Example Compound P-1 (solid content: 45% by mass, particle diameter: 112 nm).

### Synthesis Example 2

### Synthesis of Example Compound P-2

Passive films were formed on a gas monomer reactor TAS-2J (trade name, manufactured by Taiatsu Techno Corporation) in the same manner as Synthesis Example 1. To thus treated reactor were added 350.92 g of distilled water, through which nitrogen gas was passed for 1 hour beforehand, 3.78 g of a surfactant Pionine A-43-S (trade name, manufactured by Takemoto Oil & Fat Co., Ltd.), 20.25 g of 1 mol/l NaOH aqueous solution, 0.216 g of tetrasodium ethylenediaminetetraacetate, 34.02 g of styrene, 18.36 g of isoprene, 1.62 g of acrylic acid, and 2.16 g of tert-dodecylmercaptan. The gas monomer reactor was then closed, the contents were stirred at the stirring rate of 225 rpm, and the inner temperature of the reactor was raised to 65° C. A solution of 1.35 g of ammonium persulfate and 50 ml of water was added thereto and stirred for 2 hours. An emulsion prepared by stirring 233.94 g of distilled water, 5.67 g of surfactant Pionine A-43-S (trade name, manufactured by Takemoto Oil & Fat Co., Ltd.), 306.18 g of styrene, 165.24 g of isoprene, 14.58 g of acrylic acid, 2.16 g of tert-dodecylmercaptan, and 1.35 g of ammonium persulfate was added to the gas monomer reactor over 8 hours. After the addition, the resultant mixture was stirred for 2 hours, and further the inner temperature of the reactor was raised to 90° C. and the mixture was stirred for 3 hours. After the reaction, the inner temperature was lowered to room temperature, and the resultant was filtered by a filter cloth (mesh: 225) to obtain 1147 g of Example Compound P-2 (solid content: 45% by mass, particle diameter: 121 nm).

### Synthesis Example 3

### Synthesis of Example Compound P-4

Passive films were formed on a gas monomer reactor TAS-2J (trade name, manufactured by Taiatsu Techno Corporation) in the same manner as Synthesis Example 1. To thus treated reactor were added 578.11 g of distilled water, through which nitrogen gas was passed for 1 hour beforehand, 16.2 g of a surfactant PELEX SS-H (trade name, manufactured by Kao Corporation), 20.25 g of 1 mol/l NaOH aqueous solution, 0.216 g of tetrasodium ethylenediaminetetraacetate, 321.3 g of styrene, 202.5 g of isoprene, 16.2 g of acrylic acid, and 4.32 g of tert-dodecylmercaptan. The reactor was then closed, the contents were stirred at the stirring rate of 225 rpm, and the inner temperature of the reactor was raised to 60° C. A solution of 2.7 g of ammonium persulfate and 25 ml of water was added thereto and stirred for 5 hours. Further, a solution of 1.35 g of ammonium persulfate and 25 ml of water was added thereto, the inner temperature of the reactor was raised to 90° C., and the resulting mixture was stirred for 3 hours. After the reaction, the inner temperature was lowered to room temperature, and the resultant was filtered by a filter cloth (mesh: 225) to obtain 1139 g of Example Compound P-4 (solid content: 45% by mass, particle diameter: 105 nm).

The solvent of the polymer latex coating solution for the invention may be an aqueous solvent, and an organic water mixable solvent may be used in combination with the aqueous solvent.

Examples of such organic water mixable solvents include alcohol solvents such as methyl alcohol, ethyl alcohol and propyl alcohol; cellosolve solvents such as methyl cellosolve, ethyl cellosolve and butyl cellosolve; ethyl acetate; dimethylformamide; etc. The amount of the organic solvent is preferably 50% or less, more preferably 30% or less, of the total amount of the solvent.

The polymer content of the polymer latex liquid is preferably 10 to 70% by mass, more preferably 20 to 60% by mass, particularly preferably 30 to 55% by mass.

The polymer used in the invention for the binder preferably has an equilibrium moisture content of 2% by mass or less under the conditions of 25° C. and 60% RH. The equilibrium moisture content is more preferably 0.01 to 1.5% by mass, furthermore preferably 0.02 to 1.0% by mass.

The equilibrium moisture content under the conditions of 25° C. and 60% RH can be represented by the following equation, in which W1 is a weight of the polymer in equilibrium under the humidity controlled atmosphere of 25° C. and 60% RH, and W0 is a weight of the polymer in the absolute dry state at 25° C.: Equilibrium moisture content under the conditions of 25° C. and 60% RH=[(W1−W0)/W0]×100 (% by mass)

Definitions and measuring methods of the moisture content is described in Kobunshi Kogaku Koza 14, Kobunshi Zairyo Shikenho, edited by The Society of Polymer Science, Japan, Chijin Shokan Co., Ltd., etc.

It is particularly preferred that the polymer can be dispersed in an aqueous solvent. The dispersion may be such that fine particles of a water-insoluble hydrophobic polymer are dispersed to form latex, or such that polymer molecules in molecular or micell state are dispersed. The latex dispersions are more preferably used in the invention. The average particle diameter of the dispersed particles is 1 to 50000 nm, preferably 5 to 1000 nm, more preferably 10 to 500 nm, and furthermore preferably 50 to 200 nm. The particle size distribution of the dispersed particles is not particularly restrictive, and may be a wide distribution or a monodisperse distribution. It is preferable that two or more kinds of particles having a monodisperse distribution are mixed and used to control physical properties of the coating solution.

To the image-forming layer of the invention may be added a hydrophilic polymer such as gelatine, polyvinyl alcohol, methylcellulose, hydroxypropylcellulose and carboxymethylcellulose, if necessary. The mass ratio of the added hydrophilic polymer to the total mass of binders in the image-forming layer is preferably 30% by mass or less, more preferably 20% by mass or less.

The image-forming layer is preferably formed by using the polymer latex. In the image-forming layer, the weight ratio of the binders/the organic silver salt is preferably 1/10 to 10/1, more preferably 1/3 to 5/1, furthermore preferably 1/1 to 3/1. Further, in the image-forming layer, the weight ratio of the binders/the photosensitive silver halide is preferably 400 to 5, more preferably 200 to 10.

Total amount of the binders in the image-forming layer is preferably 0.2 to 30 g/m², more preferably 1 to 15 g/m², furthermore preferably 2 to 10 g/m². A crosslinking agent, a surfactant to improve the coating properties, etc. may be added to the image-forming layer.

Organic Silver Salt

1) Composition

An organic silver salt which can be used in the invention is a silver salt which is relatively stable to the light, but functions as a silver ion donor when heated to 80° C. or higher in the presence of exposed photosensitive silver halide and a reducing agent, and, whereby, a silver image is formed. An organic silver salt may be an arbitrary organic substance which can supply a silver ion reducible by a reducing agent. Such the non-photosensitive organic silver salt is described in JP-A No. 10-62899, paragraph numbers 0048 to 0049, EP Laid-Open No. 0803764A1, page 18, line 24 to page 19, line 37, EP Laid-Open No. 0962812A1, JP-A Nos. 11-349591, 2000-7683, 2000-72711 and the like. A silver salt of an organic acid, in particular, a silver salt of a long chain aliphatic carboxylic acid (having 10 to 30 carbon atoms, preferable 15 to 28 carbon atoms) is preferable. Preferable examples of a fatty acid silver salt include silver lignocerate, silver behenate, silver arachidate, silver stearate, silver oleate, silver laurate, silver caproate, silver myristate, silver palmitate, silver erucate and a mixture thereof. In the invention, among these fatty acid silvers, it is preferable to use fatty acid silver having the silver behenate content of, preferably not less than 50% by mol and not more than 100% by mol, more preferably not less than 85% by mol and not more than 100% by mol, further preferably not less than 95% by mol and not more than 100% by mol. Further, it is preferable to use fatty acid silver having the erucic acid content of not more than 2% by mol, more preferably not more than 1% by mol, further preferably not more than 0.1% by mol.

In addition, it is preferable that the silver stearate content is not more than 1% by mol. When the stearic acid content is not more than 1% by mol, a silver salt of an organic acid having low Dₘᵢₙ and the high sensitivity and excellent in the image shelf stability is obtained. The stearic acid content is preferably not more than 0.5% by mol, particularly preferably substantially zero.

Further, when silver arachidate is contained as a silver salt of an organic acid, the silver arachidate content is preferably not more than 6% by mol in that low Dₘᵢₙ is obtained and a silver salt of an organic acid excellent in the image shelf stability is obtained, further preferably not more than 3% by mol.

2) Shape

A shape of an organic silver salt which can be used in the invention is not particularly limited, but either of needle-like, bar-like, plate-like or scale-like may be used.

In the invention, a scale-like organic silver salt is preferable. In addition, short needle-like, rectangular parallelepiped, cubic or potato-like indefinite-shaped particle having a ratio of a length of a long axis and that of a short axis of 5 or smaller is also preferably used. These organic silver particles have the characteristic that fog is small at thermal developing as compared with a long needle-like particle having a ratio of a length of a long axis and that of a short axis of 5 or larger. In particular, a particle having a ratio of a long axis and a short axis of 3 or smaller is preferable since the mechanical stability of a coated film is improved. In the invention, a scale-like organic silver salt is defined as follows: An organic acid silver salt is observed with a microscope, a shape of an organic acid silver salt particle is approximated as a rectangular parallelepiped and, letting sides of this rectangular parallelepiped to be a, b and c from shortest (c may be the same as b), shorter numerical values a and b are used for calculation, and x is obtained as follows:

x=b/a

Like this, regarding around 200 particles, x is obtained and, letting an average to be x (average), a particle satisfying the relationship x (average)≧1.5 is regarded as scale-like. Preferably 30≧x(average)≧21.5, more preferably 15≧x(average)≧1.5. Incidentally, needle-like is 1≦x(average)<1.5.

In a scale-like particle, a can be regarded as a thickness of a plate-like particle having a plane in which b and c are sides as a main plane. An average of a is preferably not less than 0.01μ and not more than 0.3 μm, more preferably not less than 0.1 μm and not more than 0.23 μm. An average of c/b is preferably not less than 1 and not more than 9, more preferably not less than 1 and not more than 6, further preferably not less than 1 and not more than 4, most preferably not less than 1 and not more than 3.

When the aforementioned sphere-equivalent diameter is not less than 0.05 μm and not more than 1 μm, aggregation hardly occurs in a photosensitive material, and the image shelf stability becomes better. The sphere-equivalent diameter is preferably not less than 0.1 μm and not more than 1 μm. In the invention, a sphere-equivalent diameter is obtained by imaging a sample directly using an electron microscope and, thereafter, subjecting a negative to image treatment.

In the scale-like particle, (sphere-equivalent diameter)/(a of a particle) is defined as an aspect ratio. An aspect ratio of a scale-like particle is preferably not less than 1.1 and not more than 30, more preferably not less than 1.1 and not more than 15 from the viewpoint that aggregation hardly occurs in a photosensitive material, and the image shelf stability becomes better.

It is preferable that a size dispersion of an organic silver salt particle is monodisperse. Monodisperse is such that a percentage of a standard deviation of a length of each of a short axis and a long axis divided by a short axis or a long axis is preferably not more than 100%, more preferably not more than 80%, further preferably not more than 50%. A shape of an organic silver salt can be obtained by a transmission electron microscope image of an organic silver salt dispersion. As another method of measuring monodispersity, there is a method of obtaining a standard deviation of a volume-weighed average diameter of an organic silver salt, and a percentage of a value divided by a volume-weighed average diameter (variation coefficient) is preferably not more than 100%, more preferably not more than 80%, further preferably not more than 50%. As a measuring method, for example, an organic silver salt dispersed in a liquid is irradiated with the laser light, a self correlation function relative to a time change of fluctuation of the scattered light is obtained, and monodispersity can be obtained from the obtained particle size (volume-weighed average diameter).

3) Preparation

As a process for preparing an organic acid silver used in the invention and a method of dispersing it, the known methods can be applied. For example, see the aforementioned JP-A No. 10-62899, EP Laid-Open Nos. 0803763A1, 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, 2002-107868 and the like.

When a photosensitive silver salt is present jointly at dispersing of an organic silver salt, since the fog is increased and the sensitivity is remarkably lowered, it is preferable that a photosensitive silver salt is not substantially contained at dispersing. In the invention, an amount of a photosensitive silver salt to be dispersed in a water dispersion is preferably not more than 1% by mol, more preferably not more than 0.1% by mol relative to 1 mol of an organic acid silver salt in the solution, further preferably a photosensitive silver salt is not added positively.

In the invention, a photosensitive material can be prepared by mixing an organic silver salt water dispersion and a photosensitive silver salt water dispersion, and a mixing ratio of an organic silver salt and a photosensitive silver salt can be selected depending on the purpose. A ratio of a photosensitive silver salt relative to an organic silver salt is preferably in a range of 1 to 30% by mol, further 2 to 20% by mol, particularly preferably in a range of 3 to 15% by mol. mixing of two or more kinds of organic silver salt water dispersions and two or more kinds of photosensitive silver salt water dispersions is a method which is preferably used for regulating the photographic properties.

4) Addition Amount

An organic silver salt in the invention can be used at a desired amount, and a total coating silver amount including silver halide is preferably 0.1 to 5.0 g/m², more preferably 0.3 to 3.0 g/m², further preferably 0.5 to 2.0 g/m². In particular, in order to improve the image shelf stability, it is preferable that a total coating silver amount is not more than 1.9 g/m², more preferably not more than 1.8 g/m², further preferably not more than 1.6 g/m². When a preferable reducing agent in the invention is used, it is possible to obtain the sufficient image concentration at such the low silver amount.

Reducing Agent

The photothermographic material of the invention preferably comprises a heat developer of a reducing agent for the organic silver salt. The reducing agent for the organic silver salt may be any substance (preferably an organic substance) to reduce a silver ion into a silver-metal. Examples of such reducing agents are described in JP-A No. 11-65021, paragraphs 0043 to 0045; EP-A No. 0803764 A1, page 7, line 34 to page 18, line 12; etc.

The reducing agent is preferably a so-called hindered phenol reducing agent having a substituent at an ortho position of the phenolic hydroxyl group, or a.bisphenol reducing agent, more preferably a compound represented by the following formula (R).

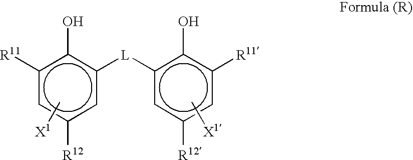

In the formula (R), R¹¹ and R^{11′} independently represent an alkyl group having 1 to 20 carbon atoms. R¹² and R^{12′} independently represent a hydrogen atom or a substituent that can bond to a benzene ring. L represents an —S— group or a —CHR¹³ — group, and R¹³ represents a hydrogen atom or an alkyl group having 1 to 20 carbon atoms. X¹ and X^{1′} independently represent a hydrogen atom or a substituent that can bond to a benzene ring.

The formula (R) is described in detail below.

1) R¹¹ and R^{11′}

R¹¹ and R^{11′} independently represent a substituted or unsubstituted alkyl group having 1 to 20 carbon atoms. The substituent on the alkyl group is not particularly restrictive, and preferably an aryl group, a hydroxy group, an alkoxy group, an aryloxy group, an alkylthio group, an arylthio group, an acylamino group, a sulfonamide group, a sulfonyl group, a phosphoryl group, an acyl group, a carbamoyl group, an ester group, a ureide group, a urethane group, a halogen atom, etc.

2) R¹² and R^{12′}, X¹ and X¹′

R¹² and R^{12′} independently represent a hydrogen atom or a substituent that can bond to a benzene ring. Also, X¹ and X^{1′} independently represent a hydrogen atom or a substituent that can bond to a benzene ring. Preferred examples of such substituents include an alkyl group, an aryl group, a halogen atom, an alkoxy group, and an acylamino group.

3) L

L represents an —S— group or a —CHR¹³— group. R¹³ represents a hydrogen atom or an alkyl group having 1 to 20 carbon atoms, and the alkyl group may have a substituent. Specific examples of the unsubstituted alkyl groups represented by R¹³ include a methyl group, an ethyl group, a propyl group, a butyl group, a heptyl group, a undecyl group, an isopropyl group, a 1-ethylpentyl group, a 2,4,4-trimethylpentyl group, etc. Examples of the substituents on the alkyl group, which may be the same as those for R¹¹, include halogen atoms, alkoxy groups, alkylthio groups, aryloxy groups, arylthio groups, acylamino groups, sulfonamide groups, sulfonyl groups, phosphoryl groups, oxycarbonyl groups, carbamoyl groups, sulfamoyl groups, etc.

4) Preferred Substituent Groups

R¹¹ and R^{11′} are preferably a secondary or tertiary alkyl group having 3 to 15 carbon atoms respectively, and specific examples thereof include an isopropyl group, an isobutyl group, a t-butyl group, a t-amyl group, a t-octyl group, a cyclohexyl group, a cyclopentyl group, a 1-methylcyclohexyl group, a 1-methylcyclopropyl group, etc. R¹¹ and R^{11′} are more preferably a tertiary alkyl group having 4 to 12 carbon atoms, furthermore preferably a t-butyl group, a t-amyl group, or a 1-methylcyclohexyl group, the most preferably a t-butyl group, respectively.

R¹² and R^{12′} are preferably an alkyl group having 1 to 20 carbon atoms respectively, and specific examples thereof include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, a methoxyethyl group, etc. R¹² and R^{12′} are more preferably a methyl group, an ethyl group, a propyl group, an isopropyl group, or a t-butyl group, respectively.

X¹ and X^{1′} are preferably a hydrogen atom, a halogen atom, or an alkyl group, more preferably a hydrogen atom, respectively.

L is preferably a —CHR¹³— group. R¹³ is preferably a hydrogen atom or an alkyl group having 1 to 15 carbon atoms, and preferred as the alkyl group are a methyl group, an ethyl group, a propyl group, an isopropyl group, and a 2,4,4-trimethylpentyl group. R¹³ is particularly preferably a hydrogen atom, a methyl group, an ethyl group, a propyl group, or an isopropyl group.

When R¹³ is a hydrogen atom, R¹² and R^{12′} are preferably an alkyl group having 2 to 5 carbon atoms, more preferably an ethyl group or a propyl group, most preferably an ethyl group, respectively.

When R¹³ is a normal or secondary alkyl group having 1 to 8 carbon atoms, R¹² and R^{12′} are preferably a methyl group. The normal or secondary alkyl group of R¹³ having 1 to 8 carbon atoms is preferably a methyl group, an ethyl group, a propyl group, or an isopropyl group, more preferably a methyl group, an ethyl group, or a propyl group.

When all of R¹¹, R^{11′}, R¹² and R^{12′} are a methyl group, R¹³ is preferably a secondary alkyl group. In this case, the secondary alkyl group of R¹³ is preferably an isopropyl group, an isobutyl group, or a 1-ethylpentyl group, more preferably an isopropyl group.

The heat developing property, the color tone of the developed silver, etc. depend on the combination of R¹¹, R^{11′}R¹², R^{12′} and R¹³ of the above reducing agent. Such properties can be controlled by combining 2 or more reducing agents, whereby it is preferable that 2 or more reducing agents are used depending the purpose.

Specific examples of the reducing agents used in the invention including the compounds represented by the formula (R) below without intention of restricting the scope of the invention.

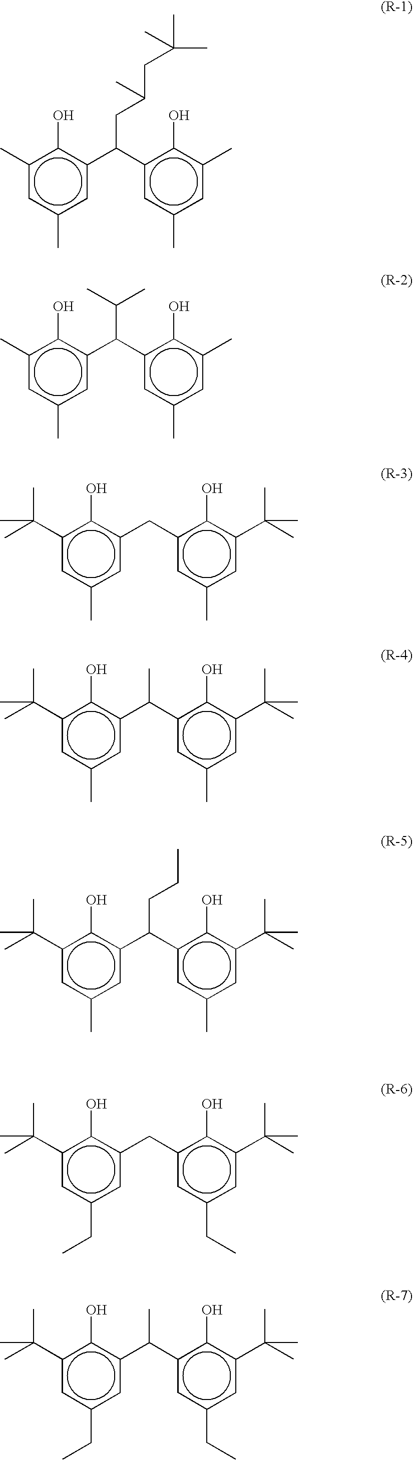

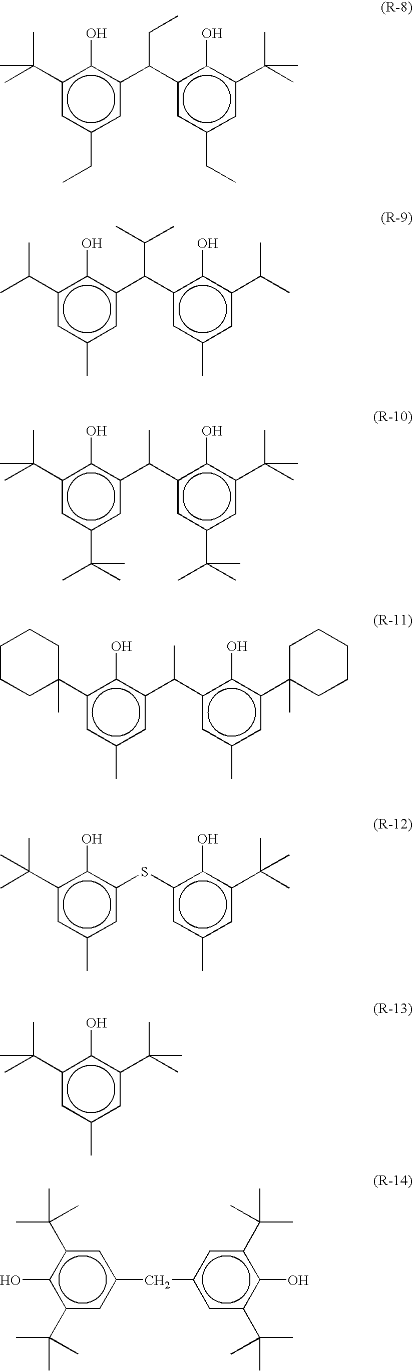

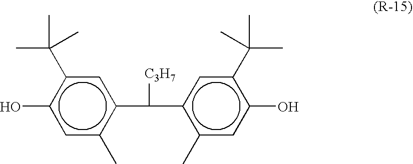

Preferred examples of the reducing agents used in the invention further include compounds described in JP-A Nos. 2001-188314, 2001-209145, 2001-350235 and 2002-156727 in addition to the above example compounds.

The amount of the reducing agent is preferably 0.1 to 3.0 g/m², more preferably 0.2 to 1.5 g/m², furthermore preferably 0.3 to 1.0 g/m². The mole ratio of the reducing agent to the silver in the image-forming layer is preferably to 50% by mol, more preferably 8 to 30% by mol, furthermore preferably 10 to 20% by mol. The reducing agent is preferably contained in the image-forming layer.

The reducing agent may be added to the coating solution by any method as a solution, an emulsified dispersion, a solid particle dispersion, etc. and then may be added to the photothermographic material.

Well known emulsification and dispersion methods are such that the component is dissolved using an oil such as dibutyl phthalate, tricresyl phosphate, glyceryl triacetate and diethyl phthalate, and a cosolvent such as ethyl acetate and cyclohexanone, and mechanically emulsified and dispersed.

The solid particle dispersion may be prepared by dispersing powder of the reducing agent in an appropriate solvent such as water using a ball mill, a colloid mill, a vibration ball mill, a sand mill, a jet mill, a roll mill, or ultrasonic wave. A protective colloid (e.g. polyvinyl alcohol) or a surfactant such as an anionic surfactant (e.g. a mixture of sodium triisopropylnaphthalene sulfonates having three isopropyl groups in different positions) may be used in the preparation. Beads of zirconia, etc. are generally used as a dispersion medium in the above mills, and there is a case where Zr, etc. is eluted from the beads and mixed with the dispersion. The amount of the beads is generally 1 to 1000 ppm and selected depending on the dispersion conditions. The Zr content of 0.5 mg or less per 1 g of silver in the photothermographic material provides no practical difficulty. An antiseptic agent such as a benzoisothiazolinone sodium salt is preferably added to an aqueous dispersion.

The solid particle dispersion methods are particularly preferred. The reducing agent is preferably added as particles, and the average particle size of the particles is 0.01 to 10 μm, preferably 0.05 to 5 μm, more preferably 0.1 to 2 μm. Also, in other solid dispersions used in the invention, the materials are preferably dispersed in this particle size.

Development Promoter

In the photothermographic material of the invention, as a development promoter, sulfonamidophenol type compounds represented by the formula (A) described in JP-A Nos. 2000-267222, 2000-330234 and the like, hindered phenol type compounds represented by the formula (II) described in JP-A No. 2001-92075, hydrazine type compounds represented by the formula (I) described in JP-A Nos. 10-62895, 11-15116 and the like, the formula (D) described in JP-A No. 2002-156727, and the formula (1) described in Japanese Patent Application No. 2001-074273, and phenol type or naphthol type compounds represented by the formula (2) described in JP-A No. 2001-264929 are preferably used. These development promoters are used in a range of 0.1 to 20% by mol, preferably in a range of 0.5 to 10% by mol, more preferably in a range of 1 to 5% by mol relative to a reducing agent. As a method of introduction into a photosensitive material, there are the same methods as those for a reducing agent. In particular, it is preferable to add as a solid dispersion or an emulsion dispersion. When added as an emulsion dispersion, it is preferable to add as an emulsion dispersion obtained by dispersing using a high boiling point solvent which is solid at a normal temperature and a low boiling point assistant solvent, or add as a so-called oilless emulsion dispersion without using a high boiling point solvent.

In the invention, among the aforementioned development promoters, hydrazine type compounds represented by the formula (D) described in JP-A No. 2002-156727, and phenol type or naphthol type compounds represented by the formula (2) described in JP-A No. 2001-264929 are more preferable.

Particularly preferable development promoters in the invention are a compound represented by the following formulae (A-1) and a compound represented by the following formula (A-2).

Q₁-NHNH-Q₂ Formula (A-1)

In the formula (A-1), Q₁ represents an aromatic group or a heterocyclic group which bonds to —NHNH-Q₂ via a carbon atom; Q₂ represents a carbamoyl group, an acyl group, an alkoxycarbonyl group, an aryloxycarbonyl group, a sulfonyl group or a sulfamoyl group.

In the formula (A-1), as an aromatic group or a heterocyclic group represented by Q₁, a 5 to 7-membered unsaturated ring is preferable. Preferable examples include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3,4-triazole ring, a 1,2,4-triazole ring, a tetrazole ring, a 1,3,4-thiadiazole ring, a 1,2,4-thiadiazole ring, a 1,2,5-thiadizole ring, a 1,3,4-oxadiazole ring, a 1,2,4-oxathiazole ring, a 1,2,5-oxathiazole ring, a thiazole ring, an oxazole ring, an isothiazole ring, an isoxazole ring, and a thiophene ring. Further, condensed rings in which these rings are mutually condensed are also preferable.

These rings may have a substituent and, when rings have two or more substituents, those substituents may be the same or different. Examples of a substituent include a halogen atom, an alkyl group, an aryl group, a carbonamido group, an alkylsulfonamido group, an aryl sulfonamido group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group, and an acyl group. When these substituents are a substitutable group, they may have a further substituent, and examples of a preferable substituent include a halogen atom, an alkyl group, an aryl group, a carbonamido group, an alkylsulfonamido group, an arylsulfonamido group, an alkoxy group, an aryloxy group, an alkylthio group, an arylthio group, an acyl group, an alkoxycarbonyl group, an aryloxycarboxyl group, a carbamoyl group, a cyano group, a sulfamoyl group, an alkylsulfonyl group, an arylsulfonyl group, and an acyloxy group.

A carbamoyl group represented by Q₂ is a carbamoyl group having, preferably 1 to 50 carbon atoms, and more preferably 6 to 40 carbon atoms, and examples thereof include unsubstituted carbamoyl group, methylcarbamoyl group, N-ethylcarbamoyl group, N-propylcarbamoyl group, N-sec-butylcarbamoyl group, N-octylcarbamoyl group, N-cyclohexylcarbamoyl group, N-tert-butylcarbamoyl group, N-dodecylcarbamoyl group, N-(3-dodecyloxypropyl)carbamoyl group, N-octadecylcarbamoyl group, N-{3-(2,4-tert-pentylphenoxy)propyl}carbamoyl group, N-(2-hexyldecyl)carbamoyl group, N-phenylcarbamoyl group, N-(4-dodecyloxyphenyl)carbamoyl group, N-(2-chloro-5-dodecyloxycarbonylphenyl) carbamoyl group, N-naphthylcarbamoyl group, N-3-pyridylcarbamoyl group, and N-benzylcarbamoyl group.

An acyl group represented by Q₂ is an acyl group having, preferably 1 to 50 carbon atoms, and more preferably 6 to 40 carbon atoms, and examples thereof include formyl group, acetyl group, 2-methylpropanoyl group, cyclohexylcarbonyl group, octanoyl group, 2-hexyldecanoyl group, decanoyl group, chroloacetyl group, trifluoroacetyl group, benzoyl group, 4-dodecyloxybenzoyl group, and 2-hydroxymethylbenzoyl group. An alkoxycarbonyl group represented by Q₂ is an alkoxycarbonyl group having, preferably 2 to 50 carbon atoms, and more preferably 6 to 40 carbon atoms, and examples thereof include methoxycarbonyl group, ethoxycarbonyl group, isobutyloxycarbonyl group, cyclohexyloxycarbonyl group, dodecyloxycarbonyl group, and benzyloxycarbonyl group.

An aryloxycarbonyl group represented by Q₂ is an aryloxycarbonyl group having, preferably 7 to 50 carbon atoms, and more preferably 7 to 40 carbon atoms, and examples thereof include phenoxycarbonyl group, 4-octyloxyphenoxycarbonyl group, 2-hydroxymethylphenoxycarbonyl group, and 4-dodecyloxyphenoxycarbonyl group. A sulfonyl group represented by Q₂ is a sulfonyl group having, preferably 1 to 50 carbon atoms, and more preferably 6 to 40 carbon atoms, and examples thereof include methylsulfonyl group, butylsulfonyl group, octylsulfonyl group, 2-hexadecylsulfonyl group, 3-dodecyloxypropylsulfonyl group, 2-octyloxy-5-tert-octylphenylsulfonyl group, and 4-dodecyloxyphenylsulfonyl group.

A sulfamoyl group represented by Q₂ is a sulfamoyl group having, preferably 0 to 50 carbon atoms, and more preferably 6 to 40 carbon atoms, and examples thereof include unsubstituted sulfamoyl group, N-ethylsulfamoyl group, N-(2-ethylhexyl)sulfamoyl group, N-decylsulfamoyl group, N-hexadecylsulfamoyl group, N-{3-(2-ethylhexyloxy)propyl}sulfamoyl group, N-(2-chloro-5-dodecyloxycarbomylphenyl)sulfamoyl group, and N-(2-tetradecyloxyphenyl)sulfamoyl group. A group represented by Q₂ may have further a group exemplified as an example of a substituent of a 5 to 7-membered unsaturated ring represented by Q₁ at a substitutable position and, when a group have two or more substituents, those substituents may be the same or different.

Then, a preferable range of compounds represented by the formula (A-1) will be described. As Q₁, a 5 to 6-membered unsaturated ring is preferable, and a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isoxazole, and rings in which these rings are condensed with a benzene ring or an unsaturated heterocycle are further preferable. In addition, Q₂ is preferably a carbamoyl group, and a carbamoyl group having a hydrogen atom on a nitrogen atom is particularly preferable.

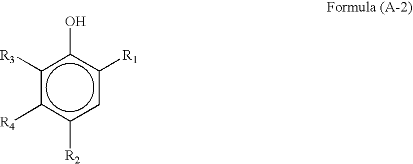

In the formula (A-2), R₁ represents an alkyl group, an acyl group, an acylamino group, an sulfonamide group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group, or a carbonic acid ester group. R₃ and R₄ each represent a group which is substitutable at a benzene ring exemplified as an example of a substituent for the formula (A-1). R₃ and R₄ may couple with each other to form a condensed ring.

R₁ is preferably an alkyl group having 1 to 20 carbon atoms (e.g. methyl group, ethyl group, isopropyl group, butyl group, tert-octyl group, cyclohexyl group etc.), an acylamino group (e.g. acetylamino group, benzoylamino group, methylureido group, 4-cyanophenylureido group etc.), a carbamoyl group (n-butylcarbamoyl group, N,N-diethylcarbamoyl group, phenylcarbamoyl group, 2-chlorophenylcarbamoyl group, 2,4-dichlorophenylcarbamoyl group etc.), and an acylamino group (including ureido group and urethane group) is more preferable.

R₂ is preferably a halogen atom (more preferably chlorine atom or bromine atom), an alkoxy group (e.g. methoxy group, butoxy group, n-hexyloxy group, n-decyloxy group, cyclohexyloxy group, benzyloxy group, etc.), or an aryloxy group (phenoxy group, naphthoxy group etc.).

R₃ is preferably a hydrogen atom, a halogen atom, an alkyl group having 1 to 20 carbon atoms, and a halogen atom is most preferable. R₄ is preferably a hydrogen atom, an alkyl group or an acylamino group, more preferably an alkyl group or an acylamino group. Examples of these preferable substituents are as in R₁. When R₄ is an acylamino group, it is preferable that R₄ and R₃ are taken together to form a carbostyryl ring.

When R₃ and R₄ in the formula (A-2) are taken together to form a condensed ring, as a condensed ring, a naphthalene ring is particularly preferable. To a naphthalene ring may be bound the same substituent as that exemplified for the formula (A-1). When the formula (A-2) is a naphthol type compound, R₁ is preferably a carbamoyl group. Inter alia, a benzoyl group is particularly preferable. R₂ is preferably an alkoxy group or an aryloxy group, particularly preferably an alkoxy group.

Preferable examples of a development promoter in the invention will be shown below. However, the invention is not limited by them.

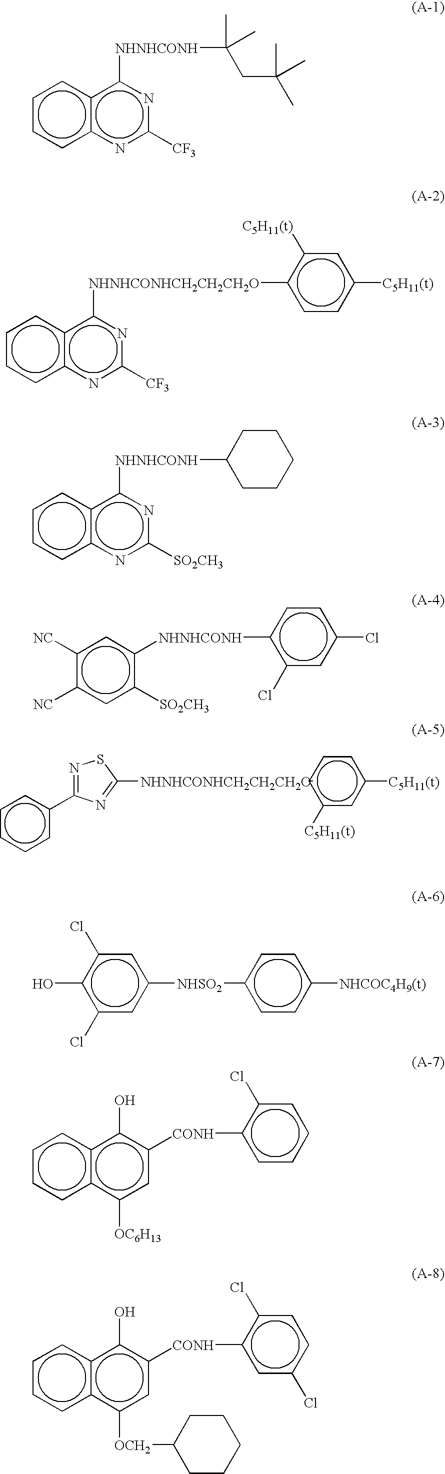

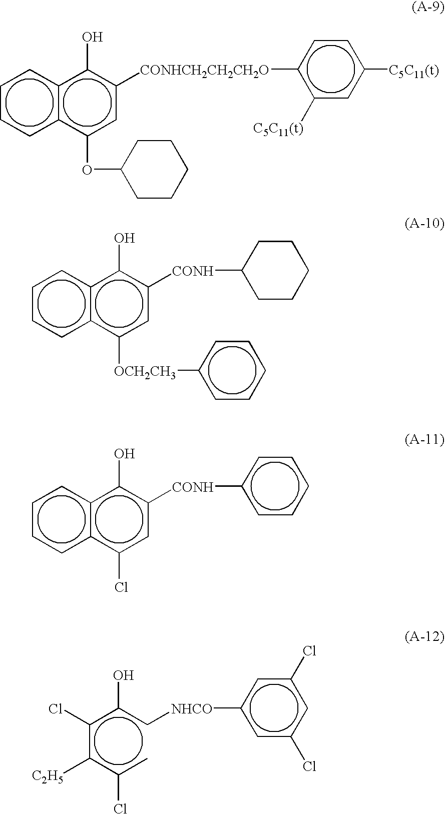

Hydrogen Bond-Forming Compound

When a reducing agent in the invention has an aromatic hydroxyl group (—OH) or amino group (—NHR, wherein R is hydrogen atom or alkyl group), in particular, the aforementioned bisphenol, it is preferable to use a non-reductive compound having a group which can form a hydrogen bond with these groups in combination.

Examples of a group which forms a hydrogen bond with a hydroxyl group or an amino group include a phosphoryl group, a sulfoxide group, a sulfonyl group, a carbonyl group, an amido group, an ester group, an urethane group, an ureido group, a tertiary amino group, and a nitrogen-containing aromatic group. Among them, preferable is a compound having a phosphoryl group, a sulfoxide group, an amido group (which has no >N—H group and is blocked like >N—Rₐ (Ra is a substituent other than H)), an urethane group (which has no >N—H group and is blocked like >N—Rₐ (Ra is a substituent other than H), or an ureido group (which has no >N—H group and is blocked like >N—Rₐ (Ra is a substituent other than H)).

In the invention, a particularly preferable hydrogen bond-forming compound is a compound represented by the following formula (D):

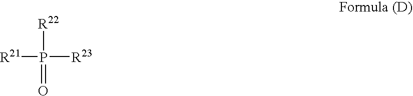

In the formula (D), R²¹ to R²³ each independently represent an alkyl group, an aryl group, an alkoxy group, an aryloxy group, an amino group or a heterocyclic group, and these groups may be unsubstituted or may have a substituent.

Examples of substituents when R²¹ to R²³ have substituents include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, and a phosphoryl group, and examples of a preferable substituent include an alkyl group or an aryl group, such as a methyl group, an ethyl group, an isopropyl group, a t-butyl group, a t-octyl group, a phenyl group, a 4-alkoxyphenyl group, and a 4-acyloxyphenyl group.

Examples of an alkyl group of R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, and a 2-phenoxypropyl group.

Examples of an aryl group include a phenyl group, a cresyl group, a xylyl group, a naphthyl group, a 4-t-butylphenyl group, a 4-t-octylphenyl group, a 4-anisidinyl group, and a 3,5-dichlorophenyl group.

Examples of an alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group and the like.

Examples of an aryloxy group include a phenoxy group, a cresyloxy group, an isopropylphenoxy group, a 4-t-butylphenoxy group, a naphthoxy group, a biphenyloxy group and the like.

Examples of an amino group include a dimethylamino group, a diethylamino group, a dibutylamino group, a dioctylamino group, a N-methyl-N-hexylamino group, a dicyclohexylamino group, a diphenylamino group, a N-methyl-N-phenylamino group and the like.

As R²¹ to R²³, an alkyl group, an aryl group, an alkoxy group, and an aryloxy group are preferable. In respect of the effect of the invention, it is preferable that at least one of R²¹ to R²³ is an alkyl group or an aryl group, and it is more preferable that two or more of R²¹ to R²³ are an alkyl group or an aryl group. In addition, from the viewpoint of inexpensive availability, it is preferable that R²¹ to R²³ are the same group.

Examples of a hydrogen bond-forming compound including a compound of the formula (D) in the invention will be shown below, but the invention is not limited by them.

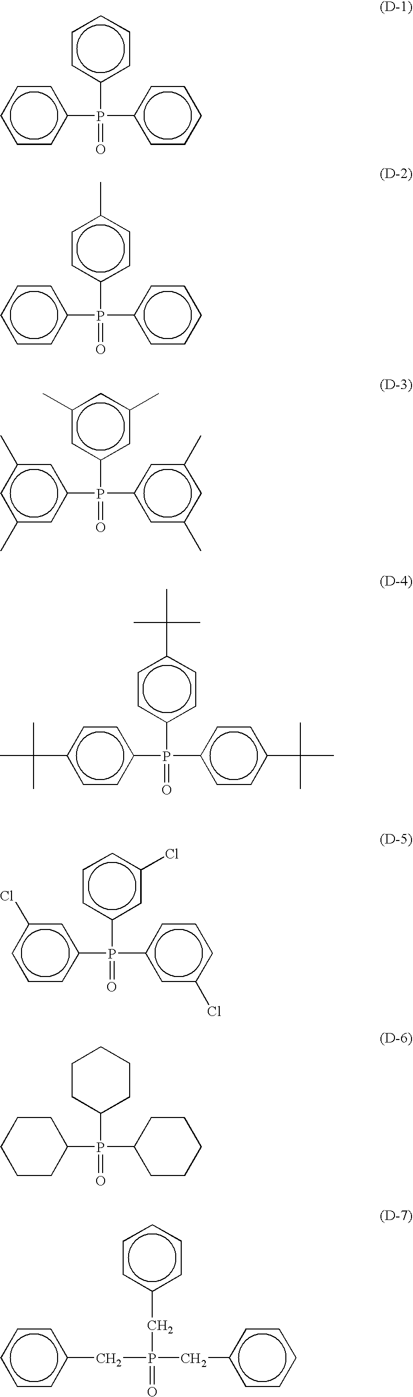

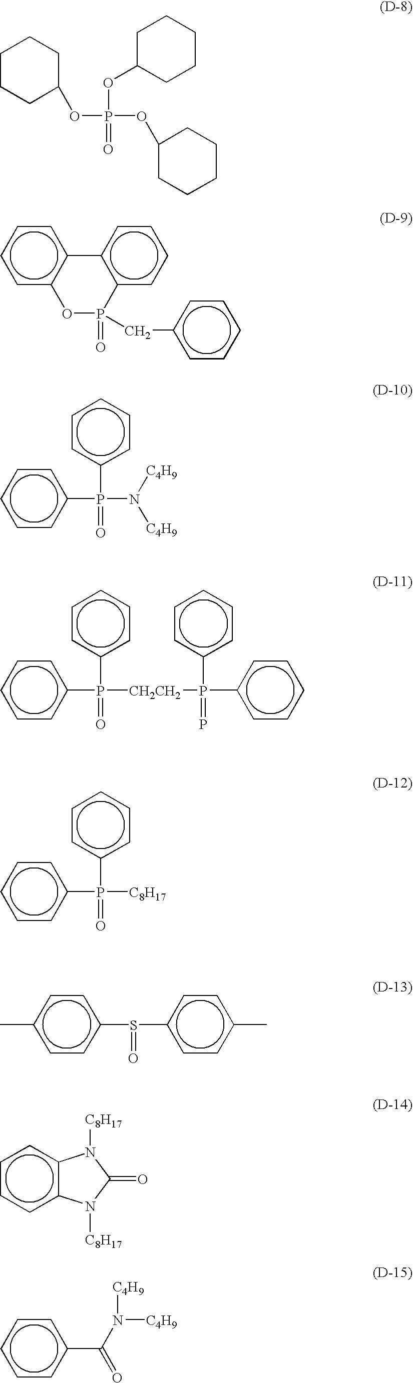

Examples of the hydrogen bond-forming compound include those described in EP No. 1096310, JP-A No. 2002-156727, and Japanese Patent Application No. 2001-124796.

The compound of the formula (D) of the invention can be made to be contained in a coating solution in the solution form, the emulsified dispersion form or the solid-dispersed fine particle dispersion form like a reducing agent, and can be used in a photosensitive material. It is preferable to use as a solid dispersion. The compound of the invention forms a hydrogen bond-forming complex with a compound having a phenolic hydroxyl group or an amino group in the solution state, and can be isolated as a complex in the crystal state depending on a combination of a reducing agent and the compound of the formula (D) of the invention.

It is particularly preferable to use the thus isolated crystal powder as a solid dispersed fine particle dispersion in order to obtain the stable performance. In addition, a method of mixing a reducing agent and the compound of formula (D) of the invention in the form of a powder, and forming a complex at dispersing with a sand grinder mill or the like using an appropriate dispersing agent may be also preferably used.

The compound of the formula (D) of the invention is used in a range of, preferably 1 to 200% by mol, more preferably in a range of 10 to 150% by mol, further preferably in a range of 20 to 100% by mol relative to a reducing agent.

Explanation of Silver Halide

1) Halogen Composition

Photosensitive silver halide used in the invention is not particularly limited in the halogen composition, and silver chloride, silver bromide chloride, silver bromide, silver bromide iodide, silver bromide chloride iodide and silver iodide can be used. Among them, silver bromide, silver bromide iodide and silver iodide are preferable. A distribution of the halogen composition in a particle may be uniform, or the halogen composition may be changed step-wisely, or may be changed continuously. In addition, a silver halide particle having a core/shell structure can be preferably used. A preferable structure is a double to quintuple structure, and a core/shell particle having a double to quartuple structure can be more preferably used. In addition, the technique of localizing silver bromide or silver iodide on the surface of a silver chloride, silver bromide or silver bromide chloride particle can be preferably used.

2) Particle Forming Method

A method of forming photosensitive silver halide is well known in the art and, for example, methods described in Research Disclosure, June 1978, No. 17029, and U.S. Pat. No. 3,700,458 can be used. Specifically, a method of preparing photosensitive silver halide by adding a silver donor compound and a halogen donor compound to a solution of gelatin or other polymer and, thereafter, mixing the photosensitive silver halide with an organic silver salt is used. Alternatively, a method described in JP-A No. 11-119374, paragraph numbers 0217 0224, and a method described in JP-A Nos. 11-352627 and 2000-347335 are preferable.

3) Particle Size

In order to suppress whitening after image formation low, a particle size of photosensitive silver halide is preferably small, specifically, 0.20 μm or smaller, more preferably not smaller than 0.01 μm and not larger than 0.15 μm, further preferably not smaller than 0.02 μm and not larger than 0.12 μm. A particle size herein refers to a diameter when converted into a circular image having the same area as the projected area of a silver halide particle (projected area of a main plane in the case of plate particle).

4) Particle Shape

Examples of a shape of a silver halide particle include a cube, an octahedron, a plate-like particle, a spherical particle, a bar-like particle, a potato-like particle and the like. In the invention, a cubic particle is particularly preferable. A particle in which a corner of a silver halide particle is round may be preferably used. A plane index (Miller index) of an outer surface of a photosensitive silver halide particle is not particularly limited, but it is preferable that a ratio occupied by a [100] plane having the high Spectral sensitizing efficacy when a Spectral sensitizing dye is adsorbed is high. The ratio is preferably 50% or more, more preferably 65% or more, further preferably 80% or more. A rate of a Miller index [100] plane can be obtained by a method described in T. Tani; J. Imaging Sci., 29, 165 (1985) utilizing adsorption dependency of a [111] plane and a [100] plane at adsorption of a sensitizing dye.

5) Heavy Metal

The photosensitive silver halide particle in the invention can contain a metal or a metal complex of Groups 8 to 10 in Periodic Table (showing Group 1 to Group 18). A metal or a central metal of a metal complex of Group 8 to Group 10 in Periodic Table is preferably rhodium, ruthenium or iridium. These metal complexes may be one kind of, or two or more kinds of complexes of homogenous metals and heterogenous metals may be used in combination. The content is preferably in a range of 1×10⁻⁹ mol to 1×10⁻³ relative to 1 mol of silver. These heavy metals and metal complexes and methods of adding them are described in JP-A Nos. 7-225449, 11-65021, paragraph numbers 0018 to 0024, and JP-A No. 11-119374, paragraph numbers 0227 to 0240.

In the invention, a silver halide particle in which a hexacyano metal complex is present on the particle superficialmost surface is preferable. Examples of the hexacyano metal complex include [Fe(CN)₆]⁴—, [Fe(CN)₆]³—, [Ru (CN)₆]⁴—, [Os(CN)₆]⁴—, [Co(CN)₆]³—, [Rh(CN)₆]³—, [Ir(CN)₆]³—, [Cr(CN)₆]³— and [Re(CN)₆]³—. In the invention, a hexacyano Fe complex is preferable.

Since the hexacyano metal complex is present as an ionic form in an aqueous solution, a counter-positive ion is not important, but it is preferable to use an alkali metal ion such as a sodium ion, a potassium ion, a rubidium ion, a cesium ion and a lithium ion, an ammonium ion, or an alkylammonium ion (e.g. tetramethylammonium ion, tetraethylammonium ion, tetrapropylammonium ion, tetra(n-butyl)ammonium ion), which is easily compatible with water, and is suitable for precipitation procedures of a silver halide emulsion.

The hexacyano metal complex may be added by kneading with a mixed solvent of water and an appropriate organic solvent which is compatible with water (e.g. alcohols, ethers, glycols, ketones, esters, amides etc.), or with gelatin.

An amount of the hexacyano metal complex to be used is preferably not smaller than 1×10⁻⁵ mol and not larger than 1×10⁻² mol, more preferably not smaller than 1×10⁻⁴ mol and not larger than 1×10⁻³ mol per 1 mol of silver.

In order that the hexacyano metal complex is present on the superficalmost surface of a silver halide particle, after addition of an aqueous silver nitrate solution used for forming a particle is completed, the hexacyano metal complex is directly added before completion of a charging step before a chemically sensitizing step of performing chalcogen sensitization such as sulfur sensitization, selenium sensitization and tellurium sensitization or noble metal sensitization such as gold sensitization, during a water washing step, during a dispersing step, or before a chemically sensitizing step. In order that a silver halide fine particle is not grown, it is preferable to add the hexacyano metal complex rapidly after particle formation, and it is preferable to add before completion of a charging step.

Addition of the hexacyano metal complex may be initiated after 96% by weight of a total amount of silver nitrate to be added for particle formation is added, and it is more preferable to initiate after 98% by weight is added, and it is particularly preferable to initiate after 99% by weight is added.

When the hexacyano metal complex is added after an aqueous silver nitrate solution is added immediately before completion of particle formation, the complex can be adsorbed on the superficialmost surface of a silver halide particle, and a majority of the complex forms a hardly-soluble salt with a silver ion on the particle surface. Since this silver salt of hexacyanoferrate (II) is a salt which is less soluble than AgI, re-dissolution due to a fine particle can be prevented, and it becomes possible to prepare a silver halide fine particle having a small particle size.

Further, a metal atom (e.g. [Fe(CN)₆]⁴) which can be contained in a silver halide particle which is used in the invention, a desalting method and a chemically sensitizing method for a silver halide emulsion are described in JP-A No. 11-84574, paragraph numbers 0046 to 0050, JP-A No. 11-65021, paragraph numbers 0025 to 0031, and JP-A No. 11-119374, paragraph numbers 0242 to 0250.

6) Gelatin

As gelatin to be contained in a photosensitive silver halide emulsion used in the invention, various gelatins can be used. Since it is necessary to maintain the dispersed state better in an organic silver salt-containing coating solution of a photosensitive silver halide emulsion, it is preferable to use gelatin having a molecular weight of 10,000 to 1,000,000. Alternatively, it is preferable to phthalation-treat a substituent of gelatin. The gelatin may be used at particle formation or at dispersing after desalting treatment, but it is preferable to use at particle formation.

7) Sensitizing Dye

As a sensitizing dye which can be applied to the invention, a sensitizing dye which can spectrally-sensitize a silver halide particle at a desired wavelength region upon adsorption onto a silver halide particle and has the spectral sensitivity suitable for the spectral property of an exposing light source can be advantageously selected. A sensitizing dye and a method of adding the same are described in JP-A No. 11-65021, paragraph numbers 0103 to 0109, a compound represented by the formula (II) of JP-A 10-186572, a dye represented by the formula (I) of JP-A No. 11-119374, a pigment described in paragraph number 0106, U.S. Pat. Nos. 5,510,236, 3,871,887, Example 5, a dye disclosed in JP-A Nos. 2-96131, 59-48753, EP Laid-Open No. 0803764A1, page 19, line 38 to page 20, line 35, JP-A Nos. 2001-272747, 2001-290238, 2002-23306 and the like. These sensitizing dyes may be used alone, or may be used by combining two or more. A time for adding a sensitizing dye to a silver halide emulsion in the invention is preferably after a desalting step and by coating, more preferably after desalting and before completion of chemical aging.

An amount of a sensitizing dye to be used in the invention can be a desired amount in conformity with the sensitivity and the performance of fog, and preferably 10⁻⁶ to 1 mol, more preferably 10⁻⁴ to 10⁻¹ mol per 1 mol of silver halide in a photosensitive layer.

In the invention, in order to improve the spectral sensitizing efficacy, a strong sensitizer can be used. Examples of the strong sensitizer used in the invention include compounds described in EP Laid-Open No. 587,338, U.S. Pat. Nos. 3,877,943, 4,873,184, JP-A Nos. 5-341432, 11-109547, 10-111543 and the like.

8) Chemical Sensitization

It is preferable that a photosensitive halide particle in the invention is chemically sensitized by a sulfur sensitizing method, a selenium sensitizing method or a tellurium sensitizing method. As a compound which is preferably used in a sulfur sensitizing method, a selenium sensitizing method and a tellurium sensitizing method, the known compounds, for example, compounds described in JP-A No. 7-128768 can be used. In the invention, tellurium sensitization is particularly preferable, and compounds described in the literatures described in JP-A No. 11-65021, paragraph number 0030, and compounds represented by the formulae (II), (III) and (IV) in JP-A No. 5-313284 are more preferable.

It is preferable that a photosensitive silver halide particle in the invention is chemically sensitized by a gold sensitizing method alone or in a combination with the aforementioned chalcogen sensitization. As a gold sensitizer, gold valence of +1 valence or +3 valence is preferable and, as a gold sensitizer, gold compounds which are usually used are preferable. Representative examples of aurate chloride, aurate bromide, potassium chloroaurate, potassium bromoaurate, auric trichloride, potassium auric thiocyanate, potassium iodoaurate, tetracyanoauric acid, ammonium aurothiocyanate and pyridyltrichlorogold are preferable. Alternatively, gold sensitizers described in U.S. Pat. No. 5,858,637 and Japanese Patent Application No. 2001-79450 are preferably used.

In the invention, chemical sensitization may be performed at any time as far as it is after particle formation and before coating, such as after desalting (1) before spectral sensitization, (2) at the same time with spectral sensitization, (3) after spectral sensitization (4) immediately before coating etc.

An amount of a sulfur, selenium or tellurium sensitizer used in the invention varies depending on a silver halide particle to be used, chemical aging conditions and the like, and around 10⁻⁸ to 10⁻² mol, preferably around 10⁻⁷ to 10⁻³ mol is used per 1 mol of silver halide.

An amount of a gold sensitizer to be added varies depending on various conditions, and a standard is 10⁻⁷ mol to 10⁻³ mol, more preferably 10⁻⁶ mol to 5×10⁻⁴ mol per 1 mol of silver halide.

The conditions of chemical sensitization in the invention are not particularly limited, but a pH is 5 to 8, a pAg is 6 to 11, and a temperature is around 40 to 95° C.

A thiosulfonic acid compound may be added to a silver halide emulsion used in the invention by a method shown in EP Publication No. 293,917.

It is preferable that a reducing agent is used in a photosensitive silver halide particle in the invention. As a specific compound for a reductive sensitizing method, ascorbic acid and thiourea dioxide are preferable and, besides, it is preferable to use stannous chloride, aminoiminomethanesulfinic acid, a hydrazine derivative, a borane compound, a silane compound, a polyamine compound or the like. A reductive sensitizer may be added at any stage of a photosentitive emulsion preparing step from a crystal growth step to a preparing step immediately before coating. In addition, it is preferable that reductive sensitization is performed by aging while retaining a pH of an emulsion at 7 or higher and a pAg at 8.3 or smaller, and it is also preferable that reductive sensitization is performed by introducing a single addition portion of a silver ion during particle formation.

9) Compound that Can be One-Electron-Oxidized to Provide One-Electron Oxidation Product to Release Further 1 or More Electron

The photothermographic material of the invention preferably comprises a compound that can be one-electron-oxidized to provide a one-electron oxidation product, which can release further 1 or more electron. The compound is used alone or in combination with the above-mentioned various chemical sensitizers, to increase the sensitivity of the silver halide.

The compound is selected from compounds of Types 1 to 5.

Type 1: a compound that can be one-electron-oxidized to provide a one-electron oxidation product, which can release 2 or more electrons in or after a subsequent bond cleavage reaction.

Type 2: a compound that has 2 or more adsorbent groups to the silver halide and can be one-electron-oxidized to provide a one-electron oxidation product, which can release 1 electron in or after a subsequent bond cleavage reaction.

Type 3: a compound that can be one-electron-oxidized to provide a one-electron oxidation product, which can release 1 or more electron after a subsequent bond formation.

Type 4: a compound that can be one-electron-oxidized to provide a one-electron oxidation product, which can release 1 or more electron after a subsequent ring cleavage reaction.

Type 5: a compound represented by X—Y, in which X represents a reducing group and Y represents a leaving group, and convertable by one-electron-oxidizing the reducing group to a one-electron oxidation product, which can be converted into an X radical by eliminating the leaving group Y in a subsequent X—Y bond cleavage reaction, and 1 electron is capable of being released from the X radical.

Each compound of Types 1 and 3 to 5 preferably has an adsorbent group to the silver halide, or a spectrally sensitizing dye moiety, more preferably has the adsorbent group to the silver halide. Each compound of Types 1 to 4 more preferably has a nitrogen-containing heterocyclic group substituted by 2 or more mercapto group as the adsorbent group.

The compounds of Types 1 to 5 are described in detail below.

In the compound of Type 1, the term “the bond cleavage reaction” specifically means a cleavage reaction of a bond of carbon-carbon, carbon-silicon, carbon-hydrogen, carbon-boron, carbon-tin or carbon-germanium. Cleavage of a carbon-hydrogen bond may be caused with the cleavage reaction. The compound of Type 1 can be one-electron-oxidized to be converted into the one-electron oxidation product, and thereafter can release further 2 or more electrons, preferably 3 or more electrons, with the bond cleavage reaction.

The compound of Type 1 is preferably represented by any one of formulae (A), (B), (i), (ii) and (iii).

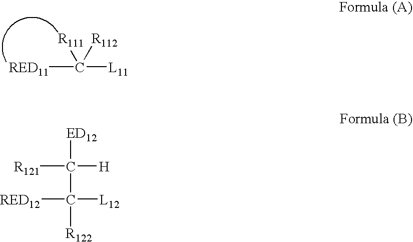

In the formula (A), RED₁₁, represents a reducing group that can be one-electron-oxidized, and L₁₁ represents a leaving group. R₁₁₂ represents a hydrogen atom or a substituent. R₁₁₁ represents a nonmetallic atomic group to form a ring structure corresponding to a tetrahydro-, hexahydro- or octahydro-derivative of a 5- or 6-membered aromatic ring including aromatic heterocycles with a carbon atom C and RED₁₁.

In the formula (B), RED₁₂ represents a reducing group that can be one-electron-oxidized, and L₁₂ represents a leaving group. R₁₂₁ and R₁₂₂ each represent a hydrogen atom or a substituent. ED₁₂ represents an electron-donating group. In the formula (B), R₁₂₁ and RED₁₂, R₁₂₁ and R₁₂₂, and ED₁₂ and RED₁₂ may bond together to form a ring structure, respectively.

In the compound represented by the formula (A) or (B) the reducing group of RED₁₁ or RED₁₂ is one-electron-oxidized, and thereafter the leaving group of L₁₁ or L₁₂ is spontaneously eliminated in the bond cleavage reaction. Further 2 or more, preferably 3 or more, electrons can be released with the bond cleavage reaction.

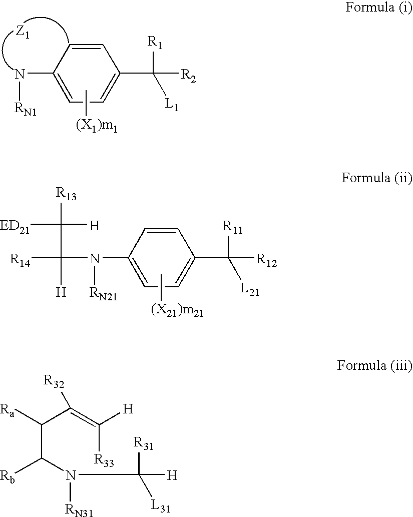

In the formula (i), Z₁ represents an atomic group forming a 6-membered ring with a nitrogen atom and 2 carbon atoms in a benzene ring; R₁, R₂ and R_{N1} each represent a hydrogen atom or a substituent; X₁ represents a substituent linkable to the benzene ring; m₁ represents an integer of 0 to 3; and L₁ represents a leaving group.

In the formula (ii), ED₂₁ represents an electron-donating group; R₁₁, R₁₂, R_{N21}, R₁₃ and R₁₄ each represent a hydrogen atom or a substituent; X₂₁ represents a substituent linkable to a benzene ring; m₂₁ represents an integer of 0 to 3; and L₂₁ represents a leaving group. R_{N21}, R₁₃, R₁₄, X₂₁ and ED₂₁ may bond to each other to form a ring structure.

In the formula (iii), R₃₂, R₃₃, R₃₁, R_{N31}, Rₐ and R_{b} each represent a hydrogen atom or a substituent; and L₃₁ represents a leaving group. Incidentally, Rₐ and R_{b} bond together to form an aromatic ring when R_{N31} is not an aryl group.

After the compound represented by the formula (i), (ii) or (iii) is one-electron-oxidized, the leaving group of L₁, L₂₁ or L₃₁ is spontaneously eliminated in the bond cleavage reaction. Further 2 or more, preferably 3 or more, electrons can be released with the bond cleavage reaction.

First, the compound represented by the formula (A) will be described in detail below.

In the formula (A), the reducing group of RED₁₁, can be one-electron-oxidized and can bond to after-mentioned R₁₁₁ to form the particular ring structure. Specifically, the reducing group may be a divalent group provided by removing 1 hydrogen atom from the following monovalent group at a position suitable for ring formation.

The monovalent group may be an alkylamino group; an arylamino group such as an anilino group and a naphthylamino group; a heterocyclic amino group such as a benzthiazolylamino group and a pyrrolylamino group; an alkylthio group; an arylthio group such as a phenylthio group; a heterocyclic thio group; an alkoxy group; an aryloxy group such as a phenoxy group; a heterocyclic oxy group; an aryl group such as a phenyl group, a naphthyl group and an anthranil group; or an aromatic or nonaromatic heterocyclic group containing at least one heteroatom selected from the group consisting of a nitrogen atom, a sulfur atom, an oxygen atom and a selenium atom, which has a 5- to 7-membered, monocyclic or condensed ring structure such as a tetrahydroquinoline ring, a tetrahydroisoquinoline ring, a tetrahydroquinoxaline ring, a tetrahydroquinazoline ring, an indoline ring, an indole ring, an indazole ring, a carbazole ring, a phenoxazine ring, a phenothiazine ring, a benzothiazoline ring, a pyrrole ring, an imidazole ring, a thiazoline ring, a piperidine ring, a pyrrolidine ring, a morpholine ring, a benzimidazole ring, a benzimidazoline ring, a benzoxazoline ring and a methylenedioxyphenyl ring. RED₁₁ is hereinafter described as the monovalent group for convenience. The monovalent groups may have a substituent.

In the invention, the term “substituent” means an atom or a group selected from the following examples when a particular explanation is not provided therefor. Examples of the substituent include halogen atoms; alkyl groups including aralkyl groups, cycloalkyl groups, active methine groups, etc.; alkenyl groups; alkynyl groups; aryl groups; heterocyclic groups, which may bond at any position; heterocyclic groups containing a quaternary nitrogen atom such as a pyridinio group, an imidazolio group, a quinolinio group and an isoquinolinio group; acyl groups; alkoxycarbonyl groups; aryloxycarbonyl groups; carbamoyl groups; a carboxy group and salts thereof; sulfonylcarbamoyl groups; acylcarbamoyl groups; sulfamoylcarbamoyl groups; carbazoyl groups; oxalyl groups; oxamoyl groups; a cyano group; carbonimidoyl groups; thiocarbamoyl groups; a hydroxy group; alkoxy groups, which may contain a plurality of ethyleneoxy groups or propyleneoxy groups as a repetition unit; aryloxy groups; heterocyclic oxy groups; acyloxy groups; alkoxy or aryloxy carbonyloxy groups; carbamoyloxy groups; sulfonyloxy groups; amino groups; alkyl, aryl or heterocyclic amino groups; acylamino groups; sulfoneamide groups; ureide groups; thioureide groups; imide groups; alkoxy or aryloxy carbonylamino groups; sulfamoylamino groups; semicarbazide groups; thiosemicarbazide groups; hydrazino groups; ammonio groups; oxamoylamino groups; alkyl or aryl sulfonylureide groups; acylureide groups; acylsulfamoylamino groups; a nitro group; a mercapto group; alkyl, aryl or heterocyclic thio groups; alkyl or aryl sulfonyl groups; alkyl or aryl sulfinyl groups; a sulfo group and salts thereof; sulfamoyl groups; acylsulfamoyl groups; sulfonylsulfamoyl groups and salts thereof; groups containing a phosphoric amide or phosphate ester structure; etc. The substituents may be further substituted by the substituent.

RED₁₁ is preferably an alkylamino group, an arylamino group, a heterocyclic amino group, an aryl group, or an aromatic or nonaromatic, heterocyclic group, more preferably an arylamino group (particularly an anilino group) or an aryl group (particularly a phenyl group). When the groups have a substituent, preferred as the substituent are halogen atoms, alkyl groups, alkoxy groups, carbamoyl groups, sulfamoyl groups, acylamino groups, and sulfoneamide groups.

When RED₁₁ is an aryl group, it is preferred that the aryl group has at least one electron-donating group. The electron-donating group is a hydroxy group; an alkoxy group; a mercapto group; a sulfoneamide group; an acylamino group; an alkylamino group; an arylamino group; a heterocyclic amino group; an active methine group; an electron-excess, aromatic, 5-membered, monocyclic or condensed, heterocyclic group containing at least one nitrogen atom, such as an indolyl group, a pyrrolyl group, an imidazolyl group, a benzimidazolyl group, a thiazolyl group, a benzthiazolyl group and an indazolyl group; a nitrogen-containing, nonaromatic heterocyclic group (or a cyclic amino group) that substitutes at the nitrogen atom, such as a pyrrolidinyl group, an indolinyl group, a piperidinyl group, a piperazinyl group and a morpholino group; etc. The active methine group is a methine group having 2 electron-withdrawing groups, and the electron-withdrawing group is an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group or a carbonimidoyl group. The 2 electron-withdrawing groups may bond together to form a ring structure.

In the formula (A), specific examples of L₁₁ include a carboxy group and salts thereof, silyl groups, a hydrogen atom, triarylboron anions, trialkylstannyl groups, trialkylgermyl groups and a —CR_{C1}R_{C2}R_{C3} group. The silyl group is specifically a trialkylsilyl group, an aryldialkylsilyl group, a triarylsilyl group, etc., and may have a substituent.

When L₁₁ represents a salt of a carboxy group, specific examples of counter ions to form the salt include alkaline metal ions, alkaline earth metal ions, heavy metal ions, ammonium ions, phosphonium ions, etc. The counter ion is preferably an alkaline metal ion or an ammonium ion, the most preferably an alkaline metal ion, particularly Li⁺, Na⁺, or K⁺ ion.

When L₁₁ represents a —CR_{C1}R_{C2}R_{C3} group, R_{C1}, R_{C2} and R_{C3} independently represent a hydrogen atom, an alkyl group, an aryl group, a heterocyclic group, an alkylthio group, an arylthio group, an alkylamino group, an arylamino group, a heterocyclic amino group, an alkoxy group, an aryloxy group or a hydroxy group. R_{C1}, R_{C2} and R_{C3} may bond to each other to form a ring structure, and may have a substituent. Incidentally, when one of R_{C1}, R_{C2} and R_{C3} is a hydrogen atom or an alkyl group, there is no case where the other two of them are a hydrogen atom or an alkyl group. R_{C1}, R_{C2} and R_{C3} are preferably an alkyl group, an aryl group (particularly a phenyl group), an alkylthio group, an arylthio group, an alkylamino group, an arylamino group, a heterocyclic group, an alkoxy group or a hydroxy group, respectively. Specific examples thereof include a phenyl group, a p-dimethylaminophenyl group, a p-methoxyphenyl group, a 2,4-dimethoxyphenyl group, a p-hydroxyphenyl group, a methylthio group, a phenylthio group, a phenoxy group, a methoxy group, an ethoxy group, a dimethylamino group, an N-methylanilino group, a diphenylamino group, a morpholino group, a thiomorpholino group, a hydroxy group, etc. Examples of the ring structure formed by R_{C1}, R_{C2} and R_{C3} include a 1,3-dithiolane-2-yl group, a 1,3-dithiane-2-yl group, an N-methyl-1,3-thiazolidine-2-yl group, an N-benzyl-benzothiazolidine-2-yl group, etc.

It is also preferred that the —CR_{C1}R_{C2}R_{C3} group is the same as a residue provided by removing L₁₁ from the formula (A) as a result of selecting each of R_{C1}, R_{C2} and R_{C3} as above.

In the formula (A), L₁₁ is preferably a carboxy group or a salt thereof, or a hydrogen atom, more preferably a carboxy group or a salt thereof.

When L₁₁ represents a hydrogen atom, the compound represented by the formula (A) preferably has a base moiety. After the compound represented by the formula (A) is oxidized, the base moiety acts to depronate the hydrogen atom of L₁₁ to release an electron.

The base is specifically a conjugate base of an acid with a pKa value of approximately 1 to 10. For example, the base moiety may contain a structure of a nitrogen-containing heterocycle such as pyridine, imidazole, benzoimidazole and thiazole; aniline; trialkylamine; an amino group; a carbon acid such as an active methylene anion; a thioacetic acid anion; carboxylate (—COO⁻); sulfate (—SO₃⁻); amineoxide (>N⁺(O⁻)—); etc. The base is preferably a conjugate base of an acid with a pKa value of approximately 1 to 8, more preferably carboxylate, sulfate or amineoxide, particularly preferably carboxylate. When these bases have an anion, the compound of the formula (A) may have a counter cation. Examples of the counter cation include alkaline metal ions, alkaline earth metal ions, heavy metal ions, ammonium ions, phosphonium ions, etc. The base moiety may be at an optional position of the compound represented by the formula (A). The base moiety may be connected to RED₁₁, R₁₁₁ or R₁₁₂ in the formula (A), or to a substituent thereon.

In the formula (A), R₁₁₂ represents a hydrogen atom or a substituent linkable to a carbon atom. Incidentally, R₁₁₂ cannot represent the same group as L₁₁.

R₁₁₂ is preferably a hydrogen atom; an alkyl group; an aryl group such as a phenyl group; an alkoxy group such as a methoxy group, an ethoxy group and a benzyloxy group; a hydroxy group; an alkylthio group such as a methylthio group and a butylthio group; an amino group; an alkylamino group; an arylamino group; or a heterocyclic amino group. R₁₁₂ is more preferably a hydrogen atom, an alkyl group, an alkoxy group, a hydroxy group, a phenyl group or an alkylamino group.

In the formula (A), the ring structure formed by R₁₁₁ corresponds to a tetrahydro-, hexahydro- or octahydro-derivative of a 5- or 6-membered aromatic ring including aromatic heterocycles. The tetrahydro-, hexahydro- or octahydro-derivative means a ring structure derived by partly hydrogenating carbon-carbon double bonds and/or carbon-nitrogen double bonds of an aromatic ring or an aromatic heterocycle. The tetrahydro-, hexahydro-, or octahydro-derivative means a ring structure derived by hydrogenating 2, 3, or 4 double bonds of carbon-carbon or carbon-nitrogen, respectively. The aromatic ring is hydrogenated and converted into a partly hydrogenated, nonaromatic ring structure.

Specifically, examples of such ring structures include a pyrrolidine ring, an imidazolidine ring, a thiazolidine ring, a pyrazolidine ring, an oxazolidine ring, a piperidine ring, a tetrahydropyridine ring, a tetrahydropyrimidine ring, a piperazine ring, a tetralin ring, a tetrahydroquinoline ring, a tetrahydroisoquinoline ring, a tetrahydroquinazoline ring, a tetrahydroquinoxaline ring, a tetrahydrocarbazole ring, an octahydrophenanthridine ring, etc. These ring structures may have a substituent.

The ring structure formed by R₁₁₁ is more preferably a pyrrolidine ring, an imidazolidine ring, a piperidine ring, a tetrahydropyridine ring, a tetrahydropyrimidine ring, a piperazine ring, a tetrahydroquinoline ring, a tetrahydroisoquinoline ring, a tetrahydroquinazoline ring, a tetrahydroquinoxaline ring, or a tetrahydrocarbazole ring, particularly preferably a pyrrolidine ring, a piperidine ring, a piperazine ring, a tetrahydropyridine ring, a tetrahydroquinoline ring, a tetrahydroisoquinoline ring, a tetrahydroquinazoline ring, or a tetrahydroquinoxaline ring, the most preferably a pyrrolidine ring, a piperidine ring, a tetrahydropyridine ring, a tetrahydroquinoline ring, or a tetrahydroisoquinoline ring.

In the formula (B), RED₁₂ and L₁₂ are the same as RED₁₁ and L₁₁ in the formula (A) with respect to the meanings and preferred embodiments, respectively. Incidentally, RED₁₂ is a monovalent group except for the case of forming a ring structure mentioned below. Specific examples of RED₁₂ are the same as above-mentioned examples of the monovalent group to provide RED₁₁. R₁₂₁ and R₁₂₂ are the same as R₁₂ in the formula (A) with respect to the meanings and preferred embodiments, respectively. ED₁₂ represents an electron-donating group. Each combination of R₁₂₁ and RED₁₂, R₁₂₁ and R₁₂₂, and ED₁₂ and RED₁₂ may bond together to form a ring structure.

The electron-donating group of ED₁₂ in the formula (B) is the same as above-mentioned electron-donating group that acts as a substituent on RED₁₁ when RED₁₁ is an aryl group. ED₁₂ is preferably a hydroxy group; an alkoxy group; a mercapto group; a sulfoneamide group; an alkylamino group; an arylamino group; an active methine group; an electron-excess, aromatic, 5-membered, monocyclic or condensed, heterocyclic group containing at least one nitrogen atom in the ring; a nitrogen-containing, nonaromatic heterocyclic group that substitutes at the nitrogen atom; or a phenyl group having a substituent composed thereof. ED₁₂ is more preferably a hydroxy group; a mercapto group; a sulfoneamide group; an alkylamino group; an arylamino group; an active methine group; a nitrogen-containing, nonaromatic heterocyclic group that substitutes at the nitrogen atom; or a phenyl group having a substituent composed thereof such as a p-hydroxyphenyl group, a p-dialkylaminophenyl group and an o,p-dialkoxyphenyl group.

In the formula (B), each combination of R₁₂₁ and RED₁₂, R₁₂₂ and R₁₂₁, and ED₁₂ and RED₁₂ may bond together to form a ring structure. The ring structure is a 5- to 7-membered, monocyclic or condensed, substituted or unsubstituted, carbocyclic or heterocyclic, nonaromatic ring. Specific examples of the ring structures formed by R₁₂₁ and RED₁₂ include a pyrroline ring, an imidazoline ring, a thiazoline ring, a pyrazoline ring, an oxazoline ring, an indane ring, a morpholine ring, an indoline ring, a tetrahydro-1,4-oxazine ring, a 2,3-dihydrobenzo-1,4-oxazine ring, a tetrahydro-1,4-thiazine ring, a 2,3-dihydrobenzo-1,4-thiazine ring, a 2,3-dihydrobenzofuran ring, 2,3-dihydrobenzothiophene ring, etc. in addition to examples of the ring structures formed by R₁₁₁ in the formula (A). When ED₁₂ and RED₁₂ form a ring structure, ED₁₂ preferably represents an amino group, an alkylamino group or an arylamino group, and specific examples of the ring structures include a tetrahydropyrazine ring, a piperazine ring, a tetrahydroquinoxaline ring, a tetrahydroisoquinoline ring, etc. When R₁₂₂ and R₁₂₁ form a ring structure, specific examples of the ring structures include a cyclohexane ring, a cyclopentane ring, etc.

Next, the formulae (i) to (iii) will be described below.

In the formulae (i) to (iii), R₁, R₂, R₁₁, R₁₂ and R₃₁ are the same as R₁₁₂ in the formula (A) with respect to the meanings and preferred embodiments, respectively. L₁, L₂₁ and L₃₁ independently represent a leaving group with examples the same as those of L₁₁ in the formula (A). X₁ and X₂₁ independently represent a substituent with examples and preferred embodiments the same as those of the substituent on RED₁₁ in the formula (A). Each of m₁ and m₂₁ is preferably an integer of 0 to 2, more preferably 0 or 1.

When R_{N1}, R_{N21} or R_{N31} is a substituent, the substituent is preferably an alkyl group, an aryl group or a heterocyclic group, and may further have a substituent. Each of R_{N1}, R_{N21} and R_{N31} is preferably a hydrogen atom, an alkyl group or an aryl group, more preferably a hydrogen atom or an alkyl group.

When R₁₃, R₁₄, R₃₃, Rₐ, or R_{b} is a substituent, the substituent is preferably an alkyl group, an aryl group, an acyl group, an alkoxycarbonyl group, a carbamoyl group, a cyano group, an alkoxy group, an acylamino group, a sulfoneamide group, a ureide group, a thiouredide group, an alkylthio group, an arylthio group, an alkylsulfonyl group, an arylsulfonyl group, or a sulfamoyl group.

In the formula (i), the 6-membered ring formed by Z₁ is a nonaromatic heterocycle condensed with the benzene ring in the formula (i). The ring structure containing the nonaromatic heterocycle and the benzene ring to be condensed is specifically a tetrahydroquinoline ring, a tetrahydroquinoxaline ring, a tetrahydroquinazoline ring, etc., preferably a tetrahydroquinoline ring or a tetrahydroquinoxaline ring. The ring structure may have a substituent.

In the formula (ii), ED₂₁ is the same as ED₁₂ in the formula (B) with respect to the meanings and preferred embodiments.

In the formula (ii), any two of R_{N21}, R₁₃, R₁₄, X₂₁ and ED₂₁ may be bonded together to form a ring structure. The ring structure formed by R_{N21} and X₂, is preferably a 5- to 7-membered, carbocyclic or heterocyclic, nonaromatic ring structure condensed with a benzene ring, and specific examples thereof include a tetrahydroquinoline ring, a tetrahydroquinoxaline ring, an indoline ring, a 2,3-dihydro-5,6-benzo-1,4-thiazine ring, etc. Preferred are a tetrahydroquinoline ring, a tetrahydroquinoxaline ring and an indoline ring.

When R_{N31} is a group other than an aryl group in the formula (iii), Rₐ and R_{b} bond together to form an aromatic ring. The aromatic ring is an aryl group such as a phenyl group and a naphthyl group, or an aromatic heterocyclic group such as a pyridine ring group, a pyrrole ring group, a quinoline ring group and an indole ring group, preferably an aryl group. The aromatic ring group may have a substituent.

In the formula (iii) Rₐ and R_{b} preferably bond together to form an aromatic ring, particularly a phenyl group.

In the formula (iii), R₃₂ is preferably a hydrogen atom, an alkyl group, an aryl group, a hydroxy group, an alkoxy group, a mercapto group or an amino group. According to a preferred embodiment, R₃₃ is an electron-withdrawing group when R₃₂ is a hydroxy group. The electron-withdrawing group is the same as above-described one, preferably an acyl group, an alkoxycarbonyl group, a carbamoyl group or a cyano group.

The compound of Type 2 will be described below.

The bond cleavage reaction of the compound of Type 2 is a cleavage reaction of a bond of carbon-carbon, carbon-silicon, carbon-hydrogen, carbon-boron, carbon-tin or carbon-germanium. Cleavage of a carbon-hydrogen bond may be caused with the cleavage reaction.

The compound of Type 2 has 2 or more, preferably 2 to 6, more preferably 2 to 4, adsorbent groups to the silver halide. The adsorbent group is further preferably a mercapto-substituted, nitrogen-containing, heterocyclic group. The number of the adsorbent groups is preferably 2 to 6, more preferably 2 to 4. The adsorbent group will hereinafter be described.

The compound of Type 2 is preferably represented by the following formula (C).

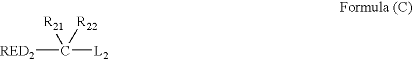

In the compound represented by the formula (C), the reducing group represented by RED₂ is one-electron-oxidized, and thereafter the leaving group of L₂ is spontaneously eliminated in the bond cleavage reaction. Further 1 electron can be released in the bond cleavage reaction.

In the formula (C), RED₂ is the same as RED₁₂ in the formula (B) with respect to the meanings and preferred embodiments. L₂ is the same as L₁₁ in the formula (A) with respect to the meanings and preferred embodiments. Incidentally, when L₂ is a silyl group, the compound of the formula (C) has 2 or more mercapto-substituted, nitrogen-containing, heterocyclic groups as the adsorbent groups. R₂₁ and R₂₂ each represent a hydrogen atom or a substituent, and are the same as R₁₁₂ in the formula (A) with respect to the meanings and preferred embodiments. RED₂ and R₂₁ may bond together to form a ring structure.

The ring structure is a 5- to 7-membered, monocyclic or condensed, carbocyclic or heterocyclic, nonaromatic ring, and may have a substituent. Incidentally, there is no case where the ring structure corresponds to a tetrahydro-, hexahydro- or octahydro-derivative of an aromatic ring or an aromatic heterocycle. The ring structure is preferably such that corresponds to a dihydro-derivative of an aromatic ring or an aromatic heterocycle, and specific examples thereof include a 2-pyrroline ring, a 2-imidazoline ring, a 2-thiazoline ring, a 1,2-dihydropyridine ring, a 1,4-dihydropyridine ring, an indoline ring, a benzoimidazoline ring, a benzothiazoline ring, a benzoxazoline ring, a 2,3-dihydrobenzothiophene ring, a 2,3-dihydrobenzofuran ring, a benzo-α-pyran ring, a 1,2-dihydroquinoline ring, a 1,2-dihydroquinazoline ring, a 1,2-dihydroquinoxaline ring, etc. Preferred are a 2-imidazoline ring, a 2-thiazoline ring, an indoline ring, a benzoimidazoline ring, a benzothiazoline ring, a benzoxazoline ring, a 1,2-dihydro pyridine ring, a 1,2-dihydroquinoline ring, a 1,2-dihydroquinazoline ring and a 1,2-dihydroquinoxaline ring, more preferred are an indoline ring, a benzoimidazoline ring, a benzothiazoline ring and a 1,2-dihydroquinoline ring, particularly preferred is an indoline ring.

The compound of Type 3 will be described below.

In the bond formation of the compound of Type 3, a bond of carbon-carbon, carbon-nitrogen, carbon-sulfur, carbon-oxygen, etc. is formed.

It is preferable that the one-electron oxidation product releases 1 or more electron after an intramolecular bond-forming reaction between the one-electron-oxidized portion and a reactive group portion such as a carbon-carbon double bond, a carbon-carbon triple bond, an aromatic group and a benzo-condensed, nonaromatic heterocyclic group.

In more detail, the compound of Type 3 is one-electron-oxidized to provide the one-electron oxidation product (a cation radical or a neutral radical provided by eliminating a proton therefrom), and the one-electron oxidation product intramolecularly reacts with the reactive group to form a bond, thereby generating another radical having a ring structure. Another electron is released from the radical directly or along with elimination of a proton.

Thus-provided 2-electron oxidation product may be subjected to hydrolysis or tautomerization reaction with proton shift, and then may release further 1 or more, generally 2 or more electrons. The 2-electron oxidation product may directly release further 1 or more, generally 2 or more electrons without the tautomerization reaction.

The compound of Type 3 is preferably represented by the following formula (D).

RED₃-L₃-Y₃ Formula (D)

In the formula (D), RED₃ represents a reducing group that can be one-electron-oxidized, and Y₃ represents a reactive group that reacts with the one-electron-oxidized RED₃, specifically an organic group containing a carbon-carbon double bond, a carbon-carbon triple bond, an aromatic group or a benzo-condensed, nonaromatic heterocyclic group. L₃ represents a linking group that connects RED₃ and Y₃.

RED₃ has the same meanings as RED₁₂ in the formula (B) RED₃ is preferably an arylamino group, a heterocyclic amino group, an aryloxy group, an arylthio group, an aryl group, or an aromatic or nonaromatic heterocyclic group (particularly a nitrogen-containing heterocyclic group). RED₃ is more preferably an arylamino group, a heterocyclic amino group, an aryl group, or an aromatic or nonaromatic heterocyclic group. Preferred as the heterocyclic group are a tetrahydroquinoline ring group, a tetrahydroquinoxaline ring group, a tetrahydroquinazoline ring group, an indoline ring group, an indole ring group, a carbazole ring group, a phenoxazine ring group, a phenothiazine ring group, a benzothiazoline ring group, a pyrrole ring group, an imidazole ring group, a thiazole ring group, a benzoimidazole ring group, a benzoimidazoline ring group, a benzothiazoline ring group, a 3,4-methylenedioxyphenyl-1-yl group, etc.

Particularly preferred as RED₃ are an arylamino group (particularly an anilino group), an aryl group (particularly a phenyl group), and an aromatic or nonaromatic heterocyclic group.

The aryl group represented by RED₃ preferably has at least one electron-donating group. The electron-donating group is the same as described above.

When RED₃ is an aryl group, a substituent on the aryl group is more preferably an alkylamino group, a hydroxy group, an alkoxy group, a mercapto group, a sulfoneamide group, an active methine group, and a nitrogen-containing, or nonaromatic heterocyclic group that substitutes at the nitrogen atom, furthermore preferably an alkylamino group, a hydroxy group, an active methine group, or a nitrogen-containing, nonaromatic heterocyclic group that substitutes at the nitrogen atom, and the most preferably an alkylamino group or a nitrogen-containing, nonaromatic heterocyclic group that substitutes at the nitrogen atom.

When an organic group containing a carbon-carbon double bond (such as a vinyl group) represented by Y₃ has a substituent, the substituent is preferably an alkyl group, a phenyl group, an acyl group, a cyano group, an alkoxycarbonyl group, a carbamoyl group, an electron-donating group, etc. The electron-donating group is preferably an alkoxy group; a hydroxy group, which may be protected by a silyl group, such as a trimethylsilyloxy group, a t-butyldimethylsilyloxy group, a triphenylsilyloxy group, a triethylsilyloxy group and a phenyldimethylsilyloxy group; an amino group; an alkylamino group; an arylamino group; a sulfoneamide group; an active methine group; a mercapto group; an alkylthio group; or a phenyl group having a substituent composed thereof.

Incidentally, when the organic group containing the carbon-carbon double bond has a hydroxy group as a substituent, Y₃ contains a moiety of >C₁═C₂(—OH)—, which may be tautomerized into a moiety of >C₁H—C₂(═O)—. In this case, it is preferred that a substituent on the C₁ carbon is an electron-withdrawing group, and as a result, Y₃ has a moiety of an active methylene group or an active methine group. The electron-withdrawing group, which can provide such a moiety of an active methylene group or an active methine group, may be the same as above-mentioned electron-withdrawing group on the methine group of the active methine group.

When an organic group containing a carbon-carbon triple bond such as an ethynyl group represented by Y₃ has a substituent, preferred as the substituent are an alkyl group, a phenyl group, an alkoxycarbonyl group, a carbamoyl group, an electron-donating group, etc.

When Y₃ is an organic group containing an aromatic group, preferred as the aromatic group are an aryl group (particularly a phenyl group) having an electron-donating group as a substituent, and an indole ring group. The electron-donating group is preferably a hydroxy group that may be protected by a silyl group, an alkoxy group, an amino group, an alkylamino group, an active methine group, a sulfoneamide group, or a mercapto group.

When Y₃ is an organic group containing a benzo-condensed, nonaromatic heterocyclic group, preferred as the benzo-condensed, nonaromatic heterocyclic group are groups having an aniline moiety, such as an indoline ring group, a 1,2,3,4-tetrahydroquinoline ring group, a 1,2,3,4-tetrahydroquinoxaline ring group and a 4-quinolone ring group.

The reactive group of Y₃ is more preferably an organic group containing a carbon-carbon double bond, an aromatic group, or a benzo-condensed, nonaromatic heterocyclic group. The reactive group is furthermore preferably a phenyl group having a carbon-carbon double bond or an electron-donating group as a substituent; an indole ring group; or a benzo-condensed, nonaromatic heterocyclic group having an aniline moiety. The carbon-carbon double bond more preferably has at least one electron-donating group as a substituent.

It is also preferred that the reactive group represented by Y₃ in the formula (D) contains a moiety equal to the reducing group represented by RED₃ as a result of selecting the reactive group as above.

L₃ represents a linking group that connects RED₃ and Y₃, specifically a single bond, an alkylene group, an arylene group, a heterocyclic group, —O—, —S—, —NRN—, —C(═O)—, —SO₂—, —SO—, —P(═O)—, or a combination thereof. RN represents a hydrogen atom, an alkyl group, an aryl group or a heterocyclic group. The linking group represented by L₃ may have a substituent. The linking group represented by L₃ may bond to each of RED₃ and Y₃ at an optional position such that the linking group substitutes optional 1 hydrogen atom of each RED₃ and Y₃.

Preferred examples of L₃ include a single bond; alkylene groups, particularly a methylene group, an ethylene group and a propylene group; arylene groups, particularly a phenylene group; a —C(═O)— group; an —O— group; an —NH— group; an —N(alkyl)-groups; and divalent linking groups of combinations thereof.

It is preferred that a cation radical (X⁺.) provided by oxidizing RED₃ or a radical (X.) provided by eliminating a proton therefrom reacts with the reactive group represented by L₃ to form a bond, to form a 3 to 7-membered ring structure containing the linking group represented by L₃. Thus, the radical (X⁺. or X.), the reactive group of Y, and L are preferably connected though 3 to 7 atoms.

Next, the compound of Type 4 will be described below.

The compound of Type 4 has a reducing group-substituted ring structure. After the reducing group is one-electron-oxidized, the compound can release further 1 or more electron with a ring structure cleavage reaction. The ring cleavage reaction proceeds as follows.

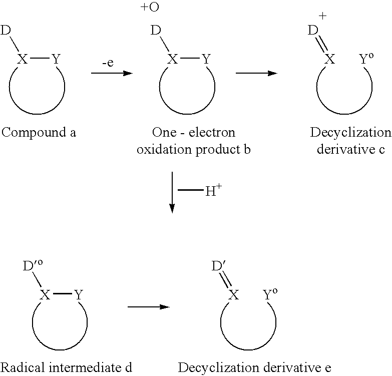

In the formula, Compound a is the compound of Type 4. In Compound a, D represents a reducing group, and X and Y each represent an atom forming a bond in the ring structure, which is cleaved after the one-electron oxidation. First, Compound a is one-electron-oxidized to generate One-electron oxidation product b. Then, the X—Y bond is cleaved with conversion of the D-X single bond into a double bond, whereby Decyclization derivative c is provided. Alternatively, there is a case where One-electron oxidation product b is converted into Radical intermediate d along with deprotonation, and Decyclization derivative e is provided in the same manner. Subsequently, further 1 or more electron is released from thus-provided Decyclization derivative c or e.

The ring structure in the compound of Type 4 is a 3 to 7-membered, carbocyclic or heterocyclic, monocyclic or condensed, saturated or unsaturated, nonaromatic ring. The ring structure is preferably a saturated ring structure, more preferably 3- or 4-membered ring. Preferred examples of such ring structures include a cyclopropane ring, a cyclobutane ring, an oxirane ring, an oxetane ring, an aziridine ring, an azetidine ring, an episulphide ring and a thietane ring. More preferred are a cyclopropane ring, a cyclobutane ring, an oxirane ring, an oxetane ring and an azetidine ring, particularly preferred are a cyclopropane ring, a cyclobutane ring and an azetidine ring. The ring structure may have a substituent.

The compound of Type 4 is preferably represented by the following formula (E) or (F).

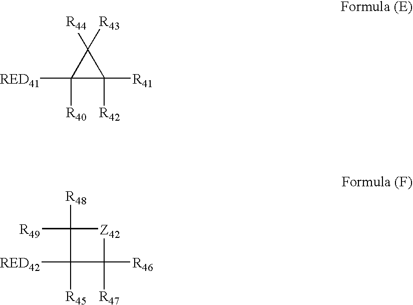

In the formulae (E) and (F), RED₄₁ and RED₄₂ are the same as RED₁₂ in the formula (B) with respect to the meanings and preferred embodiments, respectively. R₄₀ to R₄₄ and R₄₅ to R₄₉ each represent a hydrogen atom or a substituent. In the formula (F), Z₄₂ represents —CR₄₂₀R₄₂₁—, —NR₄₂₃—, or —O—. R₄₂₀ and R₄₂₁ each represent a hydrogen atom or a substituent, and R₄₂₃ represents a hydrogen atom, an alkyl group, an aryl group or a heterocyclic group.

In the formulae (E) and (F), each of R₄₀ and R₄₅ is preferably a hydrogen atom, an alkyl group, an aryl group, or a heterocyclic group, more preferably a hydrogen atom, an alkyl group, or an aryl group. Each of R₄₁ to R₄₄ and R₄₆ to R₄₉ is preferably a hydrogen atom, an alkyl group, an alkenyl group, an aryl group, a heterocyclic group, an arylthio group, an alkylthio group, an acylamino group, or a sulfoneamide group, more preferably a hydrogen atom, an alkyl group, an aryl group, or a heterocyclic group.

It is preferred that at least one of R₄₁ to R₄₄ is a donor group, and it is also preferred that both of R⁴¹ and R₄₂, or both of R₄₃ and R₄₄ are an electron-withdrawing group. It is more preferred that at least one of R₄₁ to R₄₄ is a donor group. It is furthermore preferred that at least one of R₄₁ to R₄₄ is a donor group and R₄₁ to R₄₄ other than the donor group are selected from a hydrogen atom and alkyl groups.

The donor group is an electron-donating group, or an aryl group having at least one electron-donating group. The donor group is preferably an alkylamino group; an arylamino group; a heterocyclic amino group; an electron-excess, 5-membered, monocyclic or condensed, aromatic heterocyclic group having at least one nitrogen atom in the ring; a nitrogen-containing, nonaromatic heterocyclic group that substitutes at the nitrogen atom; or a phenyl group having at least one electron-donating group as a substituent. The donor group is more preferably an alkylamino group; an arylamino group; an electron-excess, 5-membered, monocyclic or condensed, aromatic heterocyclic group having at least one nitrogen atom in the ring, wherein the aromatic heterocycle is an indole ring, a pyrrole ring or a carbazole ring; or a phenyl group having an electron-donating group as a substituent, such as phenyl groups having 3 or more alkoxy groups and phenyl groups having a hydroxy group or an alkylamino group or an arylamino group. The donor group is particularly preferably an arylamino group; an electron-excess, 5-membered, monocyclic or condensed, aromatic heterocyclic group having at least one nitrogen atom in the ring, particularly a 3-indolyl group; or a phenyl group having an electron-donating group as a substituent, particularly a phenyl group having a trialkoxyphenyl group, an alkylamino group or an arylamino group.

Z₄₂ is preferably —CR₄₂₀R₄₂₁- or —NR₄₂₃—, more preferably —NR₄₂₃—. Each of R₄₂₀ and R₄₂₁ is preferably a hydrogen atom, an alkyl group, an aryl group, a heterocyclic group, an acylamino group, or a sulfoneamino group, more preferably a hydrogen atom, an alkyl group, an aryl group, or a heterocyclic group. R₄₂₃ is preferably a hydrogen atom, an alkyl group, an aryl group or an aromatic heterocyclic group, more preferably a hydrogen atom, an alkyl group, or an aryl group.

The substituent represented by each of R₄₀ to R₄₉, R₄₂₀, R₄₂₁ and R₄₂₃ preferably has 40 or less carbon atoms, more preferably has 30 or less carbon atoms, particularly preferably 15 or less carbon atoms. The substituents of R₄₀ to R₄₉, R₄₂₀, R₄₂₁ and R₄₂₃ may bond to each other or to the other portion such as RED₄₁, RED₄₂ and Z₄₂, to form a ring.

In the compounds of Types 1 to 4 used in the invention, the adsorbent group to the silver halide is such a group that is directly adsorbed on the silver halide or promotes adsorption of the compound onto the silver halide. Specifically, the adsorbent group is a mercapto group or a salt thereof; a thione group (—C(═S)—); a heterocyclic group containing at least one atom selected from the group consisting of a nitrogen atom, a sulfur atom, a selenium atom and a tellurium atom; a sulfide group; a cationic group; or an ethynyl group. Incidentally, the adsorbent group in the compound of Type 2 is not a sulfide group.

The mercapto group or a salt thereof used as the adsorbent group may be a mercapto group or a salt thereof itself, and is more preferably a heterocyclic group, an aryl group or an alkyl group having at least one mercapto group or a salt thereof as a substituent. The heterocyclic group is a 5- to 7-membered, monocyclic or condensed, aromatic or nonaromatic, heterocyclic group. Examples thereof include an imidazole ring group, a thiazole ring group, an oxazole ring group, a benzimidazole ring group, a benzthiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group, etc. The heterocyclic group may contain a quaternary nitrogen atom, and in this case, the mercapto group bonding to the heterocyclic group may be dissociated into a mesoion. Such heterocyclic group may be an imidazolium ring group, a pyrazolium ring group, a thiazolium ring group, a triazolium ring group, a tetrazolium ring group, a thiadiazolium ring group, a pyridinium ring group, a pyrimidinium ring group, a triazinium ring group, etc. Preferred among them are triazolium ring groups such as a 1,2,4-triazolium-3-thiolate ring group. Examples of the aryl groups include a phenyl group and a naphthyl group. Examples of the alkyl groups include straight, branched or cyclic alkyl groups having 1 to 30 carbon atom. When the mercapto group forms a salt, a counter ion of the salt may be a cation of an alkaline metal, an alkaline earth metal, a heavy metal, etc. such as Li⁺, Na⁺, K⁺, Mg²⁺, Ag⁺ and Zn²⁺; an ammonium ion; a heterocyclic group containing a quaternary nitrogen atom; a phosphonium ion; etc.

Further, the mercapto group used as the adsorbent group may be tautomerized into a thione group. Specific examples of the thione groups include a thioamide group (herein a —C(═S)—NH— group); and groups containing a structure of the thioamide group, such as linear or cyclic thioamide groups, a thiouredide group, a thiourethane group and a dithiocarbamic acid ester group. Examples of such cyclic thioamide groups include a thiazolidine-2-thione group, an oxazolidine-2-thione group, a 2-thiohydantoin group, a rhodanine group, an isorhodanine group, a thiobarbituric acid group, a 2-thioxo-oxazolidine-4-one group, etc.

The thione group used as the adsorbent group, as well as the thione group derived from the mercapto group by tautomerization, may be a linear or cyclic, thioamide, thiouredide, thiourethane or dithiocarbamic acid ester group that cannot be tautomerized into the mercapto group or has no hydrogen atom at α-position of the thione group.

The heterocyclic group containing at least one atom selected from the group consisting of a nitrogen atom, a sulfur atom, a selenium atom and tellurium atom, which is used as the adsorbent group, is a nitrogen-containing heterocyclic group having an —NH— group that can form a silver imide (>NAg) as a moiety of the heterocycle; or a heterocyclic group having an —S— group, an —Se— group, a —Te— group or an═N— group, which can form a coordinate bond with a silver ion, as a moiety of the heterocycle. Examples of the former include a benzotriazole group, a triazole group, an indazole group, a pyrazole group, a tetrazole group, a benzimidazole group, an imidazole group, a purine group, etc. Examples of the latter include a thiophene group, a thiazole group, an oxazole group, a benzothiazole group, a benzoxazole group, a thiadiazole group, an oxadiazole group, a triazine group, a selenazole group, a benzselenazole group, a tellurazole group, a benztellurazole group, etc. The former is preferable.

The sulfide group used as the adsorbent group may be any group with an —S— moiety, and preferably has a moiety of alkyl or alkylene-S-alkyl or alkylene; aryl or arylene-S-alkyl or alkylene; or aryl or arylene-S-aryl or arylene. The sulfide group may form a ring structure, and may have an —S—S— group. Specific examples of the ring structures include groups with a thiolane ring, a 1,3-dithiolane ring, a 1,2-dithiolane ring, a thiane ring, a dithiane ring, a tetrahydro-1,4-thiazine ring (a thiomorpholine ring), etc. Particularly preferred as the sulfide group are groups having a moiety of alkyl or alkylene-S-alkyl or alkylene.

The cationic group used as the adsorbent group is a quaternary nitrogen-containing group, specifically a group with an ammonio group or a quaternary nitrogen-containing heterocyclic group. Incidentally, there is no case where the cationic group partly composes an atomic group forming a dye structure, such as a cyanine chromophoric group. The ammonio group may be a trialkylammonio group, a dialkylarylammonio group, an alkyldiarylammonio group, etc., and examples thereof include a benzyldimethylammonio group, a trihexylammonio group, a phenyldiethylammonio group, etc. Examples of the quaternary nitrogen-containing heterocyclic groups include a pyridinio group, a quinolinio group, an isoquinolinio group, an imidazolio group, etc. Preferred among them are a pyridinio group and an imidazolio group, and particularly preferred is a pyridinio group. The quaternary nitrogen-containing heterocyclic group may have an optional substituent. Preferred examples of the substituents on the pyridinio group and the imidazolio group include alkyl groups, aryl groups, acylamino groups, a chlorine atom, alkoxycarbonyl groups and carbamoyl groups. The substituent on the pyridinio group is particularly preferably a phenyl group.

The ethynyl group used as the adsorbent group means a —C≡CH group, in which the hydrogen atom may be substituted.

The above-mentioned adsorbent groups may have an optional substituent.

Specific examples of the adsorbent groups further include ones described in pages 4 to 7 of a specification of JP-A No. 11-95355.

Preferred as the adsorbent group used in the invention are mercapto-substituted, nitrogen-containing, heterocyclic groups such as a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzthiazole group and a 1,5-dimethyl-1,2,4-triazolium-3-thiolate group; and nitrogen-containing heterocyclic groups having an —NH— group that can form a silver imide (>NAg) as a moiety of the heterocycle, such as a benzotriazole group, a benzimidazole group and an indazole group. Particularly preferred as the adsorbent group are a 5-mercaptotetrazole group, a 3-mercapto-1,2,4-triazole group and a benzotriazole group, and the most preferred are a 3-mercapto-1,2,4-triazole group and a 5-mercaptotetrazole group.

It is particularly preferred that the compound used in the invention has 2 or more mercapto group as a moiety. The mercapto group (—SH) may be converted into a thione group in the case where it can be tautomerized. The compound may have 2 or more adsorbent groups containing above-mentioned mercapto or thione group as a moiety, such as a cyclic thioamide group, an alkylmercapto group, an arylmercapto group and a heterocyclic mercapto group. Further, the compound may have 1 or more adsorbent group containing 2 or more mercapto or thione groups as a moiety, such as a dimercapto-substituted, nitrogen-containing, heterocyclic group.

Examples of the adsorbent groups containing 2 or more mercapto groups, such as a dimercapto-substituted, nitrogen-containing, heterocyclic group, include a 2,4-dimercaptopyrimidine group, a 2,4-dimercaptotriazine group, a 3,5-dimercapto-1,2,4-triazole group, a 2,5-dimercapto-1,3-thiazole group, a 2,5-dimercapto-1,3-oxazole group, a 2,7-dimercapto-5-methyl-s-triazolo(1,5-A)-pyrimidine group, a 2,6,8-trimercaptopurine group, a 6,8-dimercaptopurine group, a 3,5,7-trimercapto-s-triazolotriazine group, a 4,6-dimercaptopyrazolo pyrimidine group, a 2,5-dimercapto-imidazole group, etc. Particularly preferred are a 2,4-dimercaptopyrimidine group, a 2,4-dimercaptotriazine group, and a 3,5-dimercapto-1,2,4-triazole group.

The adsorbent group may be connected to any position of the compound represented by each of the formulae (A) to (F) and (i) to (iii). Preferred portions, which the adsorbent group bonds to, are RED₁₁, RED₁₂, RED₂ and RED₃ in the formulae (A) to (D); RED₄₁, R₄₁, RED₄₂, and R₄₆ to R₄₈ in the formulae (E) and (F); and optional portions other than R₁, R₂, R₁₁, R₁₂, R₃₁, L₁, L₂₁ and L₃₁ in the formulae (i) to (iii). Further, more preferred portions are RED₁₁ to RED₄₂ in the formulae (A) to (F).

The spectrally sensitizing dye moiety is a group containing a spectrally sensitizing dye chromophore, which is a residual group provided by removing an optional hydrogen atom or substituent from a spectrally sensitizing dye compound. The spectrally sensitizing dye moiety may be connected to any position of the compound represented by each of the formulae (A) to (F) and (i) to (iii). Preferred portion, which the spectrally sensitizing dye moiety bonds to, are RED₁₁, RED₁₂, RED₂ and RED₃ in the formulae (A) to (D); RED₄₁, R₄₁, RED₄₂, and R₄₆ to R₄₈ in the formulae (E) and (F); and optional portions other than R₁, R₂, R₁₁, R₁₂, R₃₁, L₁, L₂₁ and L₃₁ in the formulae (i) to (iii). Further, more preferred portions are RED, to RED₄₂ in the formulae (A) to (F). The spectrally sensitizing dye is preferably such that typically used in color sensitizing techniques, and examples thereof include cyanine dyes, composite cyanine dyes, merocyanine dyes, composite merocyanine dyes, homopolar cyanine dyes, styryl dyes, and hemicyanine dyes. Typical spectrally sensitizing dyes are disclosed in Research Disclosure, Item 36544, September 1994. The dyes can be synthesized by one skilled in the art according to procedures described in the above Research Disclosure and F. M. Hamer, The Cyanine dyes and Related Compounds, Interscience Publishers, New York, 1964. Further, dyes described in pages 7 to 14 of a specification of JP-A No. 11-95355 (U.S. Pat. No. 6,054,260) may be used in the invention.

The total number of carbon atoms in the compounds of Types 1 to 4 is preferably 10 to 60, more preferably 15 to 50, furthermore preferably 18 to 40, particularly preferably 18 to 30.

When a silver halide photosensitive material using the compounds of Types 1 to 4 is exposed, the compound is one-electron-oxidized. After the subsequent reaction, the compound is further oxidized while releasing 1 or more electron, or 2 or more electrons depending on Type. An oxidation potential in the first one-electron oxidation is preferably 1.4 V or less, more preferably 1.0 V or less. This oxidation potential is preferably higher than 0 V, more preferably higher than 0.3 V. Thus, the oxidation potential is preferably approximately 0 to 1.4 V, more preferably approximately 0.3 to 1.0 V.

The oxidation potential may be measured by a cyclic voltammetry technique. Specifically, a sample is dissolved in a solution of acetonitrile/water=80/20 volume % (containing 0.1 M lithium perchlorate), nitrogen gas is passed through the resultant solution for 10 minutes, and then the oxidation potential is measured at 25° C. at a potential scanning rate of 0.1 V/second by using a glassy carbon disk as a working electrode, using a platinum wire as a counter electrode, and using a calomel electrode (SCE) as a reference electrode. The oxidation potential per SCE is obtained at peak potential of cyclic voltammetric curve.

In the case where the compound of Types 1 to 4 is one-electron-oxidized and release further 1 electron after the subsequent reaction, an oxidation potential in the subsequent oxidation is preferably −0.5 to −2 V, more preferably −0.7 to −2 V, furthermore preferably −0.9 to −1.6 V.

In the case where the compound of Types 1 to 4 is one-electron-oxidized and release further 2 or more electrons after the subsequent reaction, oxidation potentials in the subsequent oxidation are not particularly limited. The oxidation potentials in the subsequent oxidation often cannot be measured precisely, because the oxidation potential in releasing the second electron cannot be clearly differentiated from the oxidation potential in releasing the third or later electron.

Next, the compound of Type 5 will be described.

The compound of Type 5 is represented by X—Y, in which X represents a reducing group and Y representsa leaving group. The reducing group represented by X can be one-electron-oxidized to provide a one-electron oxidation product, which can be converted into an X radical by eliminating the leaving group Y with a subsequent X—Y bond cleavage reaction. The X radical can further release 1 electron. The oxidation reaction of the compound of Type 5 may be represented by the following formula.

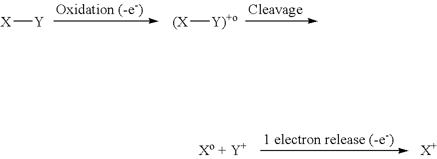

The compound of Type 5 exhibits an oxidation potential of preferably 0 to 1.4 V, more preferably 0.3 to 1.0 V. The radical X. provided in the formula exhibits an oxidation potential of preferably −0.7 to −2.0 V, more preferably −0.9 to −1.6 V.

The compound of Type 5 is preferably represented by the following formula (G).

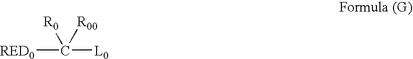

In the formula (G), RED₀ represents a reducing group, L₀ represents a leaving group, and R₀ and R₀₀ each represent a hydrogen atom or a substituent. RED₀ and R₀, and R₀ and R₀₀ may be bond together to form a ring structure, respectively. RED₀ is the same as RED₂ in the formula (C) with respect to the meanings and preferred embodiments. R₀ and R₀₀ are the same as R₂₁ and R₂₂ in the formula (C) with respect to the meanings and preferred embodiments, respectively. Incidentally, R₀ and R₀₀ are not the same as the leaving group of L₀ respectively, except for a hydrogen atom. RED₀ and R₀ may bond together to form a ring structure with examples and preferred embodiments the same as those of the ring structure formed by bonding RED₂ and R₂₁ in the formula (C). Examples of the ring structure formed by R₀ and R₀₀ include a cyclopentane ring, a tetrahydrofuran ring, etc. In the formula (G), L₀ is the same as L₂ in the formula (C) with respect to the meanings and preferred embodiments.

The compound represented by the formula (G) preferably has an adsorbent group to the silver halide, or a spectrally sensitizing dye moiety. However, the compound does not have 2 or more adsorbent groups when L₀ is a group other than a silyl group. Incidentally, the compound may have 2 or more sulfide groups as the adsorbent groups, not depending on L₀.

The adsorbent groups to the silver halide in the compound represented by the formula (G) may be the same as those in the compounds of Types 1 to 4. Further, examples of the adsorbent groups in the compound represented by the formula (G) include ones described as “silver halide adsorbent groups” in pages 4 to 7 of the specification of JP-A No. 11-95355, and the preferred embodiment thereof described in the specification may be applied to the invention.

The spectrally sensitizing dye moiety in the compound represented by the formula (G) is the same as in the compounds of Types 1 to 4. Examples of the spectrally sensitizing dye moieties in the compound represented by the formula (G) include ones described as “light absorbing groups” in pages 7 to 14 of the specification of JP-A No. 11-95355, and the preferred embodiment thereof described in the specification may be applied to the invention.

Specific examples of the compounds of Types 1 to 5 are illustrated below without intention of restricting the scope of the invention.

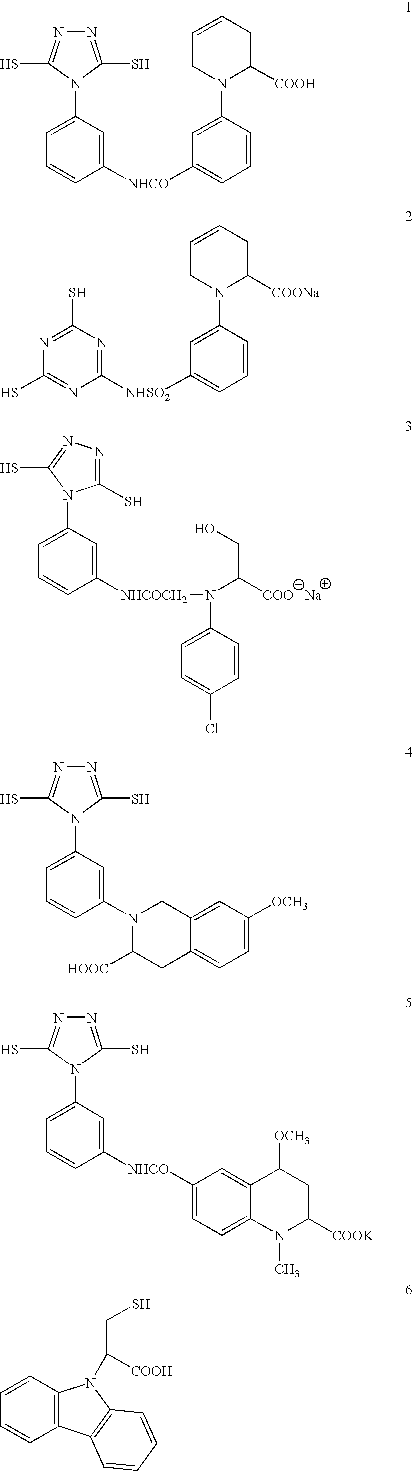

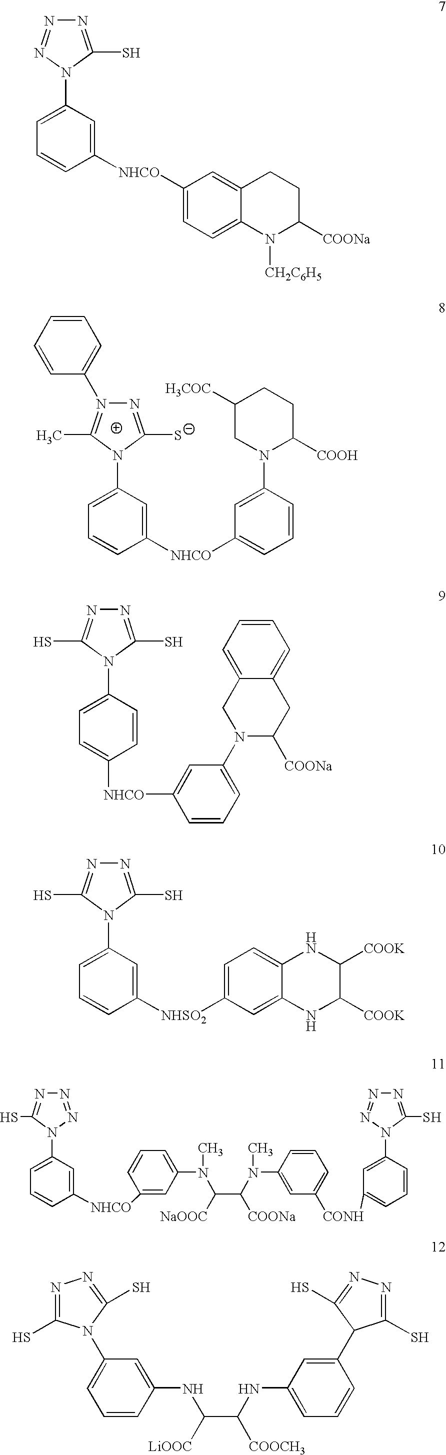

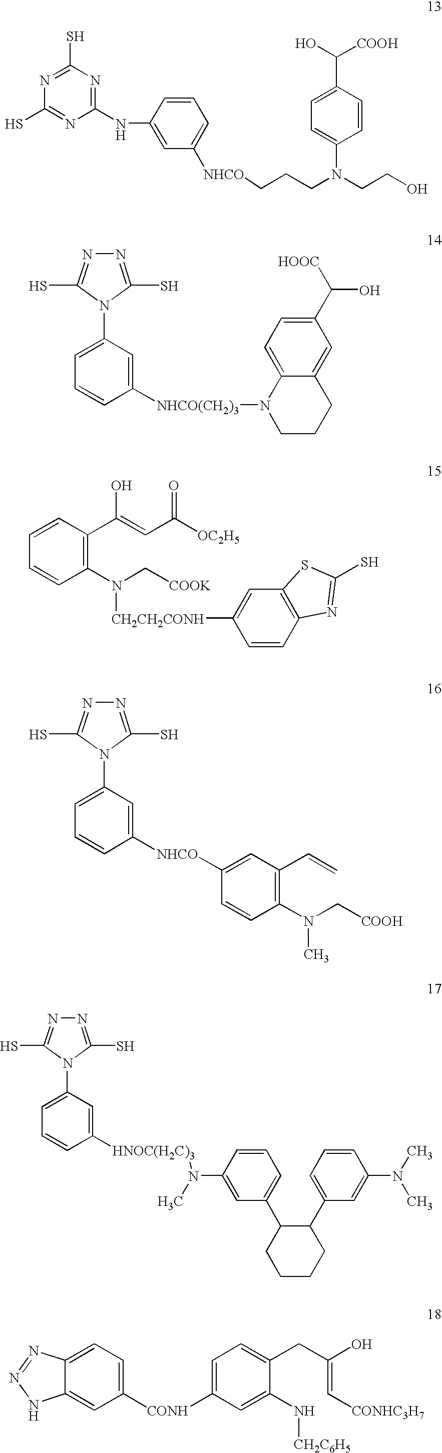

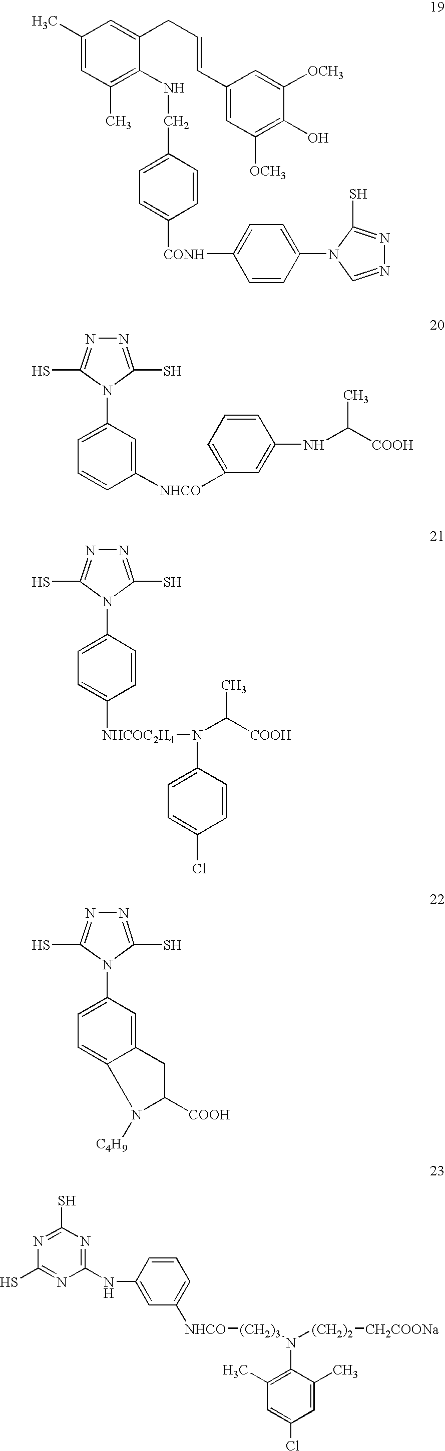

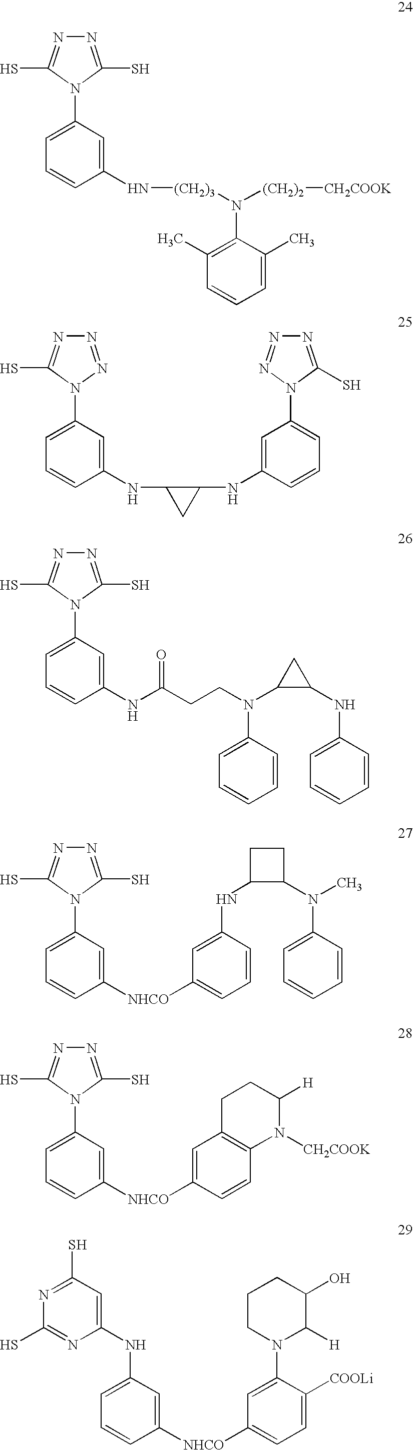

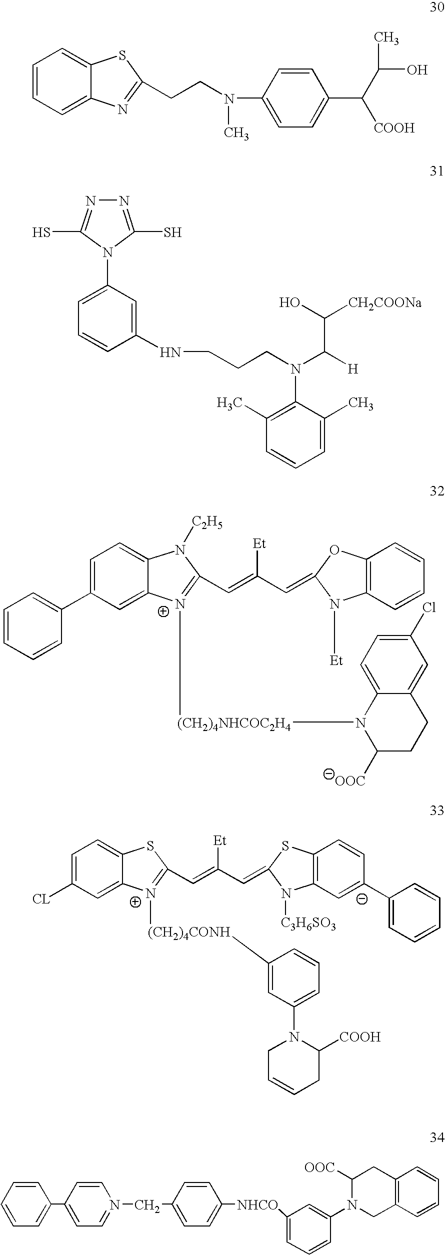

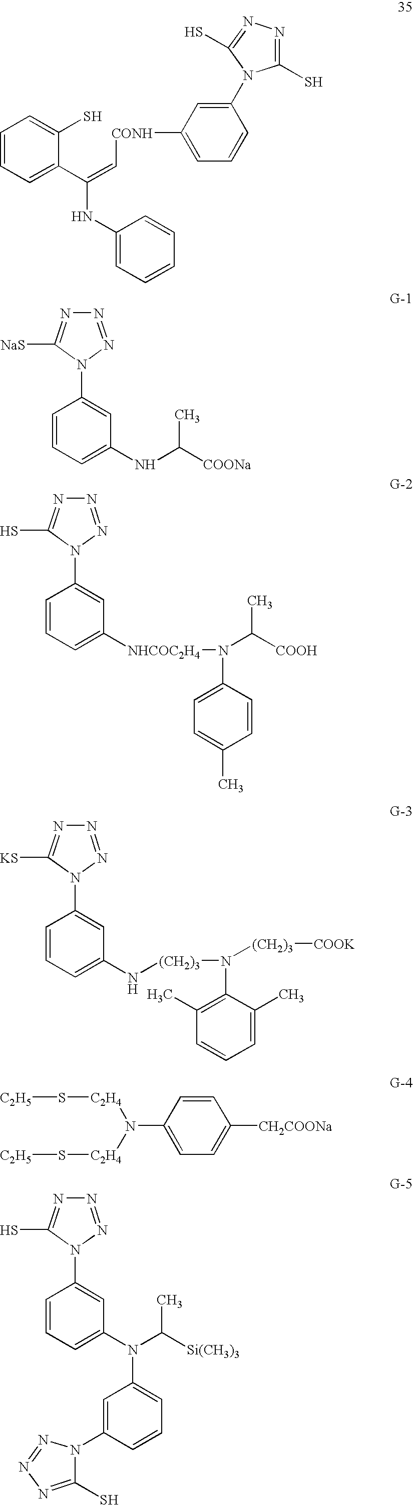

The compounds of Types 1 to 4 used in the invention are the same as compounds described in detail in Japanese Patent Application Nos. 2002-192373, 2002-188537, 2002-188536, 2001-272137, and 2002-192374. Specific examples of the compounds of Types 1 to 4 further include example compounds described in these patent specifications. Further, synthesis examples of the compounds of Types 1 to 4 may be the same as described in these patent specifications.

Specific examples of the compounds of Type 5 further include compounds described as “one-photon two-electron sensitizer” or “deprotonating electron donating sensitizer” in JP-A Nos. 9-211769 (Compounds PMT-1 to S-37 described in Tables E and F in pages 28 to 32), 9-211774 and 11-95355 (Compounds INV 1 to 36); JP-W No. 2001-500996 (Compounds 1 to 74, 80 to 87, and 92 to 122); U.S. Pat. Nos. 5,747,235 and 5,747,236; EP Nos. 786692A1 (Compounds INV 1 to 35) and 893732A1; U.S. Pat. Nos. 6,054,260 and 5,994,051, etc.

The compounds of Types 1 to 5 may be used at any time during preparation of the photosensitive silver halide emulsion and production of the photothermographic material. For example, the compound may be used, in a photosensitive silver halide grains-forming step, in a desalination step, in a chemical sensitization step, before application, etc. The compound may be added in plural times, in these steps. The compound is preferably added, after the photosensitive silver halide grains-forming step and before the desalination step; in the chemical sensitization step (just before the chemical sensitization to immediately after the chemical sensitization); or before the application. The compound is more preferably added, from the chemical sensitization step to before mixing with the non-photosensitive organic silver salt.

It is preferred that the compounds of Types 1 to 5 used in the invention are dissolved in water, a water-soluble solvent such as methanol and ethanol, or a mixed solvent thereof, to be added. When the compound is dissolved in water, the pH value of the solvent may be increased or decreased to dissolve and add the compound in the case where the solubility of the compound is improved by increasing or decreasing the pH value.

The compounds of Types 1 to 5 are preferably added to the emulsion layer comprising the photosensitive silver halide and the non-photosensitive organic silver salt. The compound may be added to a protective layer, an intermediate layer, etc. as well as the emulsion layer, and may be diffused in the application step. The compounds may be added before or after addition of a sensitizing dye. The mol value of the compounds per 1 mol of the silver halide is preferably 1×10⁻⁹ to 5×10⁻¹ mol, more preferably 1×10⁻⁸ to 5×10⁻² mol, in the silver halide emulsion layer.

10) Use of a Plurality of Silver Halides in Combination

A photosensitive silver halide emulsion in a photosensitive material used in the invention may be one kind, or two or more kinds (e.g. having different average particle sizes, different halogen compositions, different crystal habits, different chemical sensitization conditions) may be used in combination. Gradation can be regulated by using a plurality of photosensitive silver halides having the different sensitivities. Examples of the techniques regarding them include those described in JP-A Nos. 57-119341, 53-106125, 47-3929, 48-55730, 46-5187, 50-73627, and 57-15041. It is preferable that a sensitivity difference is 0.2 logE or more in each emulsion.

11) Coating Amount

An amount of photosensitive silver halide to be used is preferably 0.03 to 0.6 g/m², more preferably 0.05 to 0.4 g/m², most preferably 0.07 to 0.3 g/m² in terms of a coating silver amount per 1 m² of a photosensitive material, and photosensitive silver halide is preferably not smaller than 0.01 mol and not larger than 0.5 mol, more preferably not smaller than 0.02 and not larger than 0.3 mol, more preferably not smaller than 0.03 mol and not larger than 0.2 mol.

12) Mixing of Photosensitive Silver Halide and Organic Silver Salt

For a method of mixing separately prepared photosensitive silver halide and organic silver salt and mixing conditions, there are a method of mixing separately having prepared silver halide particle and organic silver salt with a high speed stirrer, a ball mill, a sand mill, a colloid mill, a vibration mill, a homogenizer or the like, and a method of mixing photosensitive silver halide for which preparation has been completed at any timing during preparation of an organic silver salt, but a method is not particularly limited as far as the effect of the invention is sufficiently manifested. In addition, mixing of two or more kinds of organic silver salt water dispersions and two or more kinds of photosensitive silver salt water dispersions is a preferable method for regulating the photographic properties.

13) Mixing of Silver Halide into Coating Solution

A preferable time for adding silver halide in the invention to an image forming layer coating solution is from 180 minutes before coating to immediately before coating, preferably from 60 minutes before to 10 seconds before, and a mixing method and mixing conditions are not particularly limited as far as the effect of the invention is sufficiently manifested. As a specific mixing method, there are a method of mixing in a tank so that an average retention time calculated from an addition flow rate and an amount of a solution to be supplied to a coater becomes a desired time, and a method of employing a static mixer described in Liquid Mixing Technology authored by N. Harnby, M. F. Edwards, A. W. Mienow, translated by Koji TAKAHASHI (published by The Nikkan Kogyo Shimbun, Ltd., 1989), Chapter 8.

Explanation of Antifoggant

Examples of an antifoggant, a stabilizer and a stabilizer precursor which can be used in the invention include those described in JP-A No. 10-62899, paragraph number 0070, EP Publication No. 0803764A1, page 20, line 57 to page 21, line 7, compounds described in JP-A Nos. 9-281637, 9-329864, and compounds described in U.S. Pat. Nos. 6,083,681, 6,083,681, EP No. 1048975. In addition, an antifoggant which is preferably used in the invention is an organic halide, and examples thereof include those disclosed in JP-A No. 11-65021, paragraph numbers 0111 to 0112. In particular, organic halogen compounds represented by the formula (P) in JP-A No. 2000-284399, organic polyhalogen compounds represented by the formula (II) in JP-A No. 10-339934, and organic polyhalogen compounds described in JP-A Nos. 2001-31644 and 2001-33911 are preferable.

Organic Polyhalogen Compound

Preferable organic polyhalogen compounds which are preferable in the invention will be specifically explained below. A polyhalogen compound which is preferable in the invention is a compound represented by the following formula (H).

Q-(Y)n-C(Z₁)(Z₂)X Formula (H)

In the formula (H), Q represents an alkyl group, an aryl group or a heterocyclic group; Y represents a divalent linking group; Z₁ and Z₂ each represent a halogen atom; X represents a hydrogen atom or an electron withdrawing group; and n represents 0 or 1.

In the formula (H), Q is preferably an aryl group or a heterocyclic group.

In the formula (H), when Q is a heterocyclic group, a nitrogen-containing heterocyclic group containing 1 or 2 nitrogen atom(s) is preferable, and a 2-pyridyl group and a 2-quinolyl group are particularly preferable.

In the formula (H), when Q is an aryl group, Q represents a phenyl substituted with an electron withdrawing group in which a substituent constant σ p of Hammett takes a positive value. Regarding a substituent constant of Hammett, reference can be made to Journal of Medicinal Chemistry, 1973, Vol. 16, No. 11, 1207-1216 and the like. Examples of such the electron withdrawing group include a halogen atom (fluorine atom (σₚ value: 0.06), chlorine atom (σₚ value: 0.23), bromine atom (σₚ value: 0.23), iodine atom (σₚ value: 0.18)) a trihalomethyl group (tribromomethyl (σₚ value: 0.29), trichloromethyl (σₚ value: 0.33), trifluoromethyl (σₚ value: 0.54)), a cyanogroup (σₚ value: 0.66), a nitro group (σₚ value: 0.78), an aliphatic, aryl or heterocyclic sulfonyl group (e.g. methanesulfonyl (σₚ value: 0.72)), an aliphatic, aryl or heterocyclic acyl group (e.g. acetyl (σₚ value: 0.50), benzoyl (σₚ value: 0.43)), an alkynyl group (e.g. C═CH (σₚ value: 0.23)), an aliphatic, aryl or heterocyclic oxycarbonyl group (e.g. methoxycarbonyl (σₚ value: 0.45), phenoxycarbonyl (σₚ value: 0.44)), a carbamoyl group (σₚ value: 0.36), a sulfamoyl group (σₚ value: 0.57), a sulfoxide group, a heterocyclic group, a phosphoryl group and the like. The σₚ value is preferably in a range of 0.2 to 2.0, more preferably in a range-of 0.4 to 1.0. As the electron withdrawing group, a carbamoyl group, an alkoxycarbonyl group, an alkylsulfonyl group and an alkylphosphoryl group are particularly preferable and, inter alia, a carbamoyl group is most preferable.

X is preferably an electron withdrawing group, more preferably a halogen atom, an aliphatic, aryl or heterocyclic sulfonyl group, an aliphatic, aryl or heterocyclic acyl group, an aliphatic aryl or heterocyclic oxycarbomyl group, a carbamoyl group and a sulfamoyl group, particularly preferable a halogen atom. Among halogen atoms, a chlorine atom, a bromine atom and an iodine atom are preferable, a chlorine atom and a bromine atom are further preferable, and a bromine atom is particularly preferable.

Y represents preferably —C(═O)—, —SO— or —SO₂—, more preferably —C(═O)— or —SO₂—, particularly preferably SO₂—. A symbol n represents 0 or 1, preferably 1.

Examples of the compound of the formula (H) in the invention will be shown below.

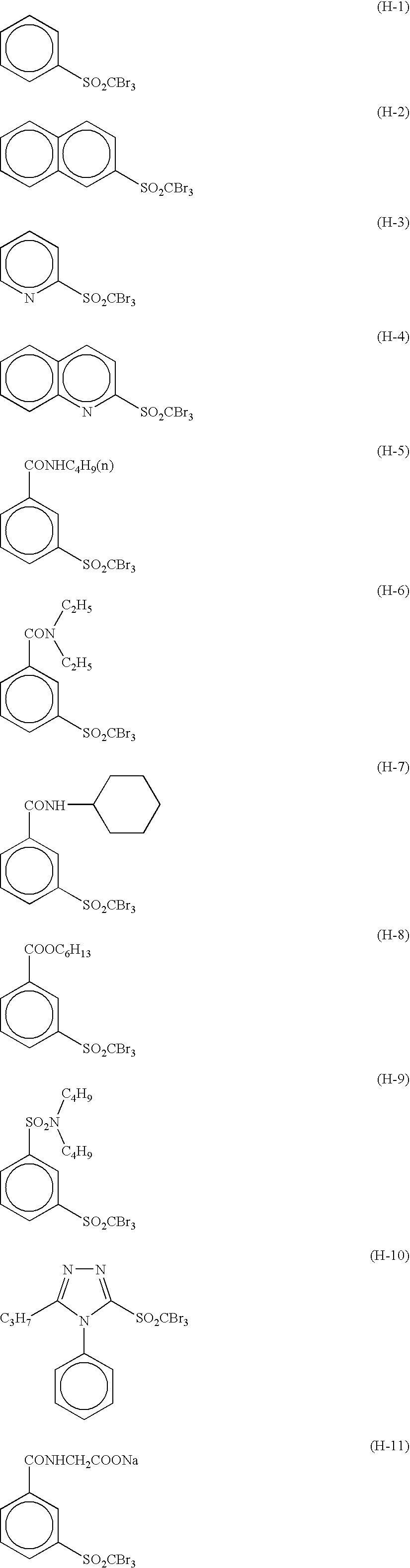

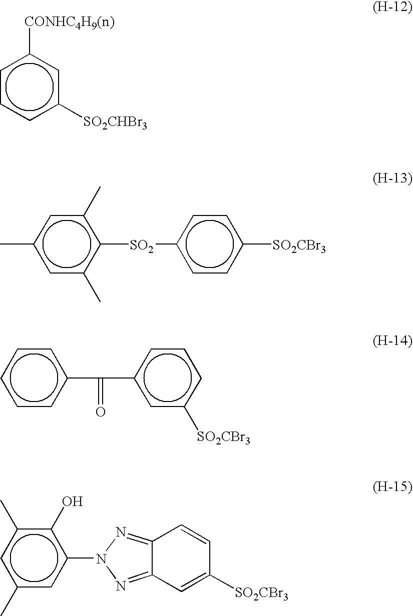

Examples of a preferable polyhalogen compound in the invention other than those described above include compounds described in JP-A Nos. 2001-31644, 2001-56526, and 2001-209145.

The coating amount of the organic polyhalogen compound of the present invention is preferably in a range of 0.01 to 0.5 g/m², more preferably in a range of 0.01 to 0.4 g/m², further preferably in a range of 0.01 to 0.3 g/m². When the coating amount of the organic polyhalogen compound exceeds 0.5 g/m², deterioration in sensitivity becomes significant thus it is not preferable.

The compound represented by the formula (H) in the invention is used at a range of 10⁻⁴ to 1 mol, more preferably at a range of 10⁻³ to 0.5 mol, further preferably at a range of 1×10⁻² to 0.2 mol per 1 mol of a non-photosensitive silver salt in an image forming layer.

In the invention, examples of a method inclusion of an antifoggant in a photosensitive material include the method described in the method of the inclusion of a reducing method, and it is also preferable that an organic polyhalogen compound is added as a solid fine particle dispersion.

Other Antifoggant

Examples of other antifoggant include a mercury (II) salt described in JP-A No. 11-65021, paragraph number 0113, benzoic acids described in JP-A No. 11-65021, paragraph number 0114, a salicylic acid derivative described in JP-A No. 2000-206642, a formalin scavenger compound represented by the formula (S) described in JP-A No. 2000-221634, a triazine compound relating to claim 9 of JP-A No. 11-354624, a compound represented by the formula (III) described in JP-A No. 6-11791, 4-hydroxy-6-methyl-1,3,3a, 7-tetrazinedene and the like.

For the purpose of fog prevention, the photothermographic material in the invention may contain an azolium salt. Examples of the azolium salt include a compound represented by the formula (XI) described in JP-A No. 59-193447, a compound described in JP-B No. 55-12581, and a compound represented by the formula (II) described in JP-A No. 60-153039. The azolium salt may be added to any part of a photosensitive material, and it is preferable to add to a layer of a plane having a photosensitive layer, and it is further preferable to add to an organic silver salt-containing layer. The azolium salt may be added at any step of preparation of a coating solution and, when added to an organic silver salt-containing layer, the salt may be added at any step from preparation of an organic silver salt to preparation of a coating solution, preferably after preparation of an organic silver salt to immediately before coating. The azolium salt may be added by any method such as a powder, a solution and a fine particle dispersion. In addition, a solution obtained by mixing with other additives such as a sensitizing dye, a reducing agent and a tone adjusting agent may be added. In the invention, an amount of the azolium salt to be added may be any amount, preferably not smaller than 1×10⁻⁶ mol and not larger than 2 mol, further preferably not smaller than 1×10⁻³ mol and not smaller than 0.5 mol.

Other Additives

1) Mercapto, Disulfide and Thione Compounds

In the invention, for suppressing or promoting development, or controlling development, improving the Spectral sensitizing efficacy, or improving the shelf stability before and after development, a mercapto compound, a disulfide compound and a thione compound may be contained, and examples thereof include compounds represented by the formula (I) described in JP-A No. 10-62899, paragraph numbers 0067 to 0069, JP-A No. 10-186572, and embodiments thereof described in the same paragraph numbers 0033 to 0052, EP Publication No. 0803764A1, page 20, lines 36 to 56. Inter alia, mercapto-substituted heterocyclic aromatic compounds described in JP-A Nos. 9-297367, 9-304875, JP-A No. 2001-100358, Japanese Patent Application Nos. 2001-104213, and 2001-104214 are preferable.

2) Tone Adjusting Agent

It is preferable that a tone adjusting agent is added to the photothermographic material of the invention, and a tone adjusting agent is described in JP-A No. 10-62899, paragraph numbers 0054 to 0055, EP Publication No. 0803764 A1, page 21, lines 23 to 48, JP-A Nos. 2000-356317 and 2000-187298 and, in particular, phthalazinones (phthalazinone, phthalazinone derivative or metal salt; e.g. 4-(1-naphthyl)phthalazinone, 6-chlorophthalazinone, 5,7-dimethoxyphthalazinone and 2,3-dihydro-1,4-phthalazinedione); a combination of phthalazinones and phthalic acids (e.g. phthalic acid, 4-methylphthalic acid, 4-nitrophthalic acid, diammonium phthalate, sodium phthalate, potassium phthalate and tetrachlorophthalic anhydride); phthaladines (phthaladine, phthaladine derivative or metal salt; e.g. 4-(1-naphthyl)phthalazine, 6-isopropylphthalazine, 6-t-butylphthalazine, 6-chlorophthalazine, 5,7-dimethoxyphthalazine and 2,3-dihydrophthalazine); a combination of phthalazines and phthalic acids are preferable, and a combination of phthalazine and phthalic acids is particularly preferable. Inter alia, a particularly preferable combination is a combination of 6-isopropylphthaladine and phthalic acid or 4-methylphthalic acid.

3) Plasticizer, Lubricant and Sliding Agent

A plasticizer and a lubricant which can be used in a photosensitive layer in the invention are described in JP-A No. 11-65021, paragraph number 0117. A sliding agent which can be used in a photosensitive layer in the invention are described in JP-A No. 11-84573, paragraph numbers 0061 to 0064, and JP-A No. 11-106881, paragraph numbers 0049 to 0062.

4) Dyes and Pigments

From a viewpoint of improvement in tone, prevention of occurrence of interference fringe at laser exposure, and prevention of irradiation, various dyes and pigments (e.g. C. I. Pigment Blue 60, C. I. Pigment Blue 64, C. I. Pigment Blue 15:6) can be used in a photosensitive layer in the invention. These are described in WO98/36322, JP-A Nos. 10-268465, 11-338098 and the like in detail.

5) Super-High Contrast Enhancer Agent

For forming a super-high contrast image suitable for printing making plate utility, it is preferable to add a Super-high contrast enhancer agent to an image forming layer. A Super-high contrast enhancer agent and a method of adding the same and an amount of the same to be added are described in the same, paragraph number 0118, JP-A No. 11-223898, paragraph numbers 0136 to 0193, compounds of the formula (H) the formulae (1) to (3), and the formulae (A) and (B) in Japanese Patent Application No. 11-87297, compounds of the formulae (specific compounds: Chemical formula 21 to Chemical formula 24) described in Japanese Patent Application No. 11-91652, and a super-high contrast promoter is described in JP-A No. 11-65021, paragraph number 0102, JP-A No. 11-223898, paragraph numbers 0194 to 0195.

In order to use formic acid or formate as a strong fogging substance, it is preferable that the substance is contained on a side having an image forming layer containing photosensitive silver halide at 5 mmol or smaller, more preferably at 1 mmol or smaller per 1 mol of silver.

When a Super-high contrast enhancer agent is used in the photothermographic material of the invention, it is preferable to use an acid formed by hydration of diphosphorus pentaoxide, or a salt thereof in combination. Examples of an acid formed by hydration of diphosphorus pentaoxide or a salt thereof include metaphosphoric acid (metaphosphate), pyrophosphoric acid (pyrophosphate), orthophophoric acid (orthophosphate), triphosphoric acid (triphosphate), tetraphosphoric acid (tetraphosphate) and hexametaphosphoric acid (hexametaphosphate). Examples of an acid formed by hydration of diphosphorus pentaoxide or a salt thereof which is particularly preferably used include orthophosphoric acid (orthophosphate) and hexametaphosphoric acid (hexamethaphosphate). Specific salts include sodium orthophosphate, dihydrogen sodium orthophosphate, sodium hexametaphosphate and ammonium hexametaphosphate.

An amount of an acid formed by hydration of diphosphorus pentaoxide or a salt thereof to be used (coating amount per 1 m² of photosensitive material) may be a desired amount depending on the performance such as the sensitivity and the fog, and 0.1 to 500 mg/m² is preferable, and 0.5 to 100 mg/m² is more preferable.

It is preferable to use a reducing agent, a hydrogen bond-forming compound, a development promoter and a polyhalogen compound in the invention as a solid dispersion, and a preferable process for preparing these solid dispersions is described in JP-A No. 2002-55405.

Preparation and Coating of Coating Solution

A preparation temperature of an image forming layer coating solution in the invention is suitably not lower than 30° C. and not higher than 65° C., a further preferable temperature is not lower than 35° C. and lower than 60° C., and a more preferable temperature is not lower than 35° C. and not higher than 55° C. In addition, it is preferable that a temperature of an image forming layer coating solution immediately after addition of a polymer latex is maintained at not lower than 30° C. and not higher than 65° C.

Layer Construction and Constituents

An image forming layer in the invention is constructed of one or more layer(s) on a substrate. When constructed of one layer, the layer comprises an organic silver salt, a photosensitive silver halide, a reducing agent and a binder and, if necessary, the layer contains desired additional materials such as a tone adjusting agent, a covering aid and other ancillary agents. When constructed of two or more layers, a first image forming layer (usually a layer adjacent to a substrate) must contain an organic silver salt and photosensitive silver halide, and a second image forming layer or both layers must contain some other components. A construction of a multi-color photosensitive thermal developing photographic material may contain a combination of these two layers per each color, or a single layer may contain all components as described in U.S. Pat. No. 4,708,928.

In the case of a multi-dye multi-color photosensitive thermal developing photographic material, respective emulsion layers are generally distinguished from each other and are retained by using a functional or non-functional barrier layer between respective photosensitive layers as described in U.S. Pat. No. 4,460,681.

The photothermographic material of the invention can have a non-photosensitive layer in addition to an image forming layer. From arrangement, the non-photosensitive layer can be classified into (a) a surface protective layer provided on an image forming layer (a side more far than a substrate), (b) an intermediate layer provided between a plurality of image forming layers, or between an image forming layer and a protecting layer, (c) an undercoat layer provided between an image forming layer and a substrate, and (d) a back layer provided on a side opposite to an image forming layer.

In addition, a layer acting as an optical filter may be provided, and is provided as a (a) or (b) layer. An anti-halation layer is provided as a (c) or (d) layer in a photosensitive material.

1) Surface Protective Layer

In order to prevent adhesion of an image forming layer, a surface protective layer can be provided on the photothermographic material in the invention. The surface protective layer may be a single layer, or a plurality of layers.

The surface protective layer is described in JP-A No. 11-65021, paragraph numbers 0119 to 0120, and JP-A No. 2000-171936.

As a binder in a surface protective layer in the invention, gelatin is preferable, and it is also preferable to use polyvinyl alcohol (PVA) or use it in combination. As gelatin, inert gelatin (e.g. trade name: Nitta gelatin 750, manufactured by Nitta gelatin Co., Ltd.) and phthalated gelatin (e.g. trade name: Nitta gelatin 801, manufactured by Nitta gelatin Co., Ltd.) can be used. Examples of PVA include those described in JP-A No. 2000-171936, paragraph numbers 0009-2020, and preferable examples include completely saponified PVA-105, partially saponified PVA-205 and PVA-335, and MP-203 of modified polyvinyl alcohol (all trade names, manufactured by Kuraray Co., Ltd.). An amount of polyvinyl alcohol in a protecting layer (per 1 layer) to be coated (per 1 m² of support) is preferably 0.3 to 4.0 g/m², more preferably 0.3 to 2.0 g/m².

An amount of a total binder (including water-soluble polymer and latex polymer) in a surface protective layer (per 1 layer) to be coated (per 1 m² of support) is preferably 0.3 to 5.0 g/m², more preferably 0.3 to 2.0 g/m².

2) Anti-Halation Layer

In the photothermographic material of the invention, an anti-halation layer can be provided on a photosensitive layer on a side farer from a light source.

An anti-halation layer is described in JP-A No. 11-65021, paragraph numbers 0123 to 0124, JP-A Nos. 11-223898, 9-230531, 10-36695, 10-104779, 11-231457, 11-352625, 11-352626 and the like.

An anti-halation dye having absorption in an exposure wavelength is contained in an anti-halation layer. When an exposure wavelength is in an infrared region, an infrared-ray absorbing dye may be used and, in that case, a dye having no absorption in a visible region is preferable.

When halation prevention is conducted using a dye having absorption in a visible region, it is preferable that a color of a dye does not substantially remain after image formation, it is preferable that a means of quenching by the heat of thermal development is used, and it is particularly preferable that a thermal quenching dye and a base precursor are added to a non-photosensitive layer so as to function as an anti-halation layer. These techniques are described in JP-A No. 11-231457.

An amount of a quenching dye to be added is determined depending on utility of a dye. Generally, the dye is used at such an amount that the optical concentration (absorbance) when measured at a desired wavelength exceeds 0.1. The optical concentration is preferably 0.15 to 2, more preferably 0.2 to 1. An amount of a dye to be used for obtaining such the optical concentration is generally around 0.001 to 1 g/m².

When a dye is quenched like this, the optical concentration after thermal development can be lowered below 0.1. Two or more kinds of quenching dyes may be used in combination in a thermal quenching-type recording material or a photothermographic material. Similarly, two or more kinds of base precursors may be used in combination.

In thermal quenching using such the quenching dye and base precursor, it is preferable from the viewpoint of thermal quenching property that a substance which lowers a melting point by 3° C. (deg) or more when mixed with a base precursor described in JP-A No. 11-352626 (e.g. diphenylsulfone, 4-chlorophenyl(phenyl)sulfone), 2-naphthyl benzoate and the like are used in combination.

3) Back Layer

A back layer which can be applied to the invention is described in JP-A No. 11-65021, paragraph numbers 0128 to 0130.

In the invention, for the purpose of improving change in silver tone and image with time, a coloring agent having maximum absorption at 300 to 450 nm can be added. Such the agent is described in JP-A Nos. 62-210458, 63-104046, 63-103235, 63-208846, 63-306436, 63-314535, 01-61745, and 2001-100363.

Such the coloring agent is usually added in a range of 0.1 mg/m² to 1 g/m², and is preferably added to a back layer which is provided on a side opposite to a photosensitive layer.

In addition, in order to adjust base tone, it is preferable to use a dye having an absorption peak at 580 to 680 nm. As a dye for this purpose, an azomethine type oil-soluble dye having the small absorption intensity on a short wavelength side described in JP-A Nos. 4-359967 and 4-359968, and a phthalocyanine type water-soluble dye described in Japanese Patent Application No. 2002-96797 are preferable. A dye for this purpose may be added to any layer, and it is more preferable to add to a non-photosensitive layer on an emulsion surface side or to a back surface side.

It is preferable that the photothermographic material in the invention is a so-called one side photosensitive material having at least one photosensitive layer containing a silver halide emulsion on one side of a substrate, and having a back layer on the other side.

4) Matting Agent

In the invention, for improving the conveyance property, it is preferable to add a matting agent, and a matting agent is described in JP-A No. 11-65021, paragraph numbers 0126 to 0127. An amount of a matting agent to be coated per 1 m² of a photosensitive material is preferably 1 to 400 mg/m², more preferably 5 to 300 mg/m².

In the invention, a shape of a matting agent may be defined-shaped or undefined-shaped, and defined-shaped sphere is preferably used. An average particle diameter is preferably in a range of 0.5 to 10 μm, more preferably in a range of 1.0 to 8.0 μm, further preferably in a range of 2.0 to 6.0 μm. In addition, a variation coefficient of a size distribution is preferably 50% or smaller, more preferably 40% or smaller, further preferably 30% or smaller. Herein, a variation coefficient is a value expressed by (standard deviation of particle diameter)/(average of particle diameter)×100. In addition, it is preferable that two kinds of matting agents having a small variation coefficient and a ratio of an average particle diameter of larger than 3 are used in combination.

In addition, a matting degree of an emulsion surface may be any degree as far as stardust disorder does not occur, and is preferably not smaller than 30 seconds and not larger than 2000 seconds, particularly preferably not smaller than 40 seconds and not larger than 1500 seconds expressed as Beck smoothness. Beck smoothness can be easily obtained by known methods (e.g. method of testing smoothness of paper and board by Beck testing device).

In the invention, a matting degree of a back layer as a Beck smoothness is preferably not larger than 1200 seconds and not smaller than 10 seconds, more preferably not larger than 800 seconds and not smaller than 20 seconds, further preferably not larger than 500 seconds and not smaller than 40 seconds.

In the invention, it is preferable that a matting agent is contained in an outermost surface layer of a photosensitive material or a layer functioning as an outermost surface layer, or a layer near the outer surface, and it is preferable that the matting agent is contained in a layer acting as a so-called protecting layer.

5) Polymer Latex

When the photothermographic material of the invention is used in printing utility, in particular, in which a dimensional change is problematic, it is preferable that a polymer latex is used in a surface protective layer or a back layer. Such the polymer latex is described in Synthetic Resin Emulsion (edited by Taira Okuda, Hiroshi Inagaki, published by Polymer Publishing society (1978)), Application of Synthetic latex (edited by Takaaki Sugimura, Yasuo Kataoka, Soichi Suzuki, Keiji Kasahara, published by Polymer Publishing Society (1993)), and Chemistry of Synthetic Latex (Authored Souichi Muroi, published by Polymer Publishing Society, (1970)), and examples thereof include methyl methacrylate (33.5% by weight); ethyl acrylate (50% by weight)/methacrylic acid (16.5% by weight) copolymer latex, methyl methacryalte (47.5% by weight)/butadiene (47.5% by weight)/itaconic acid (5% by weight) copolymer latex, ethyl acrylate/methacrylic acid copolymer latex, methyl methacrylate (58.9% by weight)/2-ethylhexyl acryalte (25.4% by weight)/styrene (8.6% by weight)/2-hydroxyethyl methacrylate (5.1% by weight)/acrylic acid (2.0% by weight) copolymer latex, methyl methacrylate (64.0% by weight)/styrene (9.0% by weight)/butyl acrylate (20.0% by weight)/2-hydroxyethyl methacryalte (5.0% by weight)/acrylic acid (2.0% by weight) copolymer latex. Further, as a binder for a surface protective layer, a combination of polymer latexes described in Japanese Patent Application No. 11-6872, the techniques described in JP-A No. 2000-267226, paragraph numbers 0021 to 0025, the techniques described in Japanese Patent Application No. 11-6872, paragraph numbers 0027 to 0028, and the techniques described in JP-A No. 2000-19678, paragraph numbers 0023 to 0041 may be applied. A ratio of a polymer latex in a surface protective layer is preferably not smaller than 10% by weight and not larger than 90% by weight, particularly preferably not smaller than 20% by weight and not larger than 80% by weight of a total binder.

6) Film Surface pH

In the photothermographic material of the invention, a film surface pH before thermal developing treatment is preferably 7.0 or smaller, more preferably 6.6 or smaller. A lower limit thereof is not particularly limited, but is around 3. A most preferable pH range is 4 to 6.2. It is preferable from the viewpoint of reduction in a film surface pH that a film surface pH is regulated by using an organic acid such as a phthalic derivative, a non-volatile acid such as sulfuric acid, or a volatile base such as ammonia. Since ammonia is easily volatized and can be removed before a coating step or thermal development, it is preferable in order to attain a low film surface pH.

Alternatively, it is preferable to use a non-volatile base such as sodium hydroxide, potassium hydroxide, lithium hydroxide and the like, and ammonia in combination. In addition, a method of measuring a film surface pH is described in JP-A No. 2000-284399, paragraph number 0123.

7) Hardening Agent

A hardening agent may be used in each layer of a photosensitive layer, a protecting layer and a back layer in the invention. As an example of a hardening agent, there are respective methods described in T. H. James “THE THEORY OF THE PHOTOGRAPHIC PROCESS, FOURTH EDITION” (published by Macmillan Publishing Co., Inc. in 1977), page 77 to 87, and in addition to chromium alum, 2,4-dichloro-6-hydroxy-s-triazine sodium salt, N,N-ethylenebis(vinylsulfonacetamide) and N,N-propylenebis(vinylsulfonacetamide), multi-valent metal ions described in the same document, page 78, polyisocyanates described in U.S. Pat. No. 4,281,060 and JP-A No. 6-208193, epoxy compounds described in U.S. Pat. No. 4,791,042, and vinylsulfone type compounds described in JP-A No. 62-89048 are preferably used.

A hardening agent is added as a solution, and a time of adding this solution to a protecting layer coating solution is from 180 minutes before coating to immediately before coating, preferably from 60 minutes before to 10 seconds before coating. A mixing method and mixing conditions are not particularly limited as far as the effect of the invention is sufficiently manifested. As a specific mixing method, there are a method of mixing in a tank so that an average retention time calculated from an addition flow rate and an amount of a solution to be supplied to a coater, and a method using a static mixer described in Liquid Mixing Technology authored by M. Harnby, M. F. Edwards, A. W. Nienow, translated by Koji TAKAHASHI (published by The Nikkan Kogyo Shimbun, Ltd. in 1989), Chapter 8.

8) Surfactant

Surfactants which can be applied in the invention are described in JP-A No. 11-65021, paragraph number 0132, solvents are described in the same, paragraph number 0133, supports are described in the same, paragraph number 0134, electrification prevention or electrical conducting layers are described in the same, paragraph number 0135, a method of obtaining a color image is described in the same, paragraph number 0136, and lubricants are described in JP-A No. 11-84573, paragraph numbers 0061 to 0064 and Japanese Patent Application No. 11-106881, paragraph numbers 0049 to 0062.

In the invention, it is preferable to use a fluorine surfactant. Examples of a fluorine surfactant include compounds described in JP-A Nos. 10-197985, 2000-19680, 2000-214554 and the like. In addition, a polymer fluorine surfactant described in JP-A No. 9-281636 is also preferably used. In the photothermographic material of the invention, it is preferable to use fluorine surfactants described in JP-A No. 2002-82411, Japanese Patent Application Nos. 2001-242357 and 2001-264110. In particular, fluorine surfactants described in Japanese Patent Application Nos. 2001-242357 and No. 2001-2646110 are preferable in the electrification adjusting ability, the stability of a coating surface and the sliding property when a coating is prepared using an aqueous coating solution, and a fluorine surfactant described in Japanese Patent Application No. 2001-264110 is most preferable in that the electrification adjusting ability is high and it is not necessary to use a large amount.

In the invention, a fluorine surfactant may be used both in an emulsion surface and in a back surface, and it is preferable to use on both surfaces. In addition, it is particularly preferable to use by combining with the aforementioned electrically conductive layer containing a metal oxide. In this case, even when an amount of a fluorine surfactant to be used on a surface having an electrically conductive layer is reduced or the surfactant is removed, the sufficient performance can be obtained.

A preferable amount of a fluorine surfactant to be used is in a range of 0.1 mg/m² to 100 mg/m², more preferably in a range of 0.3 mg/m² to 30 mg/m², further preferably in a range of 1 mg/m² to 10 mg/m² on each of an emulsion surface and a back surface. In particular, a fluorine surfactant described in Japanese Patent Application No. 2001-264110 has the remarkable effect, and a range of 0.01 to 10 mg/m² is preferable, and a range of 0.1 to 5 mg/m² is more preferable.

9) Antistatic Agent

It is preferable that the invention has an electrically conductive layer containing a metal oxide or an electrically conductive polymer. An antistatic layer may function also as an undercoating layer or a back layer surface protective layer, or may be disposed separately. As an electrically conductive material in an antistatic layer, metal oxides in which oxygen defect or a heterogeneous metal atom is introduced in a metal oxide to enhance the electrical conductivity are preferably used. As an example of a metal oxide, ZnO, TiO₂ and SnO₂ are preferable. It is preferable to add Al or In to ZnO, add Sb, Nb, P, halogen element or the like to SnO₂, or add Nb, Ta or the like to TiO₂. In particular, SnO₂ with Sb added thereto is preferable. An amount of a heterogeneous atom to be added is preferably in a range of 0.01 to 30% by mol, more preferably in a range of 0.1 to 10% by mol. A shape of a metal oxide may be any of spherical, needle-like and plate-like. From a viewpoint of the effect of imparting the electrical conductivity, a needle-like particle having a ratio of a long axis/a short axis of 2.0 or larger, preferably 3.0 to 50 is suitable. An amount of a metal oxide to be used is preferably in a range of 1 mg/m² to 1000 mg/m², more preferably in a range of 10 mg/m² to 500 mg/m², more preferably in a range of 20 mg/m² to 200 mg/m². An antistatic layer in the invention may be disposed on any of an emulsion surface and a back surface, and it is preferable to dispose between a support and a back layer. Examples of an antistatic layer in the invention are described in JP-A No. 11-65021, paragraph number 0135, JP-A Nos. 56-143430, 56-143431, 58-62646, 56-120519, 11-84573, paragraph numbers 0040 to 0051, U.S. Pat. No. 5,575,957, and JP-A No. 11-223898, paragraph numbers 0078 to 0084.

10) Support

In order to alleviate the internal distortion remaining in a film at biaxial stretching and exclude thermal shrinkage distortion generated during thermal developing treatment, as a transparent support, polyester, in particular, polyethylene terephthalate which has been subjected to heat treatment at a temperature range of 130 to 185° C. is preferably used. In the medical photothermographic material, a transparent support may be colored with a blue dye (e.g. dye-I described in JP-A No. 8-240877, Example) or non-colored. It is preferable to apply the technique of undercoating water-soluble polyester described in JP-A No. 11-84574, a styrene butadiene copolymer described in same 10-186565, or a vinylidene chloride copolymer described in JP-A No. 2000-39684 and Japanese Patent Application No. 11-106881, paragraph numbers 0063 to 0080 to a support.

11) Other additives

Further, an antioxidant, a stabilizer, a plasticizer, an ultraviolet-ray absorbing agent or a covering aid may be added to the photothermographic material. Various additives are added to either of a photosensitive layer or a non-photosensitive layer. Regarding them, reference may be made to WO98/36322, EP803764A1, JP-A Nos. 10-186567, and 10-18568.

12) Coating Method

The photothermographic material in the invention may be coated by any method. Specifically, various coating procedures including extrusion coating, slide coating, curtain coating, dipping coating, knife coating, flow coating, and extrusion coating using a hopper described in U.S. Pat. No. 2,681,294 are used, extrusion coating and slide coating described in Stephen F. Kistler, Petert M. Schweizer “LIQUID FILM COATING” (published by CHAPMAN & HALL in 1997), page 399 to 536 are preferably used, and slide coating is particularly preferably used. An example of a shape of a slide coater used in slide coating is described in the same document, page 427, FIG. 11b.1. Alternatively, two or more layers can be coated at the same time, if necessary, by a method described in the same document, page 399 to 536, or a method described in U.S. Pat. No. 2,761,791 and British Patent No. 837,095. A particularly preferable coating method in the invention is a method described in JP-A Nos. 2001-194748, 2002-153808, 2002-153803, 2002-182333.

It is preferable that an organic silver salt-containing layer coating solution in the invention is a so-called thixiotropic fluid. Regarding this technique, reference can be made to JP-A No. 11-52509. The organic silver salt-containing layer coating solution in the invention has a viscosity at a shear rate of 0.1 S⁻¹ of, preferably not smaller than 400 mPa·s and not larger than 100,000 mPa·s, more preferably not smaller than 500 mPa·s and not larger than 20,000 mPa·s. In addition, at a shear rate of 1000 s⁻¹, a viscosity is preferably not smaller than 1 mPa·s and not larger than 200 mPa·s, Further preferably not smaller than 5 mPa·s and not larger than 80 mPa·s.

When two kinds of solutions are mixed in preparing a coating solution in the invention, the known in-line mixer and implant mixer are preferably used. A preferable in-line mixer in the invention is described in JP-A No. 2002-85948, and an implant mixer is described in JP-A No. 2002-96940.

It is preferable that a coating solution in the invention is defoaming-treated in order to retain the state of a coating surface better. A defoaming treating method preferable in the invention is a method described in JP-A No. 2002-66431.

Upon coating of a coating solution in the invention, it is preferable to eliminate electricity in order to prevent adhesion of rubbish and dusts due to electrification of a support. An example of a method of eliminating electricity preferable in the invention is described in JP-A No. 2002-143747.

In the invention, it is important to precisely control a drying wind and a drying temperature in order to dry a non-setting image forming layer coating solution. A drying method preferable in the invention is described in detail in JP-A Nos. 2001-194749, and 2002-139814.

It is preferable that the photothermographic material of the invention is heat-treated immediately after coating and drying in order to improve the film foaming property. A temperature of heat treatment as a film surface temperature is preferably in a range of 60° C. to 100° C., and a heating time is preferably in a range of 1 second to 60 seconds. A more preferable range is a film surface temperature of 70 to 90° C. and a heating time of 2 to 10 seconds. A method of heat treatment preferable in the invention is described in JP-A No. 2002-107872.

In addition, in order to continuously prepare the photothermographic material of the invention stably, a process described in JP-A Nos. 2002-156728, and 2002-182333 is preferably used.

It is preferable that the photothermographic material is a monosheet-type (a type which can form an image on a photothermographic material without using other sheet as in an image receiving material).

13) Packaging Material

It is preferable that the photosensitive material of the invention is wrapped with a packaging material having the low oxygen permeability and/or moisture permeability in order to suppress variation of the photographic property at live storage, or improve curling and winding habit. The oxygen permeability is preferably 50 ml/atm·m²·day or smaller, more preferable 10 ml/atm·m²·day or smaller, further preferably 1.0 ml/atm·m²·day or smaller, at 25° C. The moisture permeability is preferably 10 g/atm·m²·day or smaller, more preferably 5 g/atm·m²·day or smaller, further preferable 1 g/atm·m²·day or smaller.

Examples of a packaging material having the low oxygen permeability and/or moisture permeability include packaging materials described in JP-A Nos. 8-254793 and 2000-206653.

14) Other available techniques

The techniques which can be used in the thermal photosensitive material of the invention include those described in EP Nos. 803764A1, 883022A1, WO98/36322, JP-A Nos. 56-62648, 58-62644, 9-43766, 9-281637, 9-297367, 9-304869, 9-311405, 9-329865, 10-10669, 10-62899, 10-69023, 10-186568, 10^{-90823, 10}-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30382, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2000-187298, 2000-10229, 2000-47345, 2000-206642, 2000-98530, 2000-98531, 2000-112059, 2000-112060, 2000-112104, 2000-112064, and 2000-171936.

In the case of a multi-color photothermographic material, respective emulsion layers are generally retained by being isolated from each other by using a functional or non-functional barrier layer between respective photosensitive layers as described in U.S. Pat. No. 4,460,681.

The construction in the case of a multi-color photothermographic material may contain a combination of these two layers regarding each color, or may contain all components in a single layer as described in U.S. Pat. No. 4,708,928.

Image Forming Method

1) Exposure

Red to infrared emitting He—Ne laser, red semiconductor laser, blue to green emitting Ar⁺, He—Ne, He—Cd laser, and blue semiconductor laser. A red to infrared semiconductor laser is preferable, and a peak wavelength of the laser light is 600 nm to 900 nm, preferably 620 nm to 850 nm. In contrast to the above, recently, in particular, a module in which a SHG (Second Harmonic Generator) element and a semiconductor laser are incorporated, and a blue semiconductor laser have been developed, and a laser output apparatus at a short wavelength region has been paid attention. Demand of a blue semiconductor laser is expected to be expanded in the future because a high precision image recording is possible, a recording density is increased, and a long and stable output can be obtained. A peak wavelength of a blue laser light is 300 nm to 500 nm, particularly preferably 400 nm to 500 nm.

It is preferable that the laser light is oscillated in a longitudinal multiple format by a high frequency overlapping.

2) Thermal Development

The photothermographic material of the invention may be developed by any method, and is usually developed by raising a temperature of a photothermographic material exposed to an image wide. A preferable developing temperature is 80 to 250° C., preferably 100 to 140° C., more preferably 110 to 130° C. A developing time is preferably in a range of 1 to 60 seconds, more preferably 3 to 30 seconds, further preferably 5 to 25 seconds, particularly preferably in a range of 7 to 15 seconds.

As a format of thermal development, any of a drum heater and a plate heater may be used, and a plate heater format is more preferable. As a thermal development format according to a plate-type heater format, a method described in JP-A No. 11-133572 is preferable, and it is a thermal developing apparatus for obtaining a visible image by contacting a photothermographic material with a latent image formed thereon with a heating means at a thermal developing part, in which the heating means is composed of a plate heater, a plurality of pushing rollers are oppositely disposed along one surface of the plate heater, and thermal development is performed by passing the photothermographic material between the pushing roller and the plate heater. It is preferable that the plate heater is divided into 2 to 6 stages and a temperature is lowered by around 1 to 10° C. at a tip part. For example, there is an example in which four sets of plate heaters which can control a temperature independently are used, so as to control at 112° C., 119° C., 121° C., 120° C., respectively. Such the method is described in JP-A No. 54-30032, in which a moisture and an organic solvent contained in a photothermographic material can be excluded to the outside of a system, and change in a shape of a support for the photothermographic material due to rapid heating of the photothermographic material can be suppressed.

In order to miniaturize and shorten a thermal developing time, it is preferable that more stable control of a heater can be conducted, and it is desirable to initiate exposure of one sheet photosensitive material at its tip, and initiate thermal development before completion of exposure until a rear part. An imager being capable of conducting rapid treatment which is preferable in the invention is described, for example, in Japanese Patent Application Nos. 2001-08832 and 2001-091114. When this imager is used, it is possible to conduct thermal developing treatment for 14 seconds, for example, with a three-stage plate-type heater controlled at 107° C.-121° C.-121° C., and an output time for the first sheet can be shortened to about 60 seconds. For such the rapid thermal developing treatment, it is preferable to use by combining with the thermal developing material-2 in the invention which hardly undergoes influence of an environmental temperature.

3) System

Examples of a medical laser imager equipped with an exposing part and a thermal developing part include Fuji Medical dry laser imager FM-DP L (trade name, manufactured by Fuji Photo Film Co. Ltd.). FM-DP L is described in Fuji Medical Review No. 8, page 39 to 55, and it goes without saying that those techniques can be applied as a laser imager for the photothermographic material of the invention. Alternatively, as a network system suitable for DICOM, “AD network” laser imager proposed by Fuji Film Medical System Co., Ltd. can be applied to a photothermographic material.

Utility of the Invention

It is preferable that the photothermographic material is used as a medical diagnostic photothermographic material, an industrial photographic photothermographic material, a printing photothermographic material, or a COM photothermographic material, after formation of a black and white image due to silver image.

### EXAMPLES

The present invention will be specifically explained by way of Examples below, but the invention is not limited by them.

### Example 1

Preparation of PET Support

1) Preparation of PET Film Support

Using terephthalic acid and ethylene glycol, PET having an intrinsic viscosity IV=0.66 (measured in phenol/tetrachloroethane=6/4 (weight ratio) at 25° C.) is obtained. This was pelletized, dried at 130° C. for 4 hours, melted at 300° C., extruded through a T die, and cooled to make an unstretched film having such a thickness that a thickness after thermal setting became 175 μm.

This was stretched at 3.3-fold in a machine direction using rolls having different circumferential rates and, then, stretched at 4.5-fold in a transverse direction with a tenter. Temperatures thereupon are 110° C. and 130° C., respectively. Thereafter, this was thermally set at 240° C. for 20 seconds, and relaxed by 4% in a transverse direction at the same temperature. Thereafter, a chuck part of the tenter was subjected to slitting, both ends are subjected to Narr processing, and wound at 4 kg/cm² to obtain a roll having a thickness of 175 μm.

2) Surface Corona Treatment

Using a corona treating machine (trade name: Solid State corona treating machine 6 KVA model, manufactured by Pillar), both surfaces of a support are treated at room temperature at 20 m/min. From readings of a current and a voltage upon this, it was found that a support is treated at 0.375 kV·A·min/m². Upon this, a treating frequency was 9.6 kHz, and a gap clearance between an electrode and a dielectric roll was 1.6 mm.

3) Preparation of Undercoated Support

(1) Preparation of Undercoating Layer Coating Solution

Formulation 1 (for photosensitive layer side undercoating)

| | | |
|---|---|---|
| Polyester resin (trade name: pesresin A-520 (30% by weight | 59 | g |
| solution), manufactured by Takamatsu Oil & Fat Co., Ltd.) | | |
| Polyethylene glycol monononyl phenyl ether | 5.4 | g |
| (Average ethylene oxide number = 8.5) 10% by weight | | |
| solution | | |
| Polymer fine particle (Average particle diameter = 0.4 μm) | 0.91 | g |
| (trade name: MP-1000, manufactured by Soken Chemical & | | |
| Engineering Co., Ltd.) | | |
| Distilled water | 935 | ml |

Formulation 2 (for first layer of the back surface layer)

| | | |
|---|---|---|
| Styrene-butadiene copolymer latex | 158 | g |
| (Solid 40% by weight, styrene/butadiene weight ratio = 68/32) | | |
| 2,4-Dichloro-6-hydroxy-s-triazine sodium salt (8% by weight | 20 | g |
| aqueous solution) | | |
| 1% by weight aqueous solution of sodium | 10 | ml |
| laurylbenzenesulfonate | | |
| Distilled water | 854 | ml |

Formulation 3 (for second layer of the back surface layer)

| | | |
|---|---|---|
| SnO₂/SbO (9/1 mass ratio, average particle diameter: | 84 | g |
| 0.038 μm, 17% by weight dispersion) | | |
| Gelatin (10% by weight aqueous solution) | 89.2 | g |
| Cellulose derivative (trade name: Methorose TC-5, | 8.6 | g |
| manufactured by Shin-Etsu Chemical Co., Ltd.) (2% by | | |
| weight aqueous solution) | | |
| Polymer fine particle (trade name: MP-1000, manufactured by | 0.01 | g |
| Soken Chemical & Engineering Co., Ltd., average particle | | |
| diameter 0.4 μm) | | |
| 1 weight % aqueous solution of sodium | 10 | ml |
| dodecylbenzenesulfonate | | |
| NaOH (1% by weight) | 6 | ml |
| Proxel (manufactured by ICI) | 1 | ml |
| Distilled water | 805 | ml |

(2) Undercoating

Each of both sides of the aforementioned biaxial stretched polyethylene terephthalate support having a thickness of 175 μm was subjected to the aforementioned corona discharge treatment, (1) the aforementioned undercoating coating solution formulation 1 was coated on one side (photosensitive layer side) at a wet coating amount of 6.6 ml/m² (per one side) with a wire bar, and dried at 180° C. for 5 minutes and, then, (2) the aforementioned undercoating coating solution formulation 2 was coated on a back side at a wet coating amount of 5.7 ml/m² with a wire bar, and dried at 180° C. for 5 minutes, further, (3) the aforementioned undercoating coating solution formulation 3 was coated on the back side at a wet coating amount of 7.7 ml/m² with a wire bar, and dried at 180° C. for 6 minutes to prepare an undercoated support.

Back Layer

1) Preparation of Back Layer Coating Solution

Preparation of (a) Solid Fine Particle Dispersion of Base Precursor

2.5 kg of the base precursor compound-1, 300 g of a surfactant (trade name: Demol N, manufactured by Kao Corporation), 800 g of diphenylsulfone, 1.0 g of benzoisothiazolinone sodium salt and distilled water were mixed to a total amount of 8.0 kg, and the mixed solution was beads-dispersed using a transverse-type sand mill (trade name: UVM-2, manufactured by AIMEX). As a dispersing method, the mixed solution was fed to the transverse-type sand mill charged with zirconia beads having an average diameter of 0.5 mm with a diaphragm pomp, and dispersed in the state at an internal pressure of 50 hPa or higher until a desired average particle diameter was obtained.

The dispersion was dispersed until a ratio of absorbance at 450 nm and absorbance at 650 nm (D450/D650) in spectral absorption of the dispersion as determined by spectral absorption measurement became 3.0. The resulting dispersion was diluted with distilled water so that the concentration of a base precursor became 25% by weight, and filtered with a filter (average pore diameter: using a 3 μm polypropylene filter) in order to trash, which was put into practice.

2) Preparation of Dye Solid Fine Particle Dispersion

6.0 kg of the cyanine dye compound-1, 3.0 kg of sodium p-dodecylbenzenesulfonate, 0.6 kg of a surfactant (trade name: Denol SNB, manufactured by Kao Corporation) and 0.15 kg of a defoaming agent (trade name: Surfinol 104E, manufactured by Nisshin Chemicals Co., Ltd.) were mixed with distilled water to a total solution amount of 60 kg. The mixed solution was dispersed with 0.5 mm zirconia beads using a transverse-type sand mill (trade name: UVM-2, manufactured by AIMEX).

The dispersion was dispersed until a ratio of absorbance at 650 nm and absorbance at 750 nm (D650/D750) in spectral absorption of the dispersion as determined by spectral absorption measurement became 5.0 or larger. The resulting dispersion was diluted with distilled water so that the concentration of a cyanine dye became 6% by weight, and filtered with a filter (average pore diameter, 1 μm) to remove trash, which was put into practice.

3) Preparation of Anti-Halation Layer Coating Solution

A temperature of a container was retained at 40° C., and 40 g of gelatin, 20 g of monodisperse polymethyl methacrylate fine particle (average particle size 8 μm, particle diameter standard deviation 0.4), 0.1 g of benzoisothiazolinone and 490 ml of water were added to dissolve gelatin. Further, 2.3 ml of a 1 mol/l aqueous sodium hydroxide solution, 40 g of the aforementioned dye solid fine particle dispersion, 90 g of (a) the aforementioned solid fine particle dispersion of a base precursor, 12 ml of a 3% aqueous sodium polystyrene sulfonate solution and 180 g of a 10% SBR latex solution were mixed. Immediately before coating, 80 ml of a 4% aqueous N,N-ethylenebis(vinylsulfoneacetamide) solution was mixed therein to obtain a anti-halation layer coating solution.

4) Preparation of Back Surface Protective Layer Coating Solution

A temperature of a container was retained at 40° C., and 40 g of gelatin, 35 mg of benzoisothiazolinone and 840 ml of water were added to dissolve gelatin. Further, 5.8 ml of a 1 mol/l aqueous sodium hydroxide solution, 1.5 g of liquid paraffin emulsion as liquid paraffin, 10 ml of a 5% aqueous di(2-ethylhexyl) sulfosuccinate sodium salt solution, 20 ml of a 3% aqueous sodium polystyrene sulfonate solution, 2.4 ml of a 2% fluorine surfactant (F-1) solution, 2.4 ml of a 2% fluorine surfactant (F-2) solution, and 32 g of a 19% by weight methyl methacrylate/sutyrene/butyl acrylate/hydroxyethyl methacrylate/acrylic acid copolymer (copolymerization ratio 57/8/28/5/2) latex solution were mixed. Immediately before coating, 25 ml of 4% aqueous N, N-ethylenebis (vinylsulfoneacetamide) solution was mixed therein to obtain a back surface protective layer coating solution.

5) Coating of Back Layer

The anti-halation layer coating solution was coated on a back side of the undercoated support at a gelatin coating amount of 0.52 g/m², further, the back surface protective layer coating solution was simultaneously coated thereon at a gelatin coating amount of 1.7 g/m², and dried to obtain a back layer.

Image Forming Layer, Intermediate Layer, and Surface Protective Layer

1. Preparation of Coating Materials

1) Preparation of Silver Halide Emulsion

Preparation of Silver Halide Emulsion 1

3.1 ml of a 1% by weight potassium bromide solution was added to 1421 ml of distilled water, and 3.5 ml of sulfuric acid having the concentration of 0.5 mol/l and 31.7 g of phthalated gelatin were added to obtain a solution, a temperature of which was retained at 30° C. while stirring in a reaction pot, and a solution A obtained by diluting to 22.22 g of silver nitrate to 95.4 ml by adding distilled water and a solution B obtained by diluting 15.3 g of potassium bromide and 0.8 g of potassium iodide to a volume of 97.4 ml with distilled water were added at a total amount at a constant flow rate over 45 seconds. Thereafter, 10 ml of a 3.5% by weight aqueous hydrogen peroxide solution was added, and 10.8 ml of 10% by weight aqueous benzoimidazole solution was further added. Further, a solution C obtained by diluting 51.86 g of silver nitrate to 317.5 ml by adding distilled water and a solution D obtained by diluting 44.2 g of potassium bromide and 2.2 g of potassium iodide to a volume of 400 ml with distilled water were added at a total amount at a constant flow rate over 20 minutes in the case of the solution C, or by a controlled double jet method while maintaining a pAg at 8.1 in the case of the solution D.

A total amount of a potassium salt of iridate (III) hexachloride was added to 1×10⁻⁴ mol per 1 mol of silver 10 minutes after initiation of addition of the solution C and the solution D. In addition, a total amount of an aqueous potassium hexacyanoferrate (II) solution was added at 3×10⁻⁴ mol per 1 mol of silver 5 seconds after completion of addition of the solution C. pH thereof was adjusted to 3.8 using sulfuric acid having the concentration of 0.5 mol/L, stirring was stopped, and a precipitation/desalting/water washing step was performed. pH thereof was adjusted to 5.9 using sodium hydroxide having the concentration of 1 mol/L to prepare a silver halide dispersion having a pAg of 8.0.

A temperature of the aforementioned silver halide dispersion was maintained at 38° C. while stirring, 5 ml of a 0.34% by weight solution of 1,2-benzoisothiazolin-3-one in methanol and, 40 minutes after, a temperature was elevated to 47° C. After 20 minutes from temperature elevation, a solution of sodium benzenethiosulfonate in methanol was added at 7.6×10⁻⁵ mol per 1 mol of silver and, further, after 5 minutes, a solution of a tellurium sensitizing agent C in methanol was added at 2.9×10⁻⁴ mol per 1 mol of silver, followed by aging for 91 minutes. Thereafter, a solution of a spectral sensitizing dye, which contains spectral sensitizing dyes A and B at a molar ratio of 3:1 in methanol, was added at a total amount of the sensitizing dyes A and B of 1.2×10⁻³ mol per 1 mol of silver and, after 1 minute, 1.3 ml of a 0.8% by weight solution of N,N′-dihydroxy-N″-diethylmelamine in methanol was added and, further 4 minutes after, a solution of 5-methyl-2-mercaptobenzoimidazole in methanol at 4.8×10⁻³ mol per 1 mol of silver, a solution of 1-phenyl-2-heptyl-5-mercapto-1,3,4-triazole in methanol at 5.4×10⁻³ mol per 1 mol of silver and an aqueous solution of 1-(3-methylureido)-5-mercaptotetrazole sodium salt at 8.5×10⁻³ mol per 1 mol of silver were added to prepare a silver halide emulsion 1.

A particle in the prepared silver halide emulsion was a silver bromide iodide particle containing 3.5% by mol iodine uniformly and having an average sphere-equivalent diameter of 0.042 μm and a variation coefficient of a sphere-equivalent diameter of 20%. A particle size and the like were obtained from an average of 1000 particles using an electron microscope. A [100] plane ratio of this particle was obtained to be 80% using a Kuberkamunk method.

Preparation of Silver Halide Emulsion 2

According to the same manner as that of preparation of the silver halide emulsion 1, a silver halide emulsion 2 was prepared, except that a solution temperature at particle formation was changed from 30° C. to 47° C., 15.9 g of potassium bromide was diluted with distilled water to a volume of 97.4 ml in the solution B, 45.8 g of potassium bromide was diluted with distilled water to a volume of 400 ml in the solution D, a time of adding the solution C was 30 minutes, and potassium hexacyanoferrete (II) was removed. Preparation, desalting, water washing, and dispersion were performed as in the silver halide emulsion 1. Further, according to the same manner as that of the emulsion 1, chemical sensitization, and addition of 5-methyl-2-mercaptobenzoimidazole and 1-phenyl-2-heptyl-5-mercapto-1,3,4-triazole were performed to obtain a silver halide emulsion 2, except that the amount of the tellurium sensitizing agent C to be added was changed to 1.1×10⁻⁴ mol per 1 mol of silver, the amount of the solution of the spectral sensitizing dye, which contains the spectral sensitizing dyes A and B at a molar ratio of 3:1 in methanol, was changed to a total of the sensitizing dyes A and B of 7.0×10⁻⁴ mol per 1 mol of silver, 1-phenyl2-heptyl-5-mercapto-1,3,4-triazole was changed to 3.3×10⁻³ mol per 1 mol of silver, and 1-(3-methylureido)-5-mercaptotetrazole sodium salt was changed to 4.7×10⁻³ mol per 1 mol of silver. An emulsion particle of the silver halide emulsion 2 was a pure silver bromide cubic particle having an average sphere-equivalent diameter of 0.080 μm and a variation coefficient of a sphere-equivalent diameter of 20%.

Preparation of Silver Halide Emulsion 3

According to the same manner as that of preparation of the silver halide emulsion 1, a silver halide emulsion 3 was prepared, except that a solution temperature at particle formation was changed from 30° C. to 27° C. In addition, precipitation, desalting, water washing and dispersion were performed as in the silver halide emulsion 1. According to the same manner as that of the emulsion 1, a silver halide emulsion 3 was obtained, except that the solution of the spectral sensitizing dye, which contains the spectral sensitizing dyes A and B at a molar ratio of 3:1 in methanol to be added, was changed to a solid dispersion (a gelatin solution) of the spectral sensitizing dyes A and B at a molar ratio of 1:1 of an addition amount of 6×10⁻³ mol per 1 mol of silver, the amount of the tellurium sensitizing agent C to be added was changed to 5.2×10⁻⁴ mol per 1 mol of silver and, 3 minutes after addition of the tellurium sensitizing agent, aurate bromide was added at 5×10⁻⁴ mol per 1 mol of silver and potassium thiocyanate was added at 2×10⁻³ mol per 1 mol of silver. An emulsion particle of the silver halide emulsion 3 was a silver bromide iodide particle containing 3.5% by mol of iodine uniformly and having an average sphere-equivalent diameter of 0.034 μm and a variation coefficient of a sphere-equivalent diameter of 20%.

Preparation of Mixed Emulsion A for Coating Solution

70% by weight of the silver halide emulsion 1, 15% by weight of the silver halide emulsion 2 and 15% by weight of the silver halide emulsion 3 were dissolved, and a 1% by weight aqueous benzothiazolium iodide solution was added at 7×10-3 mol per 1 mol of silver. Further, water was added so that the content of silver halide per 1 kg of a mixed emulsion for coating solution became 38.2 g as silver, and a sodium salt of 1-(3-methylurado)-5-mercaptotetrazole was added at 0.34 g per 1 kg of a mixed emulsion for coating solution.

Further, as a compound that can be one-electron-oxidized to provide one-electron oxidation product to release further 1 or more electron, compounds 1, 20 and 26 were respectively added at 2×10-3 mol per 1 mol of silver.

2) Preparation of Fatty Acid Silver Dispersion

Preparation of Fatty Acid Silver Dispersion A

87.6 kg of behenic acid (trade name: Edenor C22-85R, manufactured by Henkel), 423 L of distilled water, 49.2 L of an aqueous NaOH solution having the concentration of 5 mol/L, and 120 L of t-butyl alcohol were mixed, and stirred to react at 75° C. for 1 hour to obtain a sodium behenate solution A. Separately, 206.2 L of an aqueous solution of 40.4 kg of silver nitrate (pH 4.0) was prepared, and a temperature was retained at 10° C. A temperature of a reaction vessel in which 635 L of distilled water and 30 L of t-butyl alcohol were placed was retained at 30° C., and a total amount of the aforementioned sodium behenate solution A and a total amount of the silver nitrate solution were added at a constant flow rate over 93 minutes and 15 seconds and 90 minutes, respectively, while stirring well. Upon this, for 11 minutes after initiation of addition of the aqueous silver nitrate solution, only the aqueous silver nitrate solution was added and, thereafter, addition of the sodium behenate solution A was initiated and, for 14 minutes and 15 seconds after completion of addition of the aqueous silver nitrate solution, only the sodium behenate solution A was added. Upon this, a temperature in the reaction vessel was 30° C., and an outer temperature was controlled so that a solution temperature became constant. In addition, a temperature of a piping of a system for adding the sodium behenate solution A was retained by circulating warm water outside a double tube, and the system was regulated so that a solution temperature of an exit at a tip of an addition nozzle became 75° C. In addition, a temperature of a piping of a system for adding the aqueous silver nitrate solution was retained by circulating cold water outside a double tube. A position of adding the sodium behenate solution A and a position of adding the aqueous silver nitrate solution were disposed symmetrically relative to a stirring axis as a center, and heights were regulated so as not to contact with a reaction solution.

After completion of addition of the sodium behenate solution A, the solution was allowed to stand while stirring at that temperature for 20 minutes, and a temperature was raised to 35° C. over 30 minutes, followed by aging for 210 minutes. Immediately after completion of aging, solids were filtered off by centrifugation filtration, and the solids were washed with water until the conductivity of filtering water became 30 μS/cm. Thus, fatty acid silver salt was obtained. The resulting solids were stored as a wet cake without drying.

The form of the resulting silver behenate particle was evaluated by electron microscope imaging, and the particle was a scale-like crystal having, as an average, a=0.14 μm, b=0.4 μm, c=0.6 μm, an average aspect ratio of 5.2, an average sphere-equivalent diameter of 0.52 μm, and a variation coefficient of a sphere-equivalent diameter of 15% (a, b and c were defined in the text).

19.3 kg of polyvinyl alcohol (trade name: PVA-217, manufactured by Kurarey Co., Ltd.) and water were added to the wet cake corresponding to 260 kg of dry solid, a total weight of 1000 kg, the material is slurried with a dissolver wing, and further pre-dispersed with a pipeline mixer (trade name: PM-10 type, manufactured by MIZUHO Industrial Co., Ltd.).

Then, the pre-dispersed stock solution was treated three time with a dispersing machine (trade name: Microfluidizer M-610, manufactured by Microfluidex International Corporation, using Z-type interaction chamber) by regulating a pressure at 1260 kg/cm², to obtain a silver behenate dispersion. Cooling procedures were as follows: each of hose heat exchangers was mounted before and after the interaction chamber, and a temperature was set at a dispersion temperature at 18° C. by regulating a temperature of cooing medium.

Preparation of Fatty Acid Silver Dispersion B

Preparation of Recrystallized Behenic Acid

100 kg of behenic acid (trade name: Edelor C22-85R, manufactured by Henkel) was mixed with 1200 kg of isopropyl alcohol, dissolved at 50° C., filtered with a 10 μm filter, and recrystallization was performed by cooling to 30° C. A cooling speed upon recrystallization was controlled at 3° C./hour. The resulting crystal was filtered by centrifugation, and washed with 100 kg of isopropyl alcohol, and dried. The resulting crystal was esterified, subjected to GC-FID measurement, and it was found that the content of behenic acid is 96% and, besides, 2% of lignoceric acid, 2% of arachidic acid and 0.001% of erucic acid are contained.

Preparation of Fatty Acid Silver Dispersion B by Using Recrystallized Behenic Acid

88 kg of recrystallized behenic acid, 422 L of distilled water, 49.2 L of an aqueous NaOH solution having the concentration of 5 mol/L and 120 L of t-butyl alcohol were mixed, stirred and reacted at 75° C. for 1 hour to obtain sodium behenate solution B. Separately, 260.2 L of an aqueous solution of 40.4 kg of silver nitrate (pH 4.0) was prepared, and a temperature of the solution was retained at 10° C. A temperature of a reaction vessel in which 635 L of distilled water and 30 L of t-butyl alcohol were placed was retained at 30° C., and a total amount of the sodium behenate solution B and a total amount of the aqueous silver nitrate solution were added at a constant flow rate over 93 minutes and 15 seconds and 90 minutes, respectively, while stirring well. Upon this, for 11 minutes after initiation of addition of the aqueous silver nitrate solution, only the aqueous silver nitrate solution was added and, thereafter, addition of the sodium behenate solution B was initiated and, for 14 minutes and 15 seconds after completion of addition of the aqueous nitrate solution, only the sodium behenate solution B was added. Upon this, a temperature in the reaction vessel was 30° C., and an external temperature was controlled so that a solution temperature became constant. In addition, a temperature of a piping of a system for adding the sodium behenate solution B was retained by circulating warm water outside a double tube, and a solution temperature of an exit at a tip of an addition nozzle was regulated at 75° C. In addition, a temperature of a piping of a system for adding the aqueous silver nitrate solution was retained by circulating cold water outside a double tube. A position of adding the sodium behenate solution B and a position of adding the aqueous silver nitrate solution were disposed symmetrically relative to a stirring axis as a center, and heights are regulated so as not to contact with a reaction solution.

After completion of addition of the sodium behenate solution B, the solution was allowed at that temperature for 20 minutes while stirring, and a temperature was elevated to 35° C. for 30 minutes, followed by aging for 210 minutes. Immediately after completion of aging, the solid was filtered off by centrifugation filtration, and the solid was washed with water until the conductivity of filtering water became 30 μS/cm. Thus, fatty acid silver salt was obtained. The resulting solid was stored as a wet cake without drying.

The form of the resulting silver behenate particle was evaluated with electron microscope imaging, and a crystal was found to have, as an average, a=0.21 μm, b=0.4 μm, c=0.4 μm, average aspect ratio of 2.1, and a variation coefficient of a sphere-equivalent diameter of 11% (a, b and c were defined in the text).

19.3 kg of polyvinyl alcohol (trade name: PVA-217, manufactured by Kurarey Co., Ltd.) and water were added to the wet cake corresponding to 260 kg of the dry solid thereof, to a total amount of 1000 kg, the material was slurried with a dissolver wing, and further pre-dispersed with a pipeline mixer (trade name: PM-10 type manufactured by MIZUHO Industrial Co., Ltd.).

Then, the pre-dispersed stock solution was treated three times with a dispersing machine (trade name: Microfluidizer M-610, manufactured by Microfluidex International Corporation) (accompanied with the use of a Z-type interaction chamber) by regulating a pressure at 1150 kg/cm², to obtain the silver behenate dispersion. The cooling procedures were as follows: each of hose heat exchangers was mounted before and after the interaction chamber, and a dispersion temperature was set at 18° C. by regulating a temperature of a cooling medium.

3) Preparation of Reducing Agent Dispersion

Preparation of Reducing Agent-1 Dispersion

10 kg of water was added to 10 kg of the reducing agent-1 (2,2′-methylenebis(4-ethyl-6-tert-butylphenol)) and 16 kg of a 10% by weight aqueous solution of denatured polyvinyl alcohol (trade name: POVAR MP203, manufactured by Kuraray Co., Ltd.), and mixed well to obtain a slurry. This slurry was fed with a diaphragm, dispersed for 3 hours with a transverse-type sand mill (trade name: UVM-2, manufactured by AIMEX) charged with zirconia beads having an average diameter of 0.5 mm, and 0.2 g of a sodium salt of benzoisothiazolinone and water were added to adjust the concentration of a reducing agent to 25% by weight. This dispersion was heat-treated at 60° C. for 5 hours to obtain a dispersion of the reducing agent-1. A reducing agent particle contained in the thus obtained reducing agent dispersion had a median diameter of 0.40 μm and a maximum particle diameter of 1.4 μm or smaller. The resulting reducing agent dispersion was filtered with a polypropylene filter having a pore diameter of 3.0 μm, to remove foreign matters such as trash and the like, and the dispersion was stored.

Preparation of Reducing Agent-2 Dispersion

10 kg of water was added to 10 kg of the reducing agent-2 (6,6′-di-t-butyl-4,4′-dimethyl-2,2′-butylidenediphenol) and 16 kg of a 10% by weight aqueous solution of denatured polyvinyl alcohol (trade name: Povar MP203, manufactured by Kuraray Co. Ltd.), and mixed well to obtain a slurry. This slurry was fed with a diaphragm pomp, dispersed for 3 hours and 30 minutes with a transverse type sand mill (trade name: UVM-2, manufactured by AIMEX) charged with zirconia beads having an average diameter of 0.5 mm, and 0.2 g of a sodium salt of benzoisothiazolinone and water were added to adjust the concentration of a reducing agent to 25% by weight. This dispersion was heated at 40° C. for 1 hour, and subsequently heat-treated at 80° C. for 1 hour to obtain a reducing agent-2 dispersion. A reducing agent particle contained in the thus obtained reducing agent dispersion had a median diameter of 0.50 μm and a maximum particle diameter of 1.6 μm or smaller. The resulting reducing agent dispersion was filtered with a polypropylene filter having a pore diameter of 3.0 μm to remove foreign matter such as a trash and the like, followed by storing.

4) Preparation of Hydrogen Bond-Forming Compound-1 Dispersion

10 kg of water was added to 10 kg of the hydrogen bond-forming compound-1 (tri(4-t-butylphenyl)phosphine oxide) and 16 kg of a 10% by weight aqueous solution of denatured polyvinyl alcohol (trade name: Povar MP 203, manufactured by Kuraray Co., Ltd.), and mixed well to obtain a slurry. This slurry was fed with a diaphragm pump, dispersed for 4 hours with a transverse-type sand mill (trade name: UVM-2, manufactured by AIMEX) charged with zirconia beads having an average diameter of 0.5 mm, and 0.2 g of a sodium salt of benzoisothiazolinone and water were added to adjust the concentration of the hydrogen bond-forming compound to 25% by weight. This dispersion was heated at 40° C. for 1 hour, and subsequently warmed at 80° C. for 1 hour to obtain the hydrogen bond-forming compound-1 dispersion. A hydrogen bond-forming compound particle contained in the thus obtained hydrogen bond-forming compound dispersion had a median diameter of 0.45 μm and a maximum particle diameter of 1.3 μm. The resulting hydrogen bond-forming compound dispersion was filtered with a polypropylene filter having a pore diameter of 3.0 μm, to remove foreign matters such as a trash, followed by storing.

5) Preparation of Development Promoter-1 Dispersion

10 kg of water was added to 10 kg of the development promoter-1 and 20 kg of 10% by weight aqueous solution of denatured polyvinyl alcohol (trade name: Povar MP 203, manufactured by Kuraray Co., Ltd.), and mixed well to obtain a slurry. This slurry was fed with a diaphragm pump, dispersed for 3 hours and 30 minutes with a transverse-type sand mill (trade name: UVM-2, manufactured by AIMEX) charged with zirconia beads having an average diameter of 0.5 mm, and 0.2 g of a sodium salt of benzoisothiazolinone and water were added so that the concentration of development promoter became 20% by weight, to obtain a development promoter 1 dispersion. A development promoter particle contained in the thus obtained development promoter dispersion had a median diameter of 0.48 μm and a maximum particle diameter of 1.4 μm. The resulting development promoter dispersion was filtered with a polypropylene filter having a pore diameter of 3.0 μm, to remove foreign matters such as a trash and the like, followed by storing.

6) Preparation of Solid Dispersions of Development Promoter-2 and Tone Adjusting Agent-1

Regarding solid dispersions of the development promoter-2 and the tone adjusting agent-1, according to the same manner as that of the development promoter-1, the materials were dispersed as in the developing-1, to obtain 20% by weight dispersion and 15% by weight dispersions, respectively.

7) Preparation of Polyhalogen Compound

Preparation of Organic Polyhalogen Compound-1 Dispersion

10 kg of an organic polyhalogen compound-1 (tribromomethanesulfonylbenzene), 10 kg of a 20% by weight aqueous solution of denatured polyvinyl alcohol (trade name: Povar MP 203, manufactured by Kurarey Co., Ltd.), 0.4 kg of a 20% by weight aqueous solution of sodium triisopropylnaphthalenesulfonate and 14 kg of water were added, and mixed well to obtain a slurry. This slurry was fed with a diaphragm pump, dispersed for 5 hours with a transverse-type sand mill (trade name: UVM-2, manufactured by AIMEX) charged with zirconia beads having an average diameter of 0.5 mm, and 0.2 g of a sodium salt of benzoisothiazolinone and water were added so that the concentration of the organic polyhalogen compound became 26% by weight, to obtain an organic polyhalogen compound-1 dispersion. An polyhalogen compound particle contained in the thus obtained polyhalogen compound had a median diameter of 0.41 μm and a maximum particle diameter of 2.0 μm. The resulting organic polyhalogen compound dispersion was filtered with a polypropylene filter having a pore diameter of 10.0 μm, to remove foreign matters such as a trash and the like, followed by storing.

Preparation of Organic Polyhalogen Compound-2 Dispersion

10 kg of an organic polyhalogen compound-2 (N-butyl-3-tribromomethanesulfonylbenzamide), 20 kg of a 10% by weight aqueous solution of denatured polyvinyl alcohol (trade name: Povar MP 203, manufactured by Kurarey Co., Ltd.), and 0.4 kg of a 20% by weight aqueous solution of sodium triisopropylnaphthalenesulfonate were added, and mixed well to obtain a slurry. This slurry was fed with a diaphragm pump, dispersed for 5 hours with a transverse-type sand mill (trade name: UVM-2, manufactured by AIMEX) charged with zirconia beads having an average diameter of 0.5 mm, and 0.2 g of a sodium salt of benzoisothiazolinone and water were added to adjust the concentration of the organic polyhalogen compound to 30% by weight. This dispersion was warmed at 40° C. for 5 hours to obtain an organic polyhalogen compound-2 dispersion. An organic polyhalogen compound particle contained in the thus obtained polyhalogen compound dispersion had a median diameter of 0.40 μm and a maximum particle diameter of 1.3 μM or smaller. The resulting organic polyhalogen compound dispersion was filtered with a polypropylene filter having a pore diameter of 3.0 μm, to remove foreign matters such as a trash and the like, followed by storing.

8) Preparation of Phthalazine Compound-1 Solution

8 kg of denatured polyvinyl alcohol (trade name: MP 203, manufactured by Kurarey Co., Ltd.) was dissolved in 174.57 kg of water, and 3.15 kg of a 20% by weight aqueous solution of sodium triisopropylnaphthalenesulfonate and 14.28 kg of a 70% by weight solution of a phthalazine compound-1 (6-isopropylphthalazine) were added to prepare a 5% by weight solution of the phthalazine compound-1.

9) Preparation of Mercapto Compound

Preparation of Aqueous Mercapto Compound-1 Solution

7 g of a mercapto compound-i (sodium salt of 1-(3-sulfophenyl)-5-mercaptotetrazole) was dissolved in 993 g of water to obtain a 0.7% by weight aqueous solution.

Preparation of Aqueous Mercapto Compound-2 Solution

20 g of a mercapto compound-2 (sodium salt of 1-(3-methylureido)-5-mercaptotetrazole) was dissolved in 980 g of water to obtain a 2.0% by weight aqueous solution.

10) Preparation of Pigment-1 Dispersion

64 g of C. I. Pigment Blue 60 and 6.4 g of a surfactant (trade name: Demol N, manufactured by Kao Corporation) were added to 250 g of water, and mixed well to obtain a slurry. 800 g of zirconia beads having an average diameter of 0.5 mm were prepared, placed into a vessel together with the slurry, dispersed for 25 hours with a dispersing machine (trade name: ¼ G sand grinder mill, manufactured by AIMEX), and water was added to adjust the concentration of the pigment to 5% by weight to obtain a pigment dispersion. A pigment particle contained in the thus obtained pigment dispersion had an average particle diameter of 0.21 μm.

11) Preparation of Binder Liquid

Binder of to the Present Invention

pH value of each polymer latex of a compound selected from above-shown Example Compounds (P-1) to (P-29) was adjusted to 8.35 by 25% NH₄OH. The resultant was filtered by a polypropylene filter having a pore diameter of 1.0 μm to remove foreign matters such as dirt, thereby preparing a binder liquid having a solid content of 44% by mass.

### Comparative Example: Binder RP-1

Example Compound (P-1) described in JP-A No. 2002-229149 was synthesized, and a binder liquid was prepared in the same manner as above to obtain a comparative binder RP-1 (styrene/butadiene/acrylic acid=68/29/3% by mass, Tg=17° C., solid content=44% by mass, particle size=80 nm).

### Comparative Example: Binder RP-2

A compound was synthesized in the same manner as above-mentioned Synthesis Example 1 except for using 496.8 g of styrene, 27 g of isoprene and 16.2 g of acrylic acid, and a binder liquid was prepared in the same manner as above to obtain a comparative binder RP-2 (styrene/isoprene/acrylic acid=92/5/3% by mass, Tg=86° C., solid content=44% by mass, particle size=115 nm).

### Comparative Example: Binder RP-3

A compound was synthesized in the same manner as above-mentioned Synthesis Example 2 except for using 118.8 g of styrene, 405 g of isoprene and 16.2 g of acrylic acid, and a binder liquid was prepared in the same manner as above to obtain a comparative binder RP-3 (styrene/isoprene/acrylic acid=22/75/3% by mass, Tg=−40° C., solid content=44% by mass, particle size=108 nm)

### Comparative Example: Binder RP-4

Example Compound (P-13) described in JP-A No. 2002-229149 was synthesized, and a binder liquid was prepared in the same manner as above to obtain a comparative binder RP-4 (styrene/isoprene/tetraethyleneglycol methacrylate 75/5/20% by mass, Tg=38° C., solid content=44% by mass, particle size=90 nm).

2. Preparation of Coating Solutions

1) Preparation of Coating Solutions A1 to A16 for Image-Forming Layer

Preparation of Coating Solution A1 for Image-Forming Layer

1000 g of the fatty acid silver salt dispersion B, 135 ml of water, 36 g of the pigment-1 dispersion, 14.3 g of the organic polyhalogen compound-1 dispersion, 22.3 g of the organic polyhalogen compound-2 dispersion, 171 g of the phthalazine compound-1 solution, 1060 g of the binder liquid (Example Compound (P-1), latex concentration=44% by mass), 153 g of the reducing agent-2 dispersion, 55 g of the hydrogen bonding compound-1 dispersion, 4.8 g of the development accelerator-1 dispersion, 5.2 g of the development accelerator-2 dispersion, 2.1 g of the color-controlling agent-1 dispersion, and 8 ml of the aqueous mercapto compound-2 solution were sequentially added. 140 g of the silver halide mixture emulsion A was added thereto and well mixed immediately before the application, to obtain a coating solution A1 for an image-forming layer. The coating solution A1 was transported to a coating die and coated onto the support.

The viscosity of the coating solution A1 was measured by B-type viscometer manufactured by Tokyo Keiki Co,. Ltd. As a result, the coating solution A1 had the viscosity of 43 mPa·s at 40° C. (No. 1 rotor, 60 rpm).

The viscosity of the coating solution A1, measured using a controlled stress rheometer RHEOSTRESS RS-150 (trade name, manufactured by Haake), was 23 mPa·s at 38° C.

The amount of zirconium in the coating solution A1 was 0.30 mg per 1 g of silver.

Preparation of Coating Solutions A2 to A16 for Image-Forming Layer

Coating solutions A2 to A16 for image-forming layer were prepared in the same manner as the coating solution A1 except for changing the binder (selected from Example Compounds P-2 to P-24 and comparative binders RP-1 to RP-4 with latex concentration of 44% by mass) and the amounts of the organic polyhalogen compounds as shown in Table 1, respectively.

TABLE 1

| | | | | Total | |
|---|---|---|---|---|---|
| | | | | amount of | |
| | | Organic | Organic | organic | |
| Coating | | polyhalogen | polyhalogen | polyhalogen | |
| solution | Binder | compound 1 | compound 2 | compounds | Note |
| A1 | P-1 | 0.08 g/m² | 0.16 g/m² | 0.24 g/m² | Present invention |
| A2 | P-2 | 0.08 g/m² | 0.16 g/m² | 0.24 g/m² | Present invention |
| A3 | P-3 | 0.06 g/m² | 0.12 g/m² | 0.18 g/m² | Present invention |
| A4 | P-4 | 0.09 g/m² | 0.18 g/m² | 0.27 g/m² | Present invention |
| A5 | P-7 | 0.08 g/m² | 0.16 g/m² | 0.24 g/m² | Present invention |
| A6 | P-9 | 0.08 g/m² | 0.16 g/m² | 0.24 g/m² | Present invention |
| A7 | P-11 | 0.07 g/m² | 0.14 g/m² | 0.21 g/m² | Present invention |
| A8 | P-16 | 0.08 g/m² | 0.16 g/m² | 0.24 g/m² | Present invention |
| A9 | P-17 | 0.04 g/m² | 0.08 g/m² | 0.12 g/m² | Present invention |
| A10 | P-21 | 0.10 g/m² | 0.20 g/m² | 0.30 g/m² | Present invention |
| A11 | P-25 | 0.08 g/m² | 0.16 g/m² | 0.24 g/m² | Present invention |
| A12 | RP-1 | 0.08 g/m² | 0.16 g/m² | 0.24 g/m² | Comparative example |
| A13 | RP-2 | 0.08 g/m² | 0.16 g/m² | 0.24 g/m² | Comparative example |
| A14 | RP-3 | 0.08 g/m² | 0.16 g/m² | 0.24 g/m² | comparative example |
| A15 | RP-4 | 0.08 g/m² | 0.16 g/m² | 0.24 g/m² | Comparative example |
| A16 | RP-1 | 0.18 g/m² | 0.36 g/m² | 0.54 g/m² | Comparative example |

2) Preparation of Coating Solutions B1 to B16 for Image-Forming Layer

Preparation of Coating Solution B1 for Image-Forming Layer

1000 g of the fatty acid silver salt dispersion A, 135 ml of water, 35 g of the pigment-1 dispersion, 15.8 g of the organic polyhalogen compound-1 dispersion, 46.4 g of the organic polyhalogen compound-2 dispersion, 162 g of the phthalazine compound-1 solution, 1060 g of the binder liquid (Example Compound (P-1), latex concentration=44% by mass) 75 g of the reducing agent-1 dispersion, 75 g of the reducing agent-2 dispersion, 106 g of the hydrogen bonding compound-1 dispersion, 4.8 g of the development accelerator-1 dispersion, 9 ml of the aqueous mercapto compound-1 solution, and 27 ml of the aqueous mercapto compound-2 solution were sequentially added. 118 g of the silver halide mixture emulsion A was added thereto and well mixed immediately before the application, to obtain a coating solution B1 for an image-forming layer. The coating solution B1 was transported to a coating die and coated onto the support.

The viscosity of the coating solution B1 was measured by B-type viscometer manufactured by Tokyo Keiki Co,. Ltd. As a result, the coating solution B1 had the viscosity of 27 mPa·s at 40° C. (No. 1 rotor, 60 rpm).

The viscosities of the coating solution B1, measured using a controlled stress rheometer RHEOSTRESS RS-150 (trade name, manufactured by Haake), were 34, 37, 35, 28, 19 mPa·s at 38° C. at a shear rate of 0.1, 1, 10, 100, 1000 1/second, respectively.

The amount of zirconium in the coating solution B1 was 0.32 mg per 1 g of silver.

Preparation of Coating Solutions B2 to B16 for Image-Forming Layer

Coating solutions B2 to B16 for image-forming layer were prepared in the same manner as the coating solution B1 except for changing the binder (selected from Example Compounds P-2 to P-24 and comparative binders RP-1 to RP-4 with latex concentration of 44% by mass) and the amounts of the organic polyhalogen compounds as shown in Table 2, respectively.

TABLE 2

| | | | | Total | |
|---|---|---|---|---|---|
| | | | | amount of | |
| | | Organic | Organic | organic | |
| Coating | | polyhalogen | polyhalogen | polyhalogen | |
| solution | Binder | compound 1 | compound 2 | compounds | Note |
| B1 | P-1 | 0.10 g/m² | 0.20 g/m² | 0.30 g/m² | Present invention |
| B2 | P-2 | 0.10 g/m² | 0.20 g/m² | 0.30 g/m² | Present invention |
| B3 | P-3 | 0.08 g/m² | 0.16 g/m² | 0.24 g/m² | Present invention |
| B4 | P-4 | 0.09 g/m² | 0.18 g/m² | 0.27 g/m² | Present invention |
| B5 | P-7 | 0.10 g/m² | 0.20 g/m² | 0.30 g/m² | Present invention |
| B6 | P-9 | 0.10 g/m² | 0.20 g/m² | 0.30 g/m² | Present invention |
| B7 | P-11 | 0.07 g/m² | 0.14 g/m² | 0.21 g/m² | Present invention |
| B8 | P-16 | 0.10 g/m² | 0.20 g/m² | 0.30 g/m² | Present invention |
| B9 | P-17 | 0.05 g/m² | 0.10 g/m² | 0.15 g/m² | Present invention |
| B10 | P-21 | 0.09 g/m² | 0.18 g/m² | 0.27 g/m² | Present invention |
| B11 | P-25 | 0.10 g/m² | 0.20 g/m² | 0.30 g/m² | Present invention |
| B12 | RP-1 | 0.10 g/m² | 0.20 g/m² | 0.30 g/m² | Comparative example |
| B13 | RP-2 | 0.10 g/m² | 0.20 g/m² | 0.30 g/m² | Comparative example |
| B14 | RP-3 | 0.10 g/m² | 0.20 g/m² | 0.30 g/m² | Comparative example |
| B15 | RP-4 | 0.10 g/m² | 0.20 g/m² | 0.30 g/m² | Comparative example |
| B16 | RP-1 | 0.18 g/m² | 0.36 g/m² | 0.54 g/m² | Comparative example |

3) Preparation of Intermediate Layer Coating Solution

27 ml of a 5% by weight aqueous solution of Aerosol OT (trade name, manufactured by American Cyanamide) and 135 ml of a 20% by weight aqueous solution of a diammonium salt of phthalic acid were added to 1000 g of polyvinyl alcohol (trade name: PVA-205, manufactured by Kurarey Co., Ltd.), 163 g of the pigment-1 dispersion, 33 g of an aqueous blue dye compound-1 (trade name: Kayafectototarcoize RN liquid 150, manufactured by Nippon Kayaku Co., Ltd.) solution, 27 ml of a 5% aqueous solution of a sodium salt of di(2-ethylhexyl) sulfosuccinate, and 4200 ml of a 19% by weight solution of methyl methacrylate/styrene/butyl acrylate/hydroxyethyl methacrylate/acrylic acid copolymer (copolymerization ratio 57/8/28/5/2) latex, and further, water was added fill up to a total amount of 10000 g, and pH was adjusted to 7.5 with NaOH to obtain an intermediate layer coating solution, which was supplied to a coating die at 8.9 ml/m².

A viscosity of the coating solution is 58 [mPa·s] as measured by B-type viscometer (No. 1 rotor, 60 rpm) at 40° C.

4) Preparation of Coating Solution of First Layer of Surface Protective Layer

100 g of inert gelatin and 10 mg of benzoisothiazolinone were dissolved in 840 ml of water, 180 g of a 19% by weight solution of methyl methacrylate/styrene/butyl acrylate/hydroxyethyl methacrylate/acrylic acid copolymer (copolymerization ratio 57/8/28/5/2) latex, 46 ml of a 15% by weight solution of phthalic acid in methanol, and 5.4 ml of a 5% by weight aqueous solution of a sodium salt of di(2-ethylhexyl)sulfosuccinate were added to mix and, immediately before coating, 40 ml of 4% by weight chromium alum was mixed therein with a static mixer, which was supplied to a coating die at a coating solution amount of 26.1 ml/m².

A viscosity of the coating solution was 20 [mPa·s] as measured by a B-type viscometer (No. 1 rotor, 60 rpm) at 40° C.

5) Preparation of Coating Solution of Second Layer of Surface Protective Layer

100 g of inert gelatin and 10 mg of benzoisothiazolinone were dissolved in 800 ml of water, and 180 g of a 19% by weight solution of methyl methacrylate/styrene/butyl acrylate/hydroxyethyl methacrylate/acrylic acid copolymer (copolymerization ratio 57/8/28/5/2) latex, 40 ml of a 15% by weight solution of phthalic acid in methanol, 5.5 ml of a 1% by weight solution of a fluorine surfactant (F-1), 5.5 ml of a 1% by weight aqueous solution of a fluorine surfactant (F-2), 28 ml of a 5% by weight aqueous solution of a sodium salt of di(2-ethylhexyl)sulfosuccinate, 4 g of a polymethyl methacrylate fine particle (average particle diameter 0.7 μm) and 21 g of a polymethyl methacrylate fine particle (average particle diameter 4.5 μm) were mixed therein to obtain a surface protective layer coating solution, which was supplied to a coating die at 8.3 ml/m².

A viscosity of the coating solution was 19 [mPa·s] as measured by a B-type viscometer (No. 1 rotor, 60 rpm) at 40° C.

3. Preparation of Photothermographic Material

1) Preparation of Photothermographic Materials A1 to A16

Simultaneous overlaying coating was performed on a surface opposite to the back surface in an order of an image forming layer (with each of the image forming layer coating solutions A1 to A16), an intermediate layer, a first layer of a surface protective layer and second layer of the protecting layer from the undercoated surface by a slide bead coating, and obtained samples of photothermographic materials A1 to A16. Thereupon, the image forming layer and the intermediate layer were adjusted at 31° C., the first layer of the surface protective layer coating solution was adjusted at 36° C., and the second layer of the surface protective layer coating solution was adjusted at 37° C.

A coating amount (g/m²) of each compound in the image forming layer was as follows:

| | |
|---|---|
| Silver behenate | 5.42 |
| Pigment (C.I. Pigment Blue 60) | 0.036 |
| Polyhalogen compound-1 | (shown in Table 2) |
| Polyhalogen compound-2 | (shown in Table 2) |
| Phthalazine compound-1 | 0.18 |
| Binder | 9.43 |
| Reducing agent-2 | 0.77 |
| hydrogen bond-forming compound-1 | 0.28 |
| Development promoter-1 | 0.019 |
| Development promoter-2 | 0.016 |
| tone adjusting agent | 0.006 |
| Mercapto compound-2 | 0.003 |
| Silver halide (as amount of Ag) | 0.13 |

The coating drying conditions were as follows:

Coating was performed at a speed of 160 m/min, a gap between a tip of a coating die and a support was 0.10 to 0.30 mm, and a pressure in an evacuating chamber was set low by 196 to 882 Pa relative to the atmospheric pressure. The support was subjected to eliminate of electricity with an ionic wind before coating.

Subsequently, in a chilling zone, the coating solution was cooled with a wind at a dry-bulb temperature of 10 to 20° C., conveyed in contactless manner, and dried with a dry wind at a dry-bulb temperature of 23 to 45° C. and a wet-bulb temperature of 15 to 21° C. using a helical contactless drying apparatus.

After drying and humidity conditioning at 25° C. and humidity of 40 to 60% RH, a film surface was heated to 70 to 90° C. After heating, a film surface was cooled to 25° C.

A matting degree of the prepared photothermographic material as Beck smoothness was 550 seconds in the photosensitive layer side and 130 seconds in the back side. In addition, a pH of a film surface on the photosensitive surface side was measured and found to be 6.0.

2) Preparation of Photothermographic Materials B1 to B16

According to the same manner as that of the photothermographic materials A1 to A16, photothermographic materials B1 to B16 were prepared, except that each of the image forming layer coating solutions A1 to A16 was changed to the image forming layer coating solution B1 to B16 in the photothermographic materials B1 to B16, respectively.

Upon this, a coating amount (g/m²) of each compound of the image forming layer was as follows:

| | |
|---|---|
| Silver behenate | 5.42 |
| Pigment (C.I. Pigment Blue 60) | 0.036 |
| Polyhalogen compound-1 | (shown in Table 2) |
| Polyhalogen compound-2 | (shown in Table 2) |
| Phthalazine Compound-1 | 0.18 |
| Binder | 9.70 |
| Reducing Agent-1 | 0.40 |
| Reducing Agent-2 | 0.40 |
| hydrogen bond-forming compound-1 | 0.58 |
| Development promoter-1 | 0.02 |
| Mercapto Compound-1 | 0.002 |
| Mercapto Compound-2 | 0.012 |
| Silver halide (as amount of Ag) | 0.13 |

Chemical structures of compounds used in Examples of the invention will be shown below.

Spectral Sensitizing Dye A

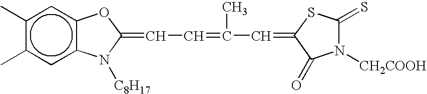

Spectral Sensitizing Dye B

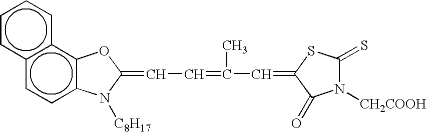

Tellurium Sensitizing Agent C

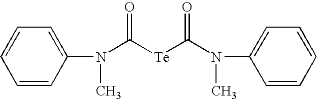

Base Precursor Compound-1

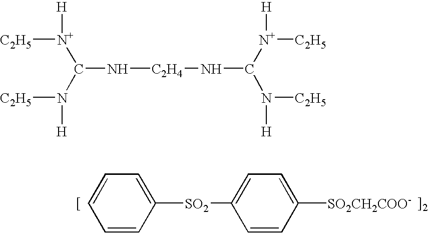

Cyanine Dye Compound-1

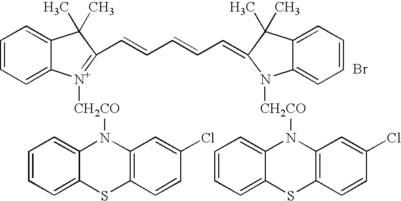

Blue Dye Compound-1

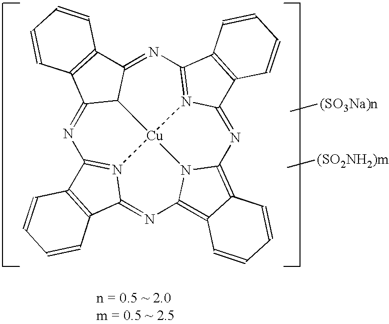

Reducing Agent-1 Reducing Agent-2

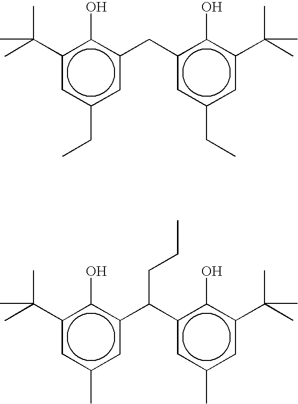

Hydrogen Bond-Forming Compound-1

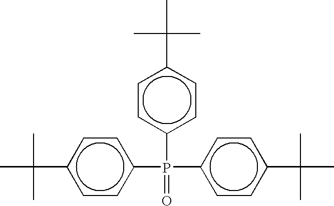

Polyhalogen Compound-1 Polyhalogen Compound-2

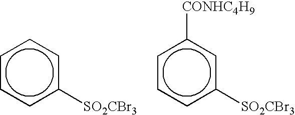

Mercapto Compound-1 Mercapto Compound-2

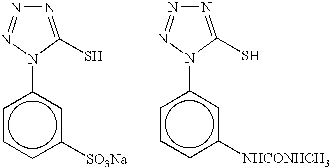

Phthalazine Compound-1 Development Promoter-1

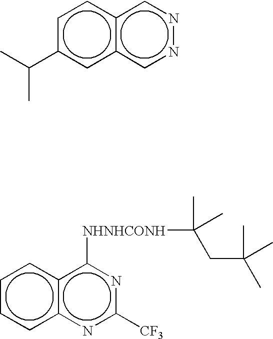

Development Promoter-2 Tone Adjusting Agent-1

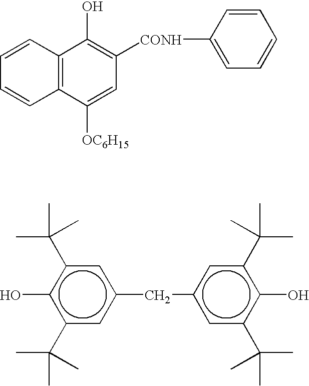

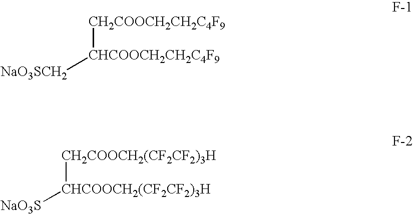

4. Evaluation of Photographic Properties

1) Preparation for Evaluation of Photographic Properties

Each of the resulting samples A1 to A16 and B1 to B16 was cut into a half cut size, packaged into the following packaging material under the environment at 25° C. and RH 50%, stored under a normal temperature for 2 weeks, and subjected to the following evaluation tests.

2) Packaging Material

A multi-layered material formed by laminating layers, which are respectively made of: PET (10 μm), PE (12 μm), aluminium foil (9 μm), Ny (15 mμ), and polyethylene containing 3% carbon (50 μm), was prepared as the packaging material.

An oxygen permeability of the packaging material was 0.02 ml/atm·m² 25° C.·day, and a moisture permeability thereof was 0.10 g/atm m²·25° C.·day.

3) Exposure and Thermal Development of Photosensitive Material

Each of the samples A1 to A16 was exposed and thermally developed with a laser imager described in Japanese Patent Application Nos. 2002-088832 and 2002-091114 (equipped with 660 nm semiconductor laser having 50 mW (IIIB) output at maximum). The thermal development was performed by using three panel heaters set at 107° C.-121° C.-121° C. for a total time of 14 seconds. The resulting image of each of the photothermographic materials A1 to A16 was subjected to evaluation of color density with a densitometer.

Each of the samples B1 to B16 was exposed and thermally developed with an laser imager (trade name: Fuji Medical dry laser imager FM-DP L, manufactured by Fuji Photo Film Co. Ltd.) equipped with 660 nm semiconductor laser having 60 mW (IIIB) output at maximum. The thermal development was performed by using four panel heaters set at 112° C.-119° C.-121° C.-121° C. for a total time of 24 seconds. The resulting image of each of the photothermographic materials B1 to B16 was subjected to evaluation of color density with a densitometer.

4) Items and Methods for Evaluation of Photographic Properties

1. Evaluation of Image Storability

Densities of white color image portions in the images of the thermally-developed samples were evaluated after a storage under the environment at 60° C. and RH 40% for 10 days, and then, each of changes in the densities of white color image portions of the samples (differences between the densities evaluated at before and at after the storage: ?Dₘᵢₙ) was expressed in a relative value to that of A16 (relative value: 100, used for calculating ?Dₘᵢₙ of A1 to A15) or B16 (relative value: 100, used for calculating ?Dₘᵢₙ of B1 to B15). The results are shown in Tables 3 and 4. 2. Evaluation of Densities of Brittleness in Process

Each of rolls of the thermally-developed samples was cut using a cutter (egde angle: 90°, shear angle: 10) at a vertical speed of 0.8 m/sec with conveying the samples at a speed of 1.2 m/sec. Then the cut face of each of the samples was evaluated by both an optical microscope and naked eyes.

The applied grades are as follows:

Grade 5: No layer peeling was observed by both an optical microscope evaluation and naked eyes evaluation.

Grade 4: Layer peelings were observed only by an optical microscope evaluation.

Grade 3: Layer peelings were observed by both an optical microscope evaluation and naked eyes evaluation.

Grade 2: Dusts formed by layer peelings were observed by naked eyes evaluation.

Grade 1: Accumulation of dusts formed by layer peelings was observed.

The results are shown in Tables 3 and 4.

3. Evaluation of Sensitivity

Each of the cologarithms of the laser outputs that achieve density of 1.0 was calculated, and expressed in a difference value with a subtraction by the cologarithm of A16 (used for calculating sensitivities of A1 to A15) or B16 (used for calculating sensitivities of B1 to B15). The results are shown in Tables 3 and 4.

TABLE 3

| Photo- | | | | | | |
|---|---|---|---|---|---|---|
| thermo- | | Isoprene | Image | | | |
| graphic | | content | stora- | Brittleness | | |
| material | Binder | (% by mass) | bility | in process | Sensitivity | Note |
| A1 | P-1 | 35.5 | 69 | 5 | 0.23 | Present invention |
| A2 | P-2 | 34 | 66.2 | 5 | 0.22 | Present invention |
| A3 | P-3 | 32 | 62.9 | 5 | 0.25 | Present invention |
| A4 | P-4 | 37.5 | 73.2 | 5 | 0.21 | Present invention |
| A5 | P-7 | 41 | 78.4 | 5 | 0.22 | Present invention |
| A6 | P-9 | 33 | 74.6 | 5 | 0.2 | Present invention |
| A7 | P-11 | 35 | 81.2 | 5 | 0.23 | Present invention |
| A8 | P-16 | 10 | 74.6 | 5 | 0.2 | Present invention |
| A9 | P-17 | 70 | 62.4 | 4 | 0.28 | Present invention |
| A10 | P-21 | 15 | 76.5 | 5 | 0.25 | Present invention |
| A11 | P-25 | 42 | 68.1 | 5 | 0.23 | Present invention |
| A12 | RP-1 | 0 | 240 | 5 | 0.25 | Comparative |
| A13 | RP-2 | 5 | 56.8 | 2 | 0.22 | Comparative |
| A14 | RP-3 | 75 | 385 | 5 | 0.21 | Comparative |
| A15 | RP-4 | 5 | 608 | 2 | 0.21 | Comparative |
| A16 | RP-1 | 0 | 100 | 4 | 0 | Comparative |

TABLE 4

| Photo- | | | | | | |
|---|---|---|---|---|---|---|
| thermo- | | Isoprene | Image | | | |
| graphic | | content | stora- | Brittleness | | |
| material | Binder | (% by mass) | bility | in process | Sensitivity | Note |
| B1 | P-1 | 35.5 | 73 | 5 | 0.22 | Present invention |
| B2 | P-2 | 34 | 70.1 | 5 | 0.21 | Present invention |
| B3 | P-3 | 32 | 66 | 5 | 0.23 | Present invention |
| B4 | P-4 | 37.5 | 75 | 5 | 0.22 | Present invention |
| B5 | P-7 | 41 | 80.1 | 5 | 0.23 | Present invention |
| B6 | P-9 | 33 | 77.1 | 5 | 0.21 | Present invention |
| B7 | P-11 | 35 | 83.2 | 5 | 0.21 | Present invention |
| B8 | P-16 | 10 | 76.9 | 5 | 0.23 | Present invention |
| B9 | P-17 | 70 | 64 | 4 | 0.27 | Present invention |
| B10 | P-21 | 15 | 79.9 | 5 | 0.26 | Present invention |
| B11 | P-25 | 42 | 72.2 | 5 | 0.23 | Present invention |
| B12 | RP-1 | 0 | 21.5 | 5 | 0.25 | Comparative |
| B13 | RP-2 | 5 | 59 | 2 | 0.21 | Comparative |
| B14 | RP-3 | 75 | 36.5 | 5 | 0.23 | Comparative |
| B15 | RP-4 | 5 | 65.3 | 3 | 0.21 | Comparative |
| B16 | RP-1 | 0 | 100 | 4 | 0 | Comparative |

As is apparent from the above results, the invention, that utilizes the specific polymer as a binder contained in an image forming layer, reveals dramatically improved image stability, sensitivity and brittleness in process.

What is claimed is:

1. A photothermographic material comprising a support and an image-forming layer disposed on the support, wherein the image-forming layer comprises a photosensitive silver halide, a non-photosensitive organic silver salt, a reducing agent and a binder, and the binder comprises a polymer formed by copolymerization of monomers including 10 to 70% by mass of a monomer represented by the following formula (M):
CH₂═CR⁰¹—CR⁰²═CH₂ Formula (M)
wherein R⁰¹ represents a hydrogen atom, an alkyl group having 1 to 6 carbon atoms, a halogen atom, or a cyano group; R⁰² represents an alkyl group having 1 to 6 carbon atoms, a halogen atom, or a cyano group; and where R⁰¹ and R⁰² are never both simultaneously a hydrogen atom.

2. A photothermographic material according to claim 1, wherein the image-forming layer contains an antifoggant formed from an organic polyhalogen compound.

3. A photothermographic material according to claim 2, wherein the organic polyhalogen compound is represented by the following formula (H):
Q—(Y)n-C(Z₁)(Z₂)X Formula (H)
wherein Q represents an alkyl group, an aryl group, or a heterocyclic group; Y represents a divalent linking group; n represents an integer of 0 or 1; Z₁ and Z₂ represent a halogen atom, respectively; and X represents a hydrogen atom or an electron-withdrawing group.

4. A photothermographic material according to claim 2, wherein the amount of the antifoggant is 0.01 to 0.5 g/m².

5. A photothermographic material according to claim 3, wherein the amount of the antifoggant is 0.01 to 0.5 g/m².

6. A photothermographic material according to claim 1, wherein the polymer has a glass-transition temperature of −30 to 70° C.

7. A photothermographic material according to claim 2, wherein the polymer has a glass-transition temperature of −30 to 70° C.

8. A photothermographic material according to claim 3, wherein the polymer has a glass-transition temperature of −30 to 70° C.

9. A photothermographic material according to claim 4, wherein the polymer has a glass-transition temperature of −30 to 70° C.

10. A photothermographic material according to claim 1, wherein the polymer is a polymer latex synthesized by an emulsion polymerization.

11. A photothermographic material according to claim 2, wherein the polymer is a polymer latex synthesized by an emulsion polymerization.

12. A photothermographic material according to claim 3, wherein the polymer is a polymer latex synthesized by an emulsion polymerization.

13. A photothermographic material according to claim 1, wherein R⁰¹ is a hydrogen atom and R⁰² is a methyl group in the formula (M).

14. A photothermographic material according to claim 2, wherein R⁰¹ is a hydrogen atom and R⁰² is a methyl group in the formula (M).

15. A photothermographic material according to claim 3, wherein R⁰¹ is a hydrogen atom and R⁰² is a methyl group in the formula (M).

16. A photothermographic material according to claim 1, wherein the polymer is copolymerized with monomers at 1 to 20% by mass, said monomers having acid groups.

17. A photothermographic material according to claim 2, wherein the polymer is copolymerized with monomers at 1 to 20% by mass, said monomers having acid groups.

18. A photothermographic material according to claim 3, wherein the polymer is copolymerized with monomers at 1 to 20% by mass, said monomers having acid groups.
